(19) United States
(12) Patent Application Publication
(10) Pub. No.: US 2008/0184142 A1
(43) Pub. Date: Jul. 31, 2008

(54) CONTENT REPRODUCTION APPARATUS, RECORDING MEDIUM, CONTENT REPRODUCTION METHOD AND CONTENT REPRODUCTION PROGRAM

(75) Inventors: Susumu IJICHI, Kanagawa (JP); Satoshi ARAKI, Kanagawa (JP); Ryo MUKAIYAMA, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sony Corporation, Tokyo (JP)

(21) Appl. No.: 11/778,920

(22) Filed: Jul. 17, 2007

(30) Foreign Application Priority Data
Jul. 21, 2006 (JP) 2006-200047

(51) Int. Cl. G06F 3/048

(52) U.S. Cl. 715/764

(57) ABSTRACT

Disclosed herein is a content reproduction apparatus for reproducing a content based on a playlist to which a plurality of contents belong, including, a reproduction section configured to reproduce a content, and a control section configured to select a predetermined one of playlists in response to an input to an inputting section and control the reproduction section so as to apply a predetermined effect based on the selected playlist to a content of the playlist to reproduce the content.

### CROSS REFERENCES TO RELATED APPLICATIONS

The present invention contains subject matter related to Japanese Patent Application JP 2006-200047 filed in the Japan Patent Office on Jul. 7, 2006, the entire contents of which being incorporated herein by reference.

### BACKGROUND OF THE INVENTION

1. Field of the Invention

This invention relates to a content reproduction apparatus, a recording medium, a content reproduction method and a content reproduction program and can be applied suitably, for example, where a content is reproduced based on a playlist which indicates a reproduction order of a plurality of contents.

2. Description of the Related Art

In resent years, a content reproduction apparatus has been spread widely which reads out and reproduces a content (for example, music data (“audio data” can also be used synonymously)) stored in a storage medium such as a hard disk or downloads and reproduces a content accumulated in a server. Such a content reproduction apparatus as just described reproduces a content based on a playlist and displays the playlist on a predetermined display section such that a user can select a desired content from within the playlist.

Also a content reproduction apparatus has been proposed which displays a playlist not as a mere list of contents but as a list compared to a broadcast list of a radio broadcasting station such that the user can select a desired content in such a sense in operation that the user performs tuning. A content reproduction apparatus of the type described is disclosed, for example, in Japanese Patent Laid-Open No. 2003-162285.

### SUMMARY OF THE INVENTION

As described above, the content reproduction apparatus in the past can provide an operation system which provides a different sense from that of systems in the past to the user by displaying a playlist compared to a broadcast list of a radio broadcasting station. However, the content reproduction apparatus in the past has no difference from an alternative apparatus wherein a playlist is displayed as a mere list of contents in that it provides a manner of enjoyment to the user that a content is reproduced in a form determined by the production side.

Therefore, it is demanded to provide a content reproduction apparatus, a recording medium, a content reproduction method and a content reproduction program by which a manner of enjoyment of a content different from a conventional manner of enjoyment can be provided.

According to the present invention, there is provided a content reproduction apparatus for reproducing a content based on a playlist to which a plurality of contents belong, including a reproduction section configured to reproduce a content, and a control section configured to select a predetermined one of playlists in response to an input to an inputting section and control the reproduction section so as to apply a predetermined effect based on the selected playlist to a content of the playlist to reproduce the content.

With the content reproduction apparatus, a content which belongs to a playlist which defines a reproduction order of contents can be reproduced with an effect suitable for a characteristic of the playlist. Consequently, a manner of enjoyment of a content different from a manner in the past of enjoyment can be provided.

The above and other objects, features and advantages of the present invention will become apparent from the following description and the appended claims, taken in conjunction with the accompanying drawings in which like parts or elements denoted by like reference characters.

### BRIEF DESCRIPTION OF THE DRAWINGS

FIG. 1 is a block diagram showing a configuration of a content reproduction apparatus which has a basic configuration according to the present invention;

FIG. 2 is a diagrammatic view illustrating management of music data by the content reproduction apparatus;

FIG. 3 is a schematic view showing a configuration of a selection screen;

FIG. 4 is a similar view but showing a configuration of a reproduction screen;

FIG. 5 is a block diagram illustrating screen changeover and reproduction control upon such screen changeover;

FIG. 6 is a diagrammatic view illustrating a manner of changeover of a channel and changeover of a tune;

FIG. 7 is a flow chart illustrating a Music Station function starting processing procedure;

FIG. 8 is a flow chart illustrating a channel changeover processing procedure;

FIG. 9 is a flow chart illustrating a tune changeover processing procedure;

FIG. 10 is a schematic view showing a configuration of a channel display setting screen;

FIG. 11 is a flow chart illustrating a channel display setting processing procedure;

FIG. 12 is a block diagram showing an outline of a content reproduction apparatus according to a first embodiment of the present invention;

FIG. 13 is a block diagram showing a configuration of a music reproduction apparatus according to the first embodiment;

FIG. 14 is a schematic view showing a configuration of a remote controller for use with the music reproduction apparatus of the first embodiment;

FIG. 15 is a schematic view showing a configuration of a selection screen of the music reproduction apparatus of the first embodiment;

FIG. 16 is a similar view but showing a configuration of a reproduction screen of the music reproduction apparatus of the first embodiment;

FIG. 17 is a block diagram illustrating screen changeover and reproduction control upon such screen changeover of the music reproduction apparatus of the first embodiment;

FIG. 18 is a diagrammatic view illustrating a manner of changeover of a channel and changeover of a tune by the music reproduction apparatus of the first embodiment;

FIG. 19 is a flow chart illustrating a Music Station function starting processing procedure by the music reproduction apparatus of the first embodiment;

FIG. 20 is a flow chart illustrating a channel changeover processing procedure by the music reproduction apparatus of the first embodiment;

FIG. 21 is a flow chart illustrating a tune changeover processing procedure by the music reproduction apparatus of the first embodiment;

FIG. 22 is a schematic view showing a configuration of a channel display setting screen by the music reproduction apparatus of the first embodiment;

FIG. 23 is a flow chart illustrating a channel display setting processing procedure by the music reproduction apparatus of the first embodiment;

FIG. 24 is a flow chart illustrating a list designation processing procedure by the music reproduction apparatus of the first embodiment;

FIG. 25 is a schematic view showing a configuration of a starting channel setting screen by the music reproduction apparatus of the other embodiment;

FIG. 26 is a block diagram showing an outline of a content reproduction apparatus according to a second embodiment of the present invention;

FIG. 27 is a block diagram showing a configuration of a music reproduction apparatus according to the second embodiment;

FIG. 28 is a schematic view showing a configuration of a remote controller for use with the music reproduction apparatus of the second embodiment;

FIG. 29 is a schematic view showing a configuration of a request acceptance dialog by the music reproduction apparatus of the second embodiment;

FIG. 30 is a similar view but showing a configuration of a deletion confirmation dialog by the music reproduction apparatus of the second embodiment;

FIG. 31 is a similar view but showing a configuration of an addition conformation dialog by the music reproduction apparatus of the second embodiment;

FIG. 32 is a flow chart illustrating a list editing processing procedure by the music reproduction apparatus of the second embodiment;

FIG. 33 is a schematic view showing a configuration of a no-data notification dialog by the music reproduction apparatus of the second embodiment;

FIG. 34 is a similar view but showing a display example of a selection screen by the music reproduction apparatus of the second embodiment;

FIG. 35 is a flow chart illustrating an addition urging processing procedure by the music reproduction apparatus of the second embodiment;

FIG. 36 is a schematic view showing another display example of the selection screen by the music reproduction apparatus of the second embodiment;

FIG. 37 is a flow chart illustrating an updating notification processing procedure by the music reproduction apparatus of the second embodiment;

FIG. 38 is a flow chart illustrating a registered data number updating processing procedure by the music reproduction apparatus of the second embodiment;

FIG. 39 is a flow chart illustrating a reproduction control processing procedure by a modification to the music reproduction apparatus of the other embodiment;

FIG. 40 is a schematic view showing a display example of a selection screen by a modification to the music reproduction apparatus of the other embodiment;

FIG. 41 is a block diagram showing a configuration of a display control apparatus according to a third embodiment of the present invention;

FIG. 42 is a block diagram showing a configuration of a music reproduction apparatus according to the third embodiment;

FIG. 43 is a schematic view showing a configuration of a channel addition notification dialog by the music reproduction apparatus of the third embodiment;

FIG. 44 is a similar view but showing a display example of a selection screen by the music reproduction apparatus of the third embodiment;

FIG. 45 is a flow chart illustrating a channel display setting change updating processing procedure by the music reproduction apparatus of the third embodiment;

FIGS. 46A, 46B and 46C are schematic views showing different examples of a display pattern of a selection screen by the music reproduction apparatus of the third embodiment;

FIG. 47 is a flow chart illustrating a screen saturation selective determination processing procedure by the music reproduction apparatus of the third embodiment;

FIG. 48 is a flow chart illustrating a screen brightness selective determination processing procedure by a modification to the music reproduction apparatus of the other embodiment;

FIGS. 49A, 49B and 49C are schematic views showing different display pattern examples of a selection screen by a modification to the music reproduction apparatus of the other embodiment;

FIG. 50 is a block diagram showing an outline of a content reproduction apparatus according to a fourth embodiment of the present invention;

FIG. 51 is a block diagram showing a music reproduction apparatus according to the fourth embodiment;

FIGS. 52A, 52B and 52C are diagrammatic views illustrating an example of equalization setting by the music reproduction apparatus of the fourth embodiment;

FIG. 53 is a flow chart illustrating an equalization setting changing processing procedure by the music reproduction apparatus of the fourth embodiment;

FIG. 54 is a flow chart illustrating a tune order changing processing procedure by a modification to the music reproduction apparatus of the other embodiment;

FIG. 55A is a diagrammatic view illustrating music data used in a modification to the music reproduction apparatus of the other embodiment and FIG. 55B is a flow chart illustrating a reproduction starting position changing processing procedure by the modified music reproduction apparatus; and

FIG. 56 is a block diagram showing a hardware configuration of a content reproduction apparatus according to a fifth embodiment of the present invention.

### DETAILED DESCRIPTION OF THE PREFERRED EMBODIMENTS

### 1. Basic Configuration of the Invention

First, a basic configuration of the present invention is described. After the basic configuration is described, first to fourth embodiments of the present invention are described based on the basic configuration.

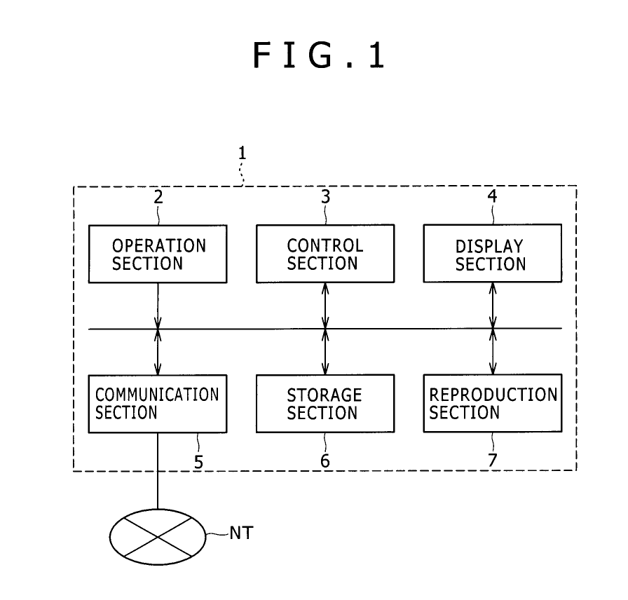

Referring to FIG. 1, there is shown a content reproduction apparatus having function blocks according to the basic configuration of the present invention. The content reproduction apparatus 1 shown includes a control section 3 which controls the other components of the content reproduction apparatus 1 in accordance with operation instructions obtained from an operation section 2 to execute various processes.

The content reproduction apparatus 1 handles music data as a content and has a plurality of functions relating to recording and reproduction of music data. The control section 3 can perform changeover among the functions in response to an operation instruction from the operation section 2 and controls a display section 4 to display a GUI (Graphical User Interface) screen corresponding to any of the functions. Incidentally, the music data here are data corresponding to a tune (also called piece of music).

In particular, if the control section 3 of the content reproduction apparatus 1 receives an instruction to change over the operative function thereof, for example, to a function of downloading music data (the function is hereinafter referred to as download function) through the operation section 2, then it controls the display section 4 to display a GUI screen corresponding to the download function. Thereafter, if an instruction to download the music data is received, then music data provided from a music providing server not shown in response to the instruction are received by a communication section 5 through a network NT and stored into a storage section 6.

Further, if the control section 3 of the content reproduction apparatus 1 receives an instruction to change over the operative function to a function of recording a CD (Compact Disc) (the function is referred to also as CD recording function) through the operation section 2, then it controls the display section 4 to display a GUI screen corresponding to the CD recording function. If an instruction to record a CD is received thereafter, then the control section 3 reads out music data from a CD not shown currently loaded in the content reproduction apparatus 1, performs a compression encoding process for the read out music data and then stores resulting music data into the storage section 6.

Further, if the control section 3 of the content reproduction apparatus 1 receives an instruction to change over the operative function to a function of reproducing music data stored in the storage section 6 (the function is hereinafter referred to also as normal reproduction function) through the operation section 2, then it controls the display section 4 to display a GUI screen corresponding to the normal reproduction function. Then, if an instruction to reproduce music data is received, then the control section 3 reads out the music data from the storage section 6 in accordance with the instruction and performs a reproduction process including a decoding process, an equalizing process, a digital to analog conversion process and an amplification process for the read out music data so that the music is outputted based on the music data.

Further, if the control section 3 of the content reproduction apparatus 1 receives an instruction to change over to the operative function to a function of reproducing a CD (the function is hereinafter referred to also as CD reproduction function) through the operation section 2, then it controls the display section 4 to display a GUI screen corresponding to the CD reproduction function. If an instruction to reproduce a CD is received thereafter, then the control section 3 reads out music data from a CD not shown currently loaded in the content reproduction apparatus 1 and controls a reproduction section 7 to perform a reproduction process for the read out music data so that the music (that is, tune) is outputted based on the music data.

In this manner, the control section 3 of the content reproduction apparatus 1 executes various processes in accordance with various functions.

Further, the content reproduction apparatus 1 has, in addition to the functions described above, a function (hereinafter referred to also as Music Station function) of providing music (tune) based on music data stored in the storage section 6 to a user in such a manner as to provide the user with such a feeling that the user enjoys music broadcast from a radio broadcasting station. In the following, the Music Station function is described.

First, a music data management method by the content reproduction apparatus 1 relating to reproduction of music data by the Music Station function is described.

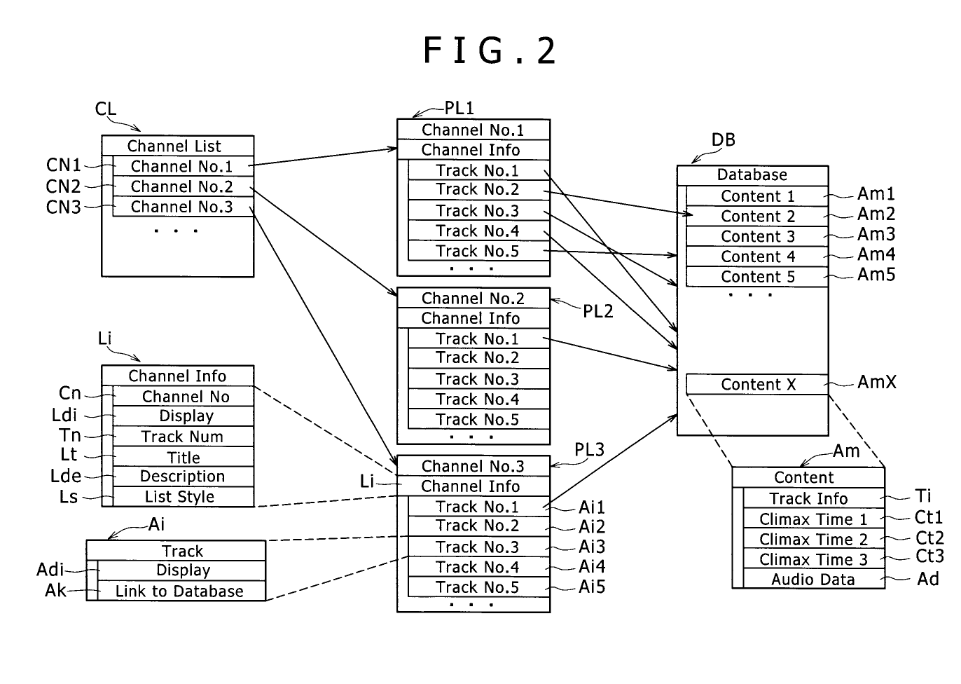

Referring to FIG. 2, a database DB for managing music data Ad is constructed in the storage section 6. The database DB manages a plurality of music data Ad individually with a plurality of music data management information Am (Am1 to AmX). Each piece of the music data management information Am includes, in addition to music data Ad, information (hereinafter referred to also as attribute information) Ti of the tune name, artist name, genre, recording date and hour, reproduction time length, jacket image, reproduction time number, degree of importance, characteristics of the tune and so forth corresponding to the music data Ad. Further, each piece of the music data management information Am includes a plurality of pieces of characteristic position information Ct (for example, three pieces Ct1 to Ct3) each indicative of a characteristic reproduction position (such as a catchy part position, a melody changeover position or the like, and this is hereinafter referred to as characteristic position).

Here, the characteristic of a tune indicated by the attribute information Ti includes, for example, impression values (numerical values representative of the tempo, brightness, tone and so forth) of the tune obtained by twelve-tone analysis of the music data Ad. Further, the attribute information Ti and the characteristic position information Ct (Ct1 to Ct3) are provided, for example, from a music providing server.

In addition, the storage section 6 stores, separately from the database DB, a plurality of playlists PL (PL1, PL2, PL3, . . . ) for managing the reproduction order of tunes of the music data Ad. Incidentally, each of the playlists PL (PL1, PL2, PL3, . . . ) corresponds to a list of tunes broadcast in a channel of a radio broadcasting station and is referred to also as channel playlist PL (PL1, PL2, PL3, . . . ).

Each of the channel playlist PL (PL1, PL2, PL3, . . . ) is a list wherein music data information Ai (Ai1 to Ai5, . . . ) which is content identification information of the individual music data Ad to be reproduced is arranged in the reproduction order. Thus, the reproduction order of the music data Ad is managed with the music data information Ai (Ai1 to Ai5, . . . ) arranged in the reproduction order. Incidentally, the reproduction order of the music data information Ai (Ai1 to Ai5, . . . ) represents the tune numbers of the music data information Ai (Ai1 to Ai5, . . . ).

Each piece of the music data information Ai (Ai1 to Ai5, . . . ) includes a link AK to the music data Ad on the database DB so that the music data Ad to be reproduced is designated by the link AK. Further, each piece of the music data information Ai (Ai1 to Ai5, . . . ) includes also music data reproduction setting Adi indicative of whether reproduction of the music data Ad designated by the link AK is permitted or inhibited in a unit of music data Ad.

In particular, each of the channel playlists PL (PL1, PL2, PL3, . . . ) indicates a reproduction order of the music data Ad and reproduction setting (reproduction permission or reproduction inhibition) in a unit of music data Ad.

Further, each of the channel playlists PL (PL1, PL2, PL3, . . . ) includes list information Li which is list identification information of the channel playlist PL. The list information Li describes a channel number Cn allocated to the channel playlist PL, list reproduction setting Ldi representing that reproduction of the music data Ad registered in the channel playlist PL should be permitted or inhibited in a unit of a channel play list, the number Tn of the tunes data information Ai in the channel playlist PL (that is, the number of the music data Ad registered in the channel playlist PL, and this is hereinafter referred to also as registered data number), the list name Lt which is the name of the channel playlist PL, list explanation Lde which is explanation of the channel playlist PL, and tune order setting Ls in the channel playlist PL.

Incidentally, the list reproduction setting Ldi can be set to “reproduction permitted” and “reproduction inhibited” normally by a user operation (a setting method is hereinafter described), and in at least one channel playlist PL, the list reproduction setting Ldi is fixed to “reproduction permitted”. In particular, this channel playlist PL is a list wherein reproduction of the music data Ad is normally permitted and is hereinafter referred to as default playlist DPL. Meanwhile, the list explanation Lde explains a text (for example, “Bright tunes are collected”) which particularly describes the channel playlist PL and a keyword (for example, “bright”) representative a characteristic of the channel playlist PL. Further, the tune order setting Ls describes that the music data Ad are reproduced in a fixed reproduction order indicated in the channel playlist PL (that is, in the order of the list), that the reproduction order indicated in the channel playlist PL is changed to reproduce the tunes in a random order (shuffle reproduction), or the like.

Further, the storage section 6 stores a list (hereinafter referred to also as channel list) CL of channels which can be utilized by the Music Station function separately from the channel playlist PL (PL1, PL2, PL3, . . . ). The channel list CL is a list of a plurality of channel numbers CN (CN1 to CN3, . . . ) arranged in the numerical order, and the channel number CN correspond to the channel number Cn allocated to the channel playlist PL. In other words, according to the channel list CL, the playlists PL (PL1, PL2, PL3, . . . ) are managed with the channel numbers CN thereof.

Incidentally, the channels which can be utilized by the Music Station function and the channel playlists PL (PL1, PL2, PL3, . . . ) need not necessarily correspond in a one-by-one corresponding relationship to each other, but a plurality of channel playlists PL may be allocated to one channel.

In this manner, the content reproduction apparatus 1 manages a plurality of playlists PL with the channel list CL and manages the reproduction order of music data Ad with the channel playlists PL.

Incidentally, as the above described channel playlists PL (PL1, PL2, PL3, . . . ) handled by the Music Station function, various kinds of playlists PL are prepared in advance. For example, the channel playlists PL include channel playlists PL constructed based on the number of times of reproduction indicated by the attribute information Ti of the music data Ad such as a channel playlist (hereinafter referred to also as new addition list) PL composed of music data Ad corresponding to newly added tunes or a channel playlist (hereinafter referred to as less frequently (or frequently) reproduced music list) PL composed of music data Ad corresponding to tunes whose reproduction time number is small (or great). The channel playlists PL further include channel playlists PL constructed based on an impression value of the tune indicated by the attribute information Ti of the music data Ad such as a channel playlist (hereinafter referred to also as catchy music list) PL composed of music data Ad corresponding to catchy tunes and a channel playlist (hereinafter referred to as bright music list) PL composed of music data Ad which correspond to bright tunes. The channel playlists PL further include channel playlists PL constructed based on a genre indicated by the attribute information Ti of the music data Ad such as a channel playlist (hereinafter referred to as classical list) PL composed of music data Ad corresponding to classical tunes and a channel playlist (hereinafter referred to also as heavy metal list) PL composed of music data Ad corresponding to heavy metal tunes.

Here, a channel playlist PL which is based on the reproduction time number is automatically updated when music data Ad is newly stored into the storage section 6 or when music data Ad is reproduced.

More specifically, for example, in the frequently reproduced music list PL describes “reproduction time number” and “high-order 10” as a keyword. Thus, after music data Ad is newly stored into the storage section 6 or is reproduced, the control section 3 of the content reproduction apparatus 1 selects, based on the key words “reproduction time number” and “high-order 10”, 10 music data Ad whose reproduction time number is comparatively great from among the music data Ad stored in the storage section 6 and updates the frequently reproduced music list PL so as to be formed from the selected music data Ad.

On the other hand, the channel playlist PL which is based on an impression value of a tune and the channel playlist PL which is based on a genre are automatically updated when music data Ad is newly stored into the storage section 6. In particular, for example, if “bright” is described as a keyword in the bright music list PL and the control section 3 of the content reproduction apparatus 1 decides, after it newly stores the music data Ad into the storage section 6, based on the keyword “bright”, that the value indicative of the brightness of the expression value of the tune of the newly stored music data Ad is higher than a predetermined value, then it updates the bright music list PL so that the music data Ad is additionally registered into the bright music list PL. Further, if “classical” is described as a keyword in the classical list PL and the control section 3 of the content reproduction apparatus 1 decides, after it newly stores the music data Ad into the storage section 6, based on the keyword “classical”, that the genre of the newly stored music data Ad is “classical”, then the control section 3 of the content reproduction apparatus 1 updates the classical list PL so that the music data Ad is additionally registered into the classical list PL.

In this manner, the Music Station function prepares a channel playlist PL for each of classes which are considered to be requested by users such as a newly added tune, a tune whose reproduction time number is small, catchy music, bright music, classical music, or heavy metal music. Thus, the content reproduction apparatus 1 automatically updates the channel playlists PL in response to storage or reproduction of music data Ad such that the music data Ad stored in the storage section 6 is registered into a pertaining one of the prepared channel playlists PL based on the reproduction time number, impression values of the tune, genre and so forth of the music data Ad.

Then, the content reproduction apparatus 1 selects one of the channel playlists PL classified into a newly added tune, a tune whose reproduction time number is small, catchy music, bright music, classical music, heavy metal music and so forth as a channel in response to a user operation on a GUI screen hereinafter described. Consequently, the user can find out a desired tune readily in such a feeling of changing over of the channel of a radio broadcast.

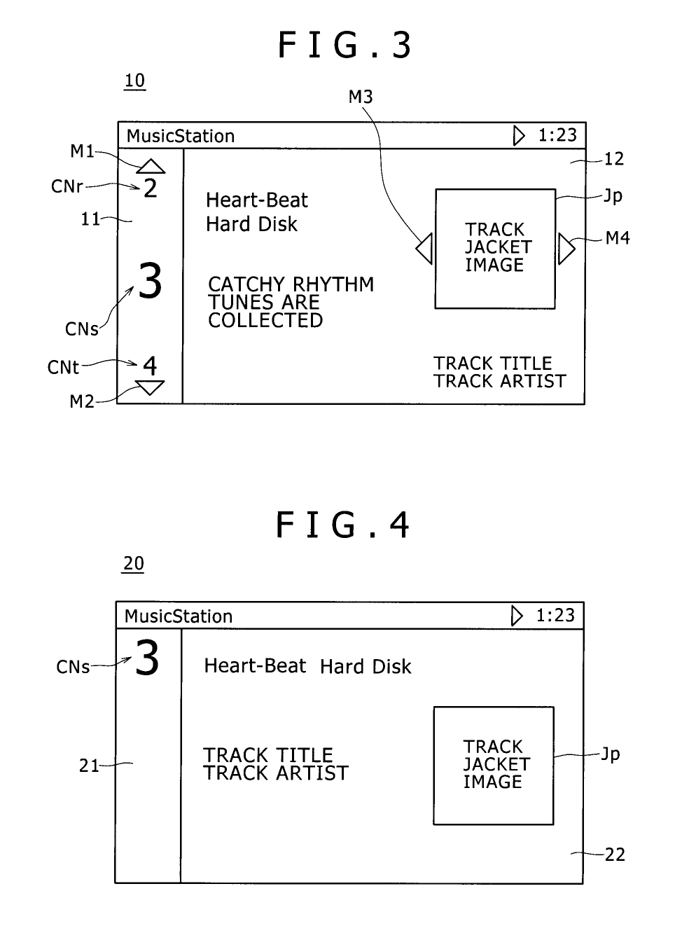

Now, GUI screens by the Music Station function are described. After the content reproduction apparatus 1 starts up the Music Station function in response to a Music Station function starting operation for the operation section 2, it displays such a selection screen 10 for selecting a channel and a tune as shown in FIG. 3 as a GUI screen on the display section 4.

The selection screen 10 has a vertically elongated channel selection region 11 disposed at a left end thereof and has a tune selection region 12 disposed at the remaining portion thereof. At a central portion of the channel selection region 11, the channel number CNs (for example, “3”) of a currently selected channel is displayed from among the channel numbers CN (CN1, CN2, CN3, . . . ) in the channel list CL. At upper and lower portions of the channel selection region 11, channel numbers CNr (for example, “2”) and CNt (for example, “4”) of channels which can be selected when the cannel is changed over from the currently selected channel in accordance with the order of the channel numbers CN (CN1, CN2, CN3, . . . ) in the channel list CL are displayed, respectively.

Further, a first mark M1 of a triangular shape with a vertex thereof directed upwardly is displayed in the proximity and on the upper side of the channel number CNr. Meanwhile, a second mark M2 of a triangular shape with a vertex thereof directed downwardly is displayed in the proximity and on the lower side of the channel number CNt. Each of the first mark M1 and the second mark M2 indicates that the channel which is selected by an operation of the operation section 2 can be changed over to the channel of the channel number CNr or the channel of the channel number CNt.

Then, the control section 3 of the content reproduction apparatus 1 changes over the channel number CNs to be displayed in the channel selection region 11 in accordance with the order of the channel numbers CN (CN1, CN2, CN3, . . . ) in the channel list CL (that is, changes over the channel) so that the user can recognize the channel changeover readily.

On the other hand, at a left portion of the tune selection region 12, the list name (for example, “Heart-Beat Hard Disk”) of a channel playlist (hereinafter referred to also as currently selected list) PL allocated to the currently selected channel and a list explanation (for example, “Catchy tunes are collected”) are displayed. Thus, the control section 3 of the content reproduction apparatus 1 changes over the list name and the list explanation to be displayed in the tune selection region 12 in response to a channel changeover operation for the operation section 2 thereby to allow the user to recognize the substance of the currently selected channel readily.

Meanwhile, at a right portion of the tune selection region 12, a jacket image Jp corresponding to a currently selected tune (that is, tune based on music data Ad corresponding to the music data information Ai selected from the currently selected list PL) is displayed. Further, the title and the artist name of the currently selected tune are displayed below the jacket image Jp.

Further, on the left side and in the proximity of the jacket image Jp, a third mark M3 of a triangular shape with a vertex thereof directed leftwardly is displayed. Meanwhile, on the right side and in the proximity of the jacket image Jp, a fourth mark M4 of a triangular shape with a vertex thereof directed rightwardly is displayed. Each of the third mark M3 and the fourth mark M4 indicates that the tune to be selected in response to an operation of the operation section 2 can be changed over to a tune based on the immediately preceding music data Ad or another tune based on the immediately succeeding music data Ad in accordance with the currently selected list PL.

Thus, the control section 3 of the content reproduction apparatus 1 can change over the jacket image Jp, music name and artist name to be displayed in the tune selection region 12 (that is, change over the tune) in response to a music changeover operation for the operation section 2 thereby to allow the user to recognize the substance of the tune based on the currently selected music data Ad readily.

In this manner, the content reproduction apparatus 1 selectively changes over the channel and selectively changes over the tune to be reproduced in response to an operation of the operation section 2 while it allows the user to visually recognize the substance of a channel and the substance of a tune through the selection screen 10.

After the Music Station function is started, the control section 3 of the content reproduction apparatus 1 selects, for example, a channel which was selected when the Music Station function was ended last and selects one music data Ad registered in the channel playlist PL allocated to the selected channel. Then, the control section 3 of the content reproduction apparatus 1 automatically starts reproduction of the music data Ad from a characteristic position. Therefore, the selection screen 10 immediately after the Music Station function is started indicates a displaying state wherein the channel upon the last ending of the Music Station function and a tune based on music data Ad registered in the channel playlist PL allocated to the channel are selected.

Further, if a music determination operation by the operation section 2 is performed while such a selection screen 10 as described above is displayed, then the control section 3 of the content reproduction apparatus 1 changes over the GUI screen from the selection screen 10 to such a reproduction screen 20 as shown in FIG. 4.

Referring to FIG. 4, the reproduction screen 20 includes a selection channel display region 21 disposed at a left end portion thereof and a selected tune display region 22 disposed at the remaining portion thereof. In the selection channel display region 21, only the channel number CNs (for example, “3”) of a currently selected channel is displayed. Meanwhile, in the selected tune display region 22, the list name of a channel playlist PL (that is, currently selected list) to which the currently selected channel is allocated and the music name and the artist name corresponding to the currently selected tune are displayed at a left portion. Further, in the selected tune display region 22, the jacket image Jp corresponding to the currently selected tune is displayed at a right portion.

In this manner, the content reproduction apparatus 1 allows the user to visually recognize the substance of the selected channel and tune through the reproduction screen 20.

Incidentally, also where no operation is performed for the operation section 2 for a predetermined period of time after the selection screen 10 is displayed, the control section 3 of the content reproduction apparatus 1 changes over the GUI screen from the selection screen 10 to the reproduction screen 20 similarly as in the case wherein a tune determination operation is performed.

Further, if the control section 3 of the content reproduction apparatus 1 recognizes that a channel changeover operation for the operation section 2 is performed while the reproduction screen 20 is displayed, then it changes over the GUI screen from the reproduction screen 20 back to the selection screen 10.

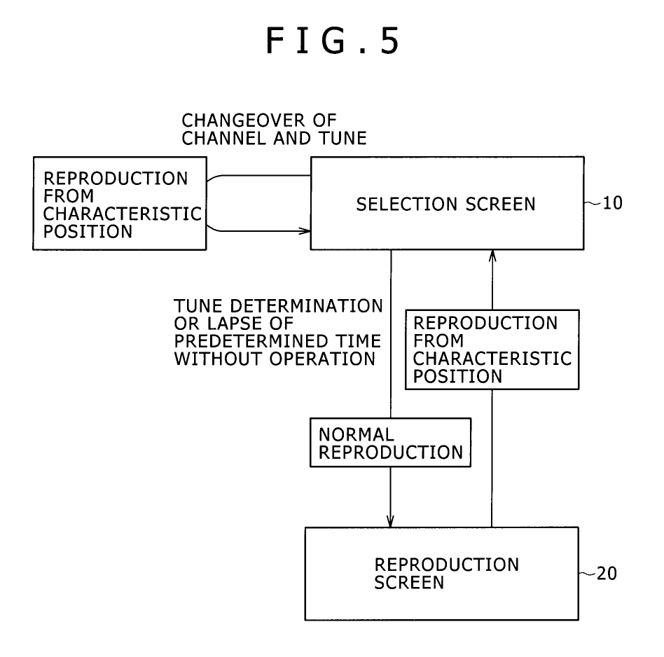

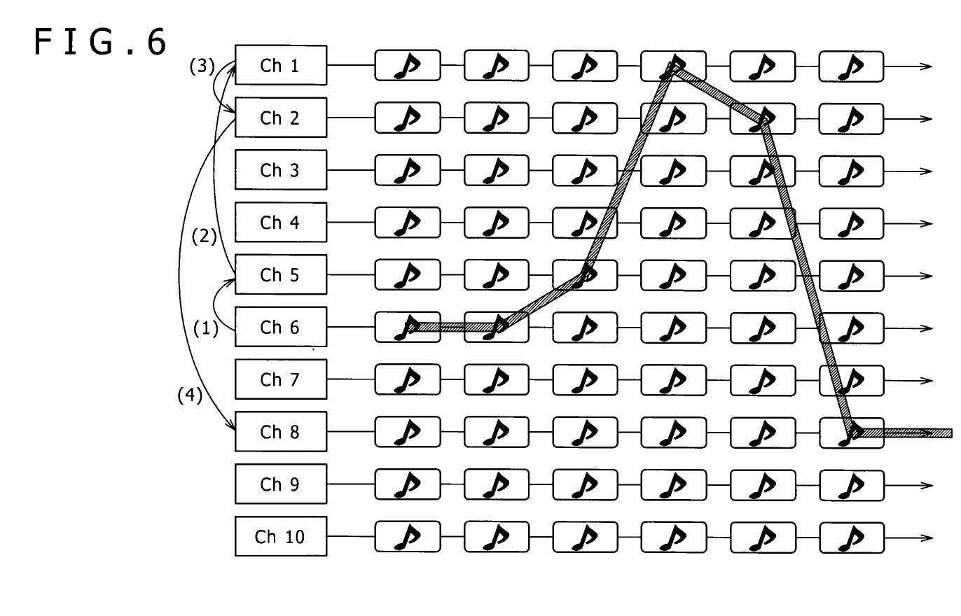

Here, changeover of the GUI screen described above and reproduction control of music data Ad upon such changeover are described with reference to FIG. 5. After the Music Station function is started, the control section 3 of the content reproduction apparatus 1 causes the selection screen 10 to be displayed and enters a partial reproduction mode wherein music data Ad is reproduced from a characteristic position.

In the partial reproduction mode, the control section 3 of the content reproduction apparatus 1 changes over the channel and changes over the tune to a tune of the channel after the changeover in response to a channel changeover operation on the selection screen 10 and changes over the tune within the same channel in response to a tune changeover operation. Then, every time the tune is changed over, the control section 3 of the content reproduction apparatus 1 reproduces the music data Ad corresponding to the tune after the changeover from a characteristic position.

Here, most users remember a characteristic portion of a tune (a catchy part, a changing over portion of the melody or the like) and recognize the tune by listening to the characteristic portion. In particular, the content reproduction apparatus 1 reproduces the music data Ad from a characteristic position so that the user may listen to the characteristic portion thereby to allow the user to readily recognize the tune based on the reproduced music data Ad.

Further, every time a channel changeover operation or a tune changeover operation is performed, the content reproduction apparatus 1 causes the music data Ad corresponding to the tune after the changeover to be reproduced from a characteristic position thereof so that the user can change over the channel and the tune in a sense of zapping.

Furthermore, the content reproduction apparatus 1 changes over, also upon channel changeover, the tune and reproduces music data corresponding to the tune after the changeover so that, also after the channel changeover, the user can listen to the tune in such a sense as if it listens to music broadcast from a radio broadcasting station without interruption of the reproduction of the music data Ad.

Further, in the content reproduction apparatus 1, since the channel playlists PL of the classes estimated to be requested by users are allocated to the channels which can be selected as described hereinabove, each user can change over the channel to a desired channel and find out a desired tune readily.

Then, if, in the partial reproduction mode, a tune determination operation is performed for the operation section 2, or if a predetermined interval of time elapses without any user operation, then the control section 3 of the content reproduction apparatus 1 changes over the display screen to the reproduction screen 20 and enters the normal reproduction mode in which the music data Ad is reproduced normally. In the normal reproduction mode, the music data Ad corresponding to the selected tune is reproduced to the last end so that the overall portion of the tune can be enjoyed by the user.

Thereafter, the control section 3 of the content reproduction apparatus 1 causes the music data Ad to be reproduced successively from the respective top position in accordance with the selection list PL until a channel changeover operation or a tune changeover operation for the operation section 2 is performed. Then, if a channel changeover operation or a tune changeover operation for the operation section 2 is performed, then the control section 3 of the content reproduction apparatus 1 enters the partial reproduction mode again.

In this manner, the control section 3 of the content reproduction apparatus 1 suitably performs changeover between the partial reproduction mode and the normal reproduction mode and, whichever mode is selected, normally reproduces the music data Ad during execution of the Music Station function.

In this instance, when the Music Station function is executed, the content reproduction apparatus 1 allows the user to change over the channel playlist PL in a unit of a channel and change over the tune within the channel in such a sense that the preset radio broadcasting station is changed over. Consequently, the content reproduction apparatus 1 allows the user to enjoy a desired tune in such a sense that it enjoys music broadcast from a radio broadcasting station.

Here, the procedure of the starting process, channel changeover process and tune changeover process of the Music Station function is described.

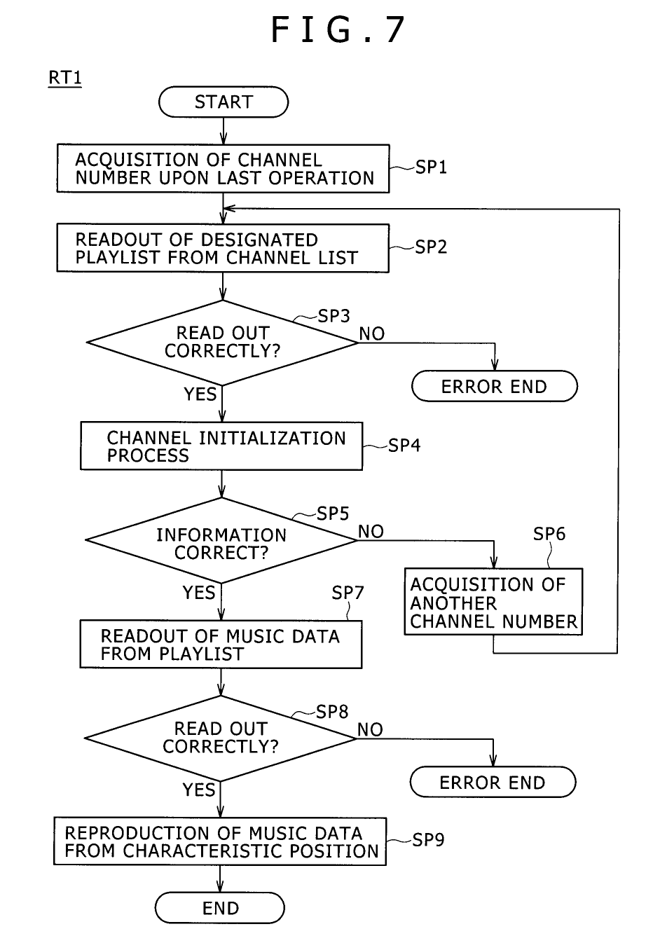

First, the procedure of the Music Station function starting process is described. Referring to FIG. 7, if the control section 3 of the content reproduction apparatus 1 recognizes that a Music Station function starting operation is performed through the operation section 2, then it starts a Music Station function starting processing procedure RT1 and advances the processing to step SP1.

At step SP1, the control section 3 acquires the channel number CN of the channel selected last during last operation of the Music Station function and then advances the processing to step SP2. Incidentally, the control section 3 of the content reproduction apparatus 1 stores information representative of the channel number CN of the currently selected channel (the information is hereinafter referred to as currently selected channel information) in the storage section 6 and suitably updates the currently selected channel information at a timing at which the channel number CN is changed over. In other words, the channel number CN indicated by the currently selected channel information stored in the storage section 6 at this point of time is the channel number CN selected last during last operation of the Music Station function. The control section 3 thus acquires the channel number CN selected last during last operation by acquiring the currently selected channel information.

At step SP2, the control section 3 designates a channel playlist PL corresponding to the acquired channel number CN based on the channel list CL and reads out the designated channel playlist PL (hereinafter referred to also as designated list) from the storage section 6. Then, the processing advances to step SP3.

At step SP3, the control section 3 decides whether or not the designated list PL has been read out correctly. If a negative result is obtained at step SP3, then since this signifies that the data of the designated list PL are broken and consequently the designated list PL cannot be read out correctly, the control section 3 ends the Music Station function starting processing procedure RT1 as an error end.

On the other hand, if an affirmative result is obtained at step SP3, then the control section 3 recognizes that the designated list PL is read out correctly and advances the processing to step SP4.

At step SP4, the control section 3 executes an initialization process for the designated list PL (the process is hereinafter referred to also as channel initialization process). The channel initialization process includes, for example, a process of re-arranging, where the tune order setting Ls of the channel playlist PL indicates shuffle reproduction, the reproduction order indicated in the channel playlist PL at random. After such a channel initialization process as just described is executed, the control section 3 advances the processing to next step SP5.

At step SP5, the control section 3 decides whether or not the information of the designated list PL (list information Li and music data information Ai) after the channel initialization process is correct. If a negative result is obtained at step SP5, then this signifies that, for example, the list reproduction setting Ldi included in the list information Li of the designated list PL includes inhibition of reproduction of the music data Ad according to the designated list PL, and consequently, the information of the designated list PL is not correct. In this instance, the processing advances to step SP6, at which the control section 3 newly acquires the channel number CN of a channel whose reproduction of music data Ad is permitted and to which, for example, the default playlist DPL is allocated. Thereafter, the processing returns to step SP2 so that the channel playlist PL corresponding to the newly acquired channel number CN is read out.

On the other hand, if an affirmative result is obtained at step SP5, then the control section 3 recognizes that the information of the designated list PL is correct, and then advances the processing to step SP7.

At step SP7, the control section 3 designates one of music data Ad (for example, music data Ad whose reproduction order number is 1) from the designated list PL and reads out the music data Ad designated in this manner (hereinafter referred to also as designated music data). Thereafter, the processing advances to step SP8.

At step SP8, the control section 3 decides whether or not the music data Ad is read out correctly. If a negative result is obtained at step SP8, then this signifies that, for example, the music data Ad is broken and therefore cannot be read out correctly. In this instance, the control section 3 ends the Music Station function starting processing procedure RT1 as an error end.

On the other hand, if an affirmative result is obtained at step SP8, then the control section 3 recognizes that the music data Ad is read out correctly and advances the processing to step SP9. At step SP9, the control section 3 causes the display section 4 to display the selection screen 10 which displays the channel number CN obtained at step SP1 or SP6 described hereinabove as the channel number CNs of the currently selected channel. The selection screen 10 further displays the list information Li (list name Lt and list explanation Lde) of the designated list PL read out at step SP2 described hereinabove and the attribute information Ti (jacket image, tune name and artist name) of the music data Ad read out at step SP7 described hereinabove. Further, the control section 3 starts reproduction of the music data Ad from a characteristic position (for example, a position indicated by one of the three positions of the characteristic position information Ct1 to Ct3) and then ends the Music Station function starting processing procedure RT1.

The content reproduction apparatus 1 starts the Music Station function in accordance with such a Music Station function starting processing procedure RT1 as described above.

By starting reproduction of music data Ad automatically after the Music Station function is started, the control section 3 of the content reproduction apparatus 1 can provide a tune based on the music data Ad to the user in such a manner as that the user has a feeling as if it heard music broadcast from a radio broadcast station.

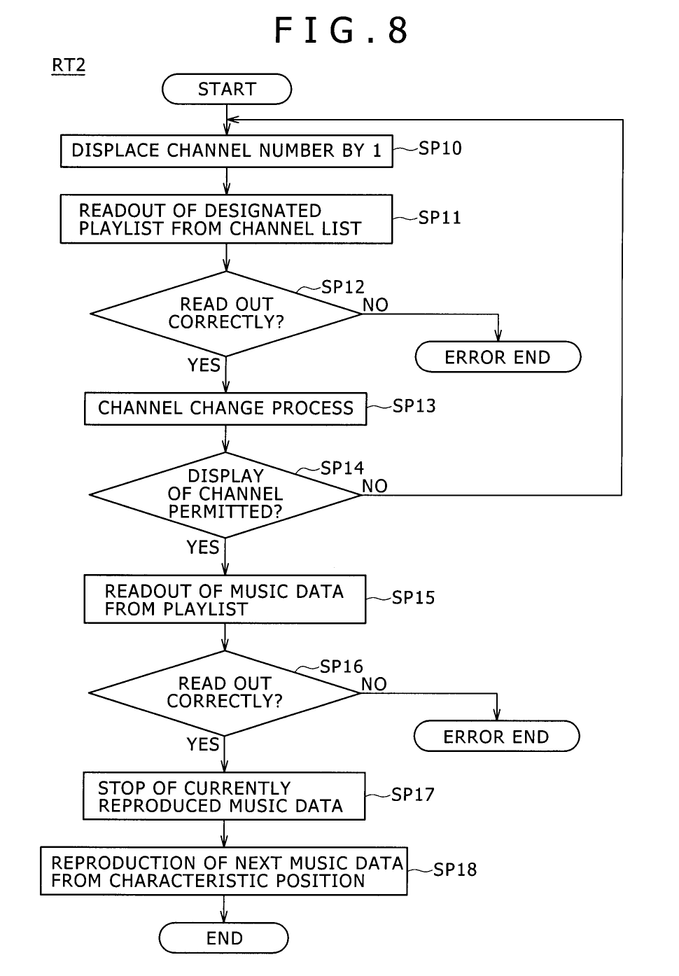

Now, a procedure of the channel changeover process by the Music Station function is described with reference to FIG. 8. If the control section 3 of the content reproduction apparatus 1 starts the Music Station function and then recognizes, while music data Ad is reproduced, that a channel changeover operation is performed through the operation section 2, then it starts a channel changeover processing procedure RT2 and advances the processing to step SP10.

At step SP10, the control section 3 displaces, in response to a channel changeover operation, the channel number CN by −1 or by +1 from the channel number CN of the channel which has been selected before the channel changeover operation (that is, from the channel number CNs displayed on the selection screen 10) (that is, to the channel number CNr or to the channel number CNt) and sets the thus displaced channel number CN as the channel number CN after the changeover. Thereafter, the processing advances to step SP11.

Incidentally, the control section 3 controls the changeover of the channel number CN annularly such that the top one and the tail one of the channel number CN are connected to each other. In other words, the control section 3 recognizes, at step SP10, the top channel number CN−1 as the tail channel number CN but recognizes the tail channel number CN+1 as the top channel number CN.

At step SP11, the control section 3 designates the channel playlist PL corresponding to the channel number CN after the changeover based on the channel list CL and reads out the designated channel playlist PL (designated list) from the storage section 6. Then, the processing advances to step SP12.

At step SP12, the control section 3 decides whether or not the designated list PL has been read out correctly. If a negative result is obtained at step SP12, then this signifies that, for example, the data of the designated list PL is broken and consequently the designated list PL cannot be read out correctly. In this instance, the control section 3 ends the channel changeover processing procedure RT2 as an error end.

On the other hand, if an affirmative result is obtained at step SP12, then the control section 3 recognizes that the designated list PL is read out correctly and advances the processing to step SP13.

At step SP13, the control section 3 executes a process for the designated list PL (the process is hereinafter referred to also as channel change process). The channel change process may be a process of re-constructing a channel playlist PL formed from music data Ad corresponding to a tune whose reproduction time number is great in response to the reproduction time number of each music data Ad before the point of time. After such a channel change process is executed, the control section 3 advances the processing to step SP14.

At step SP14, the control section 3 decides based on the list reproduction setting Ldi included in the list information Li of the designated list PL after the channel change process whether or not display of the channel to which the designated list PL is allocated is permitted. If a negative result is obtained at step SP14, then this signifies that, since the list reproduction setting Ldi indicates that reproduction of the music data Ad registered in the designated list PL is inhibited, display of the channel to which the designated list PL is allocated is inhibited. In this instance, the control section 3 returns the processing to step SP10, at which it sets a number obtained by displacing the formerly obtained channel number CN after the changeover by +1 or −1 as a channel number CN after the changeover.

On the other hand, if an affirmative result is obtained at step SP14, then since the list reproduction setting Ldi indicates that reproduction of the music data Ad registered in the designated list PL is permitted, the control section 3 recognizes that display of the channel to which the designated list PL is allocated is permitted. Thereafter, the processing advances to step SP15.

At step SP15, the control section 3 designates one music data Ad (for example, music data Ad whose reproduction order number is 1) from within the designated list PL and reads out the designated music data Ad from the storage section 6. Thereafter, the processing advances to step SP16.

At step SP16, the control section 3 decides whether or not the designated music data Ad has been read out correctly. If a negative result is obtained at step SP16, then this signifies that, for example, because the music data Ad is broken, the designated music data Ad cannot be read out correctly. In this instance, the control section 3 ends the channel changeover processing procedure RT2 as an error end.

On the other hand, if an affirmative result is obtained at step SP16, then the control section 3 recognizes that the designated music data Ad has been read out correctly, and advances the processing to step SP17, at which the control section 3 stops the reproduction of the currently reproduced music data Ad. Then at step SP18, the control section 3 causes the display section 4 to display the selection screen 10 which displays the channel number CN after the changeover obtained at step SP10 described hereinabove as the channel number CNs of the currently selected channel. The selection screen 10 further displays the list information Li (list name Lt and list explanation Lde) of the designated list PL read out at step SP11 described hereinabove and the attribute information Ti (jacket image, tune name and artist name) of the music data Ad read out at step SP15 described hereinabove. Then, the control section 3 starts reproduction of the music data Ad from a characteristic position (for example, a position indicated by one of the three positions of the characteristic position information Ct1 to Ct3) and then ends the channel changeover processing procedure RT2.

The content reproduction apparatus 1 changes over the channel by such a channel changeover processing procedure RT2 as described above.

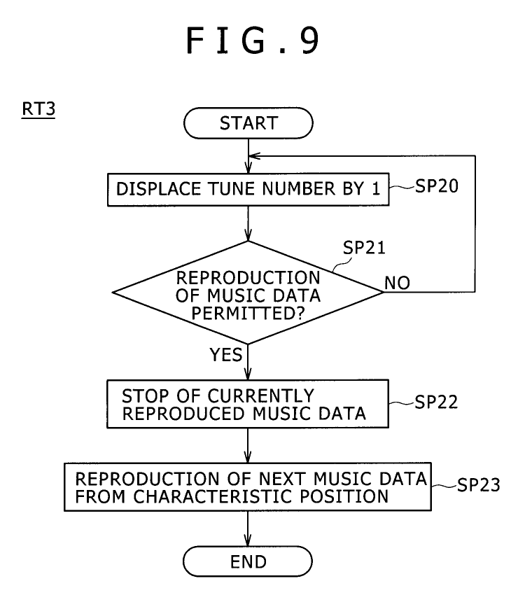

Now, a procedure of the tune changeover process by the Music Station function is described. Referring to FIG. 9, if the control section 3 of the content reproduction apparatus 1 starts the Music Station function and then recognizes, while music data Ad is reproduced, that a tune changeover operation is performed through the operation section 2, then it starts a tune changeover processing procedure RT3 and advances the processing to step SP20.

At step SP20, the control section 3 displaces, in response to a tune changeover operation, the tune number of the music data information Ai corresponding to the tune, which has been in a selected state till time immediately before the tune changeover operation, by −1 or +1 and sets the thus displaced tune number as the tune number after the changeover in the channel playlist PL allocated to the currently selected channel. Thereafter, the processing advances to step SP21.

Incidentally, the control section 3 controls the changeover of the tune number annularly such that the top one and the tail one of the tune numbers are connected to each other. In other words, the control section 3 recognizes, at step SP20, the top tune number −1 as the tail tune number but recognizes the tail tune number +1 as the top tune number.

At step S21, the control section 3 decides based on the music data reproduction setting Adi of the music data information Ai corresponding to the tune number after the changeover whether or not reproduction of the music data (designated music data) Ad designated by the music data information Ai is permitted. If a negative result is obtained at step SP21, then since this signifies that reproduction of the designated music data Ad is inhibited, the control section 3 returns the processing to step SP20, at which it sets a number displaced by +1 or −1 from the tune number after the changeover acquired formerly as a new tune number after the changeover.

On the other hand, if an affirmative result is obtained at step SP21, then the control section 3 recognizes that reproduction of the designated music data Ad is permitted, and advances the processing to step SP22.

At step SP22, the control section 3 stops the reproduction of the currently reproduced music data Ad and advances the processing to step SP23. At step SP23, the control section 3 causes the display section 4 to display the selection screen 10 which displays the attribute information Ti (jacket image, tune name and artist name) of the designated music data Ad. Further, the control section 3 starts reproduction of the designated music data Ad from a characteristic position (for example, a position indicated by one of the three positions of the characteristic position information Ct1 to Ct3) and then ends the tune changeover processing procedure RT3.

The content reproduction apparatus 1 changes over the tune by such a tune changeover processing procedure RT3 as described above.

Here, a setting method of the list reproduction setting Ldi of the playlists PL (PL1, PL2, PL3, . . . ) allocated to the individual channels is described. Incidentally, as described hereinabove in connection with the channel changeover processing procedure RT2, if the list reproduction setting Ldi of a channel playlist PL indicates that reproduction of the music data Ad registered in the channel playlist PL is permitted, the Music Station function permits display of the channel to which the channel playlist PL is allocated. However, if the list reproduction setting Ldi indicates that reproduction of the music data Ad registered in the channel playlist PL is inhibited, then the Music Station function inhibits display of the channel to which the channel playlist PL is allocated.

In short, the Music Station function allows setting of whether a channel of a GUI screen is to be displayed or not based on the list reproduction setting Ldi. Therefore, the setting method of list reproduction setting Ldi is described as a channel display setting method.

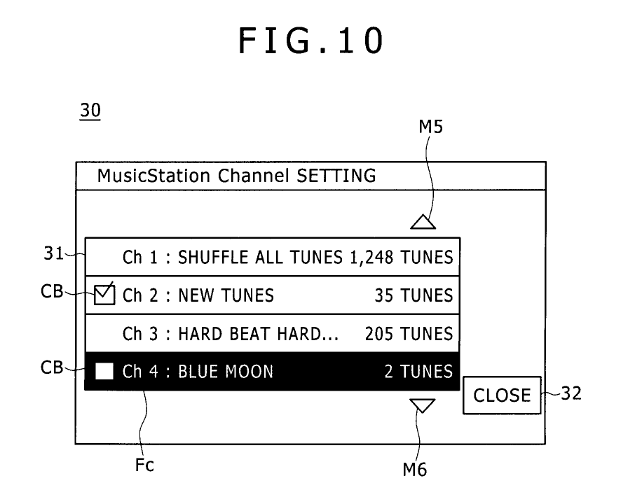

In particular, if the control section 3 of the content reproduction apparatus 1 recognizes that a setting calling operation is performed for the operation section 2 during execution of the Music Station function, then it causes the display section 4 to display such a channel display setting screen 30 as shown in FIG. 10.

Referring to FIG. 10, on the channel display setting screen 30, a channel information list 31 in which information (hereinafter referred to also as channel information) of those channels which can be utilized by the Music Station function is arranged in order of the channel list CL is disposed at a central portion. Further, a close button 32 for ending the setting to close the channel display setting screen 30 is displayed at a right lower corner portion of the channel display setting screen 30.

The channel information list 31 displays only channel information of, for example, four channels (that is, four lines) from within the channel information of all channels. Further, the channel information includes check box CB indicative of display setting of a channel, a channel number (for example, “Ch2”), a list name (for example, “new tunes”) of the channel playlist PL allocated to the channel and the number (for example, “35 tunes” of the music data Ad registered in the channel playlist PL. Incidentally, the check box CB indicates that, if a check mark is applied thereto, then the channel display setting is “display”, but if no check mark is applied, then the channel display setting is “no display”. Further, a channel for which the check box CB is not displayed is a default channel with regard to which the channel display setting is fixed to “display”, that is, a channel to which the default playlist DPL whose list reproduction setting Ldi is fixed to “reproduction permitted” is allocated.

Further, in the channel information list 31, a focus Fc is displayed for the selected channel information.

Further, a fifth mark M5 of a triangular shape with a vertex thereof directed upwardly is displayed on the upper side and in the proximity of the channel information list 31. Meanwhile, a sixth mark M6 of a triangular shape with a vertex thereof directed upwardly is displayed on the lower side and in the proximity of the channel information list 31. Each of the fifth mark M5 and the sixth mark M6 indicates that the focus Fc displayed in the channel information list 31 can be displaced upwardly or downwardly by one stage to different channel information by an operation of the operation section 2.

Then, the control section 3 of the content reproduction apparatus 1 moves, in response to a focus moving operation through the operation section 2, the focus Fc within the channel information list 31 to select one piece of the channel information.

Incidentally, although only channel information for four channels is displayed at a time on the channel information list 31, for example, if a focus moving operation for moving the focus Fc upwardly by one stage while the focus Fc is displayed at the channel information at the uppermost stage or vice versa, then the channel information displayed in the channel information list 31 is scrolled by one stage in the upward direction or the downward direction. Consequently, the user can confirm the channel information of all channels.

At this time, the control section 3 of the content reproduction apparatus 1 allows the user to tentatively listen to the tunes which are enjoyable in the channel corresponding to the channel information selected by the focus Fc by successively reproducing the music data Ad registered in the channel playlist PL of the channel, for example, for several seconds for each music data Ad from a characteristic position.

Then, if a display setting changing operation for the operation section 2 is performed while some channel information is selected, then the control section 3 of the content reproduction apparatus 1 removes, if a check mark is applied to the check box CB of the selected channel information, the check mark thereby to change the channel display setting from “display” to “no display”. However, if no check mark is applied, then the control section 3 newly applies a check mark thereby to change the channel display setting from “no display” to “display”.

Thereafter, if the close button 32 of the channel display setting screen 30 is depressed by an operation for the operation section 2, then the control section 3 of the content reproduction apparatus 1 reflects the channel display setting (that is, presence or absence of a check mark in the check box CB) on the channel display setting screen 30 on the list reproduction setting Ldi of the channel playlist PL allocated to each channel. Then, the control section 3 closes the channel display setting screen 30.

In this manner, the channel display setting can be changed for each channel on the channel display setting screen 30. Then, with regard to any channel whose channel display setting is changed to “no display”, no GUI screen (that is, none of the selection screen 10 and the reproduction screen 20) is displayed any more, and therefore, no selection is permitted naturally.

Consequently, the content reproduction apparatus 1 allows the user to set which channel should be displayed on the selection screen 10 and the reproduction screen 20 so as to be selected. Therefore, for example, the channel configuration to be displayed on the selection screen 10 can be set so as to conform with the liking of the user.

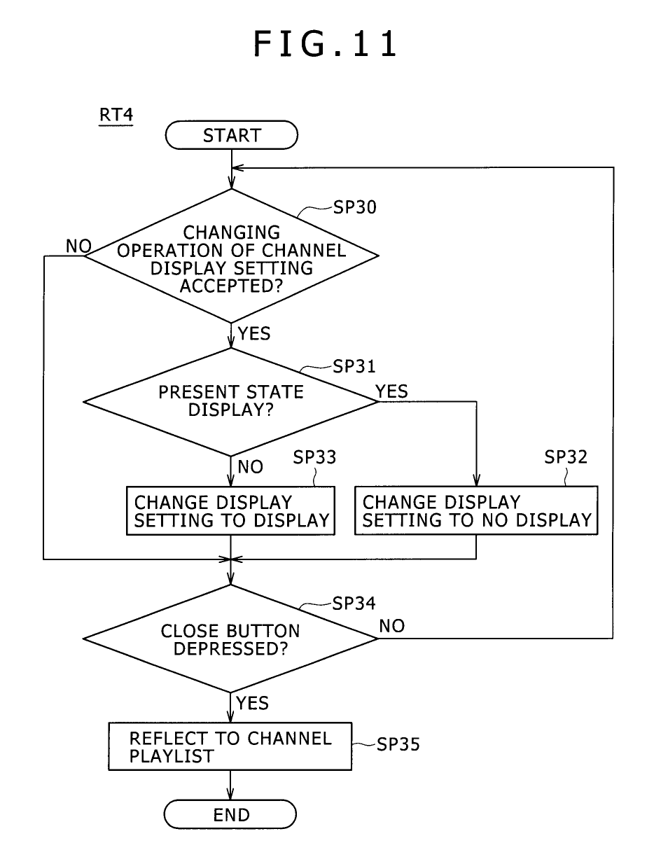

Now, a procedure of the process of channel display setting (hereinafter referred to also as channel display setting process) is described. If the control section 3 of the content reproduction apparatus 1 recognizes that a setting calling operation is performed through the operation section 2 during execution of the Music Station function, then it changes over the GUI screen of the Music Station function to a channel display setting screen 30. Then, the control section 3 starts such a channel display setting processing procedure RT4 as illustrated in FIG. 11 and advances the processing to step SP30.

Referring to FIG. 11, at step SP30, the control section 3 decides whether or not a display setting changing operation is accepted through the operation section 2 while channel information is selected through the focus Fc. If an affirmative result is obtained at step SP30, then the control section 3 advances the processing to step SP31.

At step SP31, the control section 3 decides whether or not the display setting at present of the currently selected channel information is “display”. If an affirmative result is obtained at step SP31, then this signifies that the display setting at present of the currently selected channel information is “display”, that is, a check mark is applied in the check box CB. In this instance, the control section 3 advances the processing to step SP32.

At step SP32, the control section 3 removes the check mark applied to the check box CB of the currently selected channel information to change the display setting from “display” to “no display”, and then advances the processing to step SP34.

On the other hand, if a negative result is obtained at step SP31, then this signifies that the display setting at present of the currently selected channel information is “no display”, that is, no check mark is applied to the check box CB. In this instance, the control section 3 advances the processing to step SP33.

At step SP33, the control section 3 applies a check mark to the check box CB of the currently selected channel information to change the display setting from “no display” to “display”, and then advances the processing to step SP34.

On the other hand, if a negative result is obtained at step SP30, then the control section 3 advances the processing directly to step SP34 while omitting the processes at steps SP31 to SP33.

At step SP34, the control section 3 decides whether or not the close button 32 of the channel display setting screen 30 is depressed through the operation section 2. If a negative result is obtained at step SP34, then this signifies that the user wants to continue the channel display setting. In this instance, the control section 3 returns the processing to step SP30, at which it performs an acceptance decision of a display setting changing operation.

On the other hand, if an affirmative result is obtained at step SP34, then this signifies that the user wants to end the channel display setting. In this instance, the control section 3 advances the processing to step SP35, at which it reflects the channel display setting performed on the channel display setting screen 30 on the list reproduction setting Ldi of the channel playlist PL allocated to each channel. Then, the control section 3 closes the channel display setting screen 30 and ends the channel display setting processing procedure RT4.

The content reproduction apparatus 1 changes the channel display setting in accordance with such a channel display setting processing procedure RT4 as described above.

As described above, the content reproduction apparatus 1 which has a basic configuration of the present invention has the Music Station function as one of reproduction functions of music data and can utilize the Music Station function to provide music (that is, tune) based on music data Ad to the user such that the user feels as if it enjoyed music broadcast from a radio broadcasting station.

In the following, first to fourth embodiments of the present invention which are based on the basic configuration having the Music Station function described above are described.

### 2. First Embodiment

### 2-1. Outline of the First Embodiment

First, an outline of the first embodiment is described. After the outline is described, detailed description of the first embodiment is given herein.

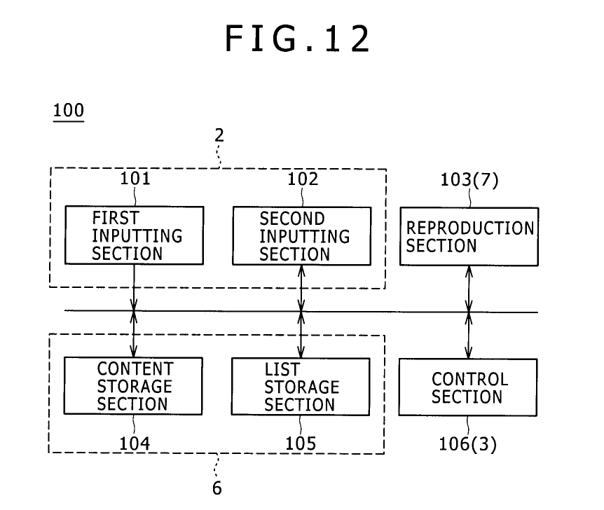

Referring to FIG. 12, there is shown a content reproduction apparatus 100 according to the first embodiment of the present invention. The content reproduction apparatus 100 shown includes a first inputting section 101 for inputting an operation amount in a first direction, a second inputting section 102 for inputting an operation amount in a second direction, and a reproduction section 103 for reproducing a content designated by an input from the first inputting section 101 or the second inputting section 102. The content reproduction apparatus 100 further includes a content storage section 104 for storing one or more contents, a list storage section 105 for storing a plurality of lists each having identification information of contents, and a control section 106 which operates in the following manner. In particular, if the control section 106 receives an input from the first inputting section 101, then it selects one of the lists stored in the list storage section 105 in accordance with the inputted operation amount in the first direction. Then, the control section 106 reads out a content corresponding to the content identification information in the selected list from the content storage section 104 and controls the reproduction section 103 to reproduce the read out content. On the other hand, if the control section 106 receives an input from the second inputting section 102, then it selects content identification information in the selected list in accordance with the inputted operation amount in the second direction. Then, the control section 106 reads out a content corresponding to the selected content identification information from the content storage section 104 and controls the reproduction section 103 to reproduce the read out content.

It is to be noted that the first inputting section 101 and the second inputting section 102 correspond to the operation section 2 of the content reproduction apparatus 1 (FIG. 1) having the basic configuration described hereinabove. Meanwhile, the content storage section 104 and the list storage section 105 correspond to the storage section 6 of the content reproduction apparatus 1, and the reproduction section 103 and the control section 106 correspond to the reproduction section 7 and the control section 3 of the content reproduction apparatus 1, respectively.

In the content reproduction apparatus 100 according to the first embodiment of the present invention having such a configuration as described above, in order for the user to reproduce a desired content, it is necessary for the user to perform only two selection operations in the maximum including selection of a list by the first inputting section 101 and selection of a content registered in the list by the second inputting section 102. Further, since the first inputting section 101 corresponding to the selection of a list and the second inputting section 102 corresponding to the selection of a content are formed as separate inputting sections from each other, the selection of a list by the first inputting section 101 and the selection of a content by the second inputting section 102 can be performed in parallel to each other. Therefore, reproduction of a desired content can be performed further readily when compared with reproduction by an apparatus in the past.

### 2-2. Particular Configuration of the First Embodiment

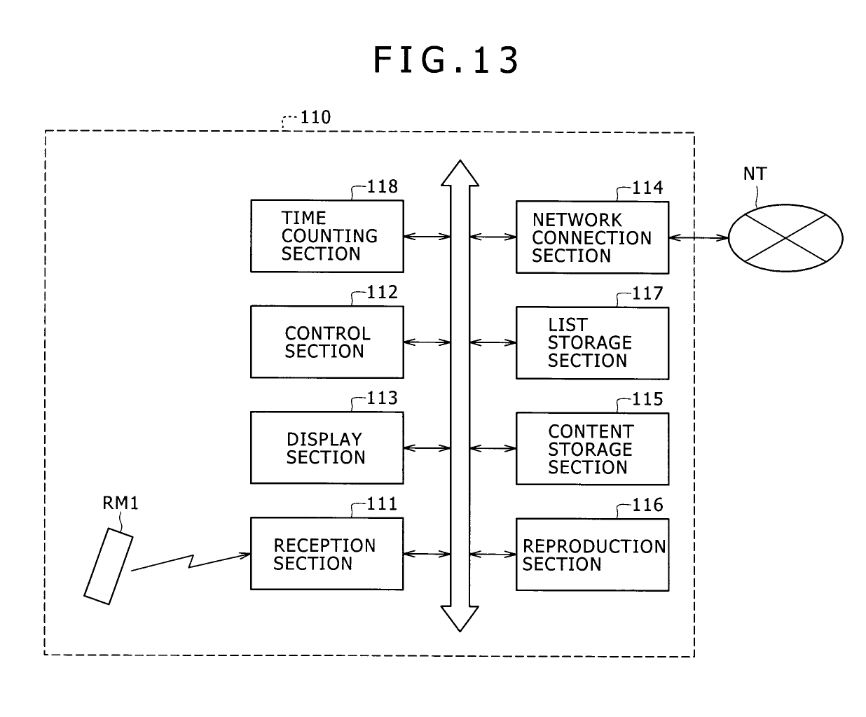

Now, a particular configuration of the first embodiment is described. Referring to FIG. 13, a music reproduction apparatus 110 shown is a particular example of the content reproduction apparatus 100 described hereinabove and is generally configured such that an operation signal transmitted from a remote controller RM1 is received and converted into an operation instruction by a reception section 111 and a control section 112 controls components of music reproduction apparatus 110 in accordance with the operation instruction to execute various processes.

Further, the music reproduction apparatus 110 has a plurality of functions relating to recording and reproduction of music data, and the control section 112 changes over the operative function among the functions in response to an operation of the remote controller RM1 and controls a display section 113 to display a GUI (Graphical User Interface) screen corresponding to each of the functions. Incidentally, the music data here are data corresponding to tunes (tunes) of music.

If the control section 112 of the music reproduction apparatus 110 receives an instruction to change over the operative function, for example, to a download function for downloading music data through the remote controller RM1, then it controls the display section 113 to display a GUI screen corresponding to the download function. Thereafter, if the control section 112 receives an instruction to download music data, then it receives music data provided from a music providing server not shown by means of a network connection section 114 thereof through a network NT and stores the received music data into a content storage section 115.

Further, if the control section 112 of the music reproduction apparatus 110 receives an instruction to change over the operative function to a CD recording function for recording a CD through the remote controller RM1, then it controls the display section 113 to display a GUI screen corresponding to the CD recording function. Then, if the control section 112 receives an instruction to record a CD, then it reads out music data from a CD not shown currently loaded in the music reproduction apparatus 110, performs a compression coding process for the read out music data and then stores resulting music data into the content storage section 115.

Further, if the control section 112 of the music reproduction apparatus 110 receives an instruction to change over the operative function to a normal reproduction function for reproducing music data stored in the content storage section 115, then it controls the display section 113 to display a GUI screen corresponding to the normal reproduction function. Thereafter, if the control section 112 receives an instruction to reproduce music data, then it reads out the music data from the content storage section 115 in accordance with the instruction and controls a reproduction section 116 to perform a reproduction process including a decoding process, an equalizing process, a digital to analog conversion process, an amplification process and so forth for the read out music data thereby to output music (that is, a tune) based on the music data.

Further, if the control section 112 of the music reproduction apparatus 110 receives an instruction to change over the operative function to a CD reproduction function for reproducing a CD through the remote controller RM1, then it controls the display section 113 to display a GUI screen corresponding to the CD reproduction function. Then, if the control section 112 receives an instruction to reproduce the CD, then it reads out music data from a CD not shown currently loaded in the music reproduction apparatus 110 and then controls the reproduction section 116 to perform a reproduction process for the read out music data thereby to output music (a tune) based on the music data.

In this manner, the control section 112 of the music reproduction apparatus 110 executes a process in response to any of the various functions.

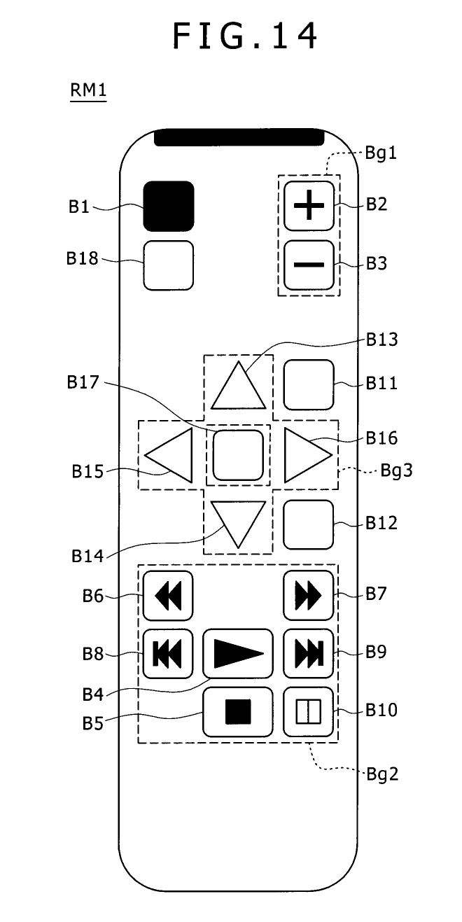

Here, a configuration of the remote controller RM1 is described with reference to FIG. 14. The remote controller RM1 includes a power supply button B1 to which a power supply on/off instruction of the music reproduction apparatus 110 is allocated, and a sound volume operation section Bg1 including sound volume operation buttons B2 and B3 to which sound volume increasing and decreasing instructions are allocated, respectively. The remote controller RM1 further includes a reproduction operation section Bg2 including reproduction control buttons B4, B5, B6, B7, B8, B9 and B10 to which reproduction control instructions (reproduction, stopping, fast forward, rewinding, tune forward, tune returning and pause) for music data are allocated. The remote controller RM1 further includes a function changeover button B11 to which a function changeover instruction is allocated, and a setting button B12 to which a setting calling instruction is allocated. The remote controller RM1 further includes a cross operation section Bg3 which in turn includes an upward button B13 and a downward button B14 to which operation instructions in the upward and downward directions on a GUI screen are allocated, respectively, and a leftward button B15 and a rightward button B16 to which operation directions in the leftward and rightward directions are allocated, respectively. The remote controller RM1 further includes a determination button B17 to which a determination instruction on a GUI screen is allocated, and an entrust button B18 to which an entrust channel selection instruction hereinafter described is allocated.

In particular, the control section 112 of the music reproduction apparatus 110 changes over the function in response to a user operation for the function changeover button B11 provided on the remote controller RM1, and controls reproduction of music data, for example, in the normal reproduction function in response to a user operation for the reproduction operation section Bg2. Further, the control section 112 performs selection and determination of music data to be downloaded, for example, in the download function in response to a user operation for the cross operation section Bg3 and the determination button B17, respectively.

It is to be noted that the upward button B13 and the downward button B14 of the remote controller RM1 correspond to the first inputting section 101 of the content reproduction apparatus 100 described hereinabove with reference to FIG. 12, and the leftward button B15 and the rightward button B16 correspond to the second inputting section 102. Further, the control section 112, content storage section 115, reproduction section 116 and list storage section 117 of the music reproduction apparatus 110 correspond to the control section 106, content storage section 104, reproduction section 103 and list storage section 105 of the content reproduction apparatus 100 described hereinabove, respectively.

Further, the music reproduction apparatus 110 has the Music Station function similarly to the basic configuration described hereinabove. The Music Station function is described below. It is to be noted that the Music Station function which the music reproduction apparatus 110 has corresponds to operations of the remote controller RM1 based on the Music Station function described hereinabove in connection with the basic configuration. Thus, an operation system of the Music Station function is described below.

First, a management method of music data Ad by the Music Station function of the music reproduction apparatus 110 is described. The management method is similar to the management method by the basic configuration described hereinabove except that the database DB is constructed in the content storage section 115, that is, the music data Ad are stored in the content storage section 115, and playlists PL and the channel list CL are stored into the list storage section 117. Thus, detailed description of the common configuration is omitted herein to avoid redundancy.

In particular, also the music reproduction apparatus 110 manages a plurality of channel lists PL in accordance with the channel list CL as seen in FIG. 2 similarly to the basic configuration described hereinabove. Further, the music reproduction apparatus 110 manages the reproduction tune order of music data Ad using the channel playlists PL.

Further, similarly as in the basic configuration described hereinabove, the Music Station function prepares a channel playlist PL for each of classes which are considered to be requested by users such as a newly added tune, a tune whose reproduction time number is small, a catchy tune, a bright tune, a classical tune, or a heavy metal tune. Thus, the control section 112 of the music reproduction apparatus 110 automatically updates the channel playlists PL in response to storage or reproduction of music data Ad such that the music data Ad stored in the content storage section 115 is registered into a pertaining one of the prepared channel playlists PL based on the reproduction time number, an impression value of the tune, genre and so forth of the music data Ad.

Then, the music reproduction apparatus 110 selects one of the channel playlists PL classified into a newly added tune, a tune whose reproduction time number is small, catchy music, bright music, classical music, heavy metal music and so forth as a channel in response to a user operation on a GUI screen hereinafter described. Consequently, the user can find out a desired tune readily in such a feeling of changing over of the channel of a radio broadcast.

Now, GUI screens by the Music Station function are described. While the GUI screens have a similar screen configuration to those of the basic configuration described hereinabove, they are different in that they correspond to operations of the remote controller RM1. Thus, the following description is given principally of such differences.

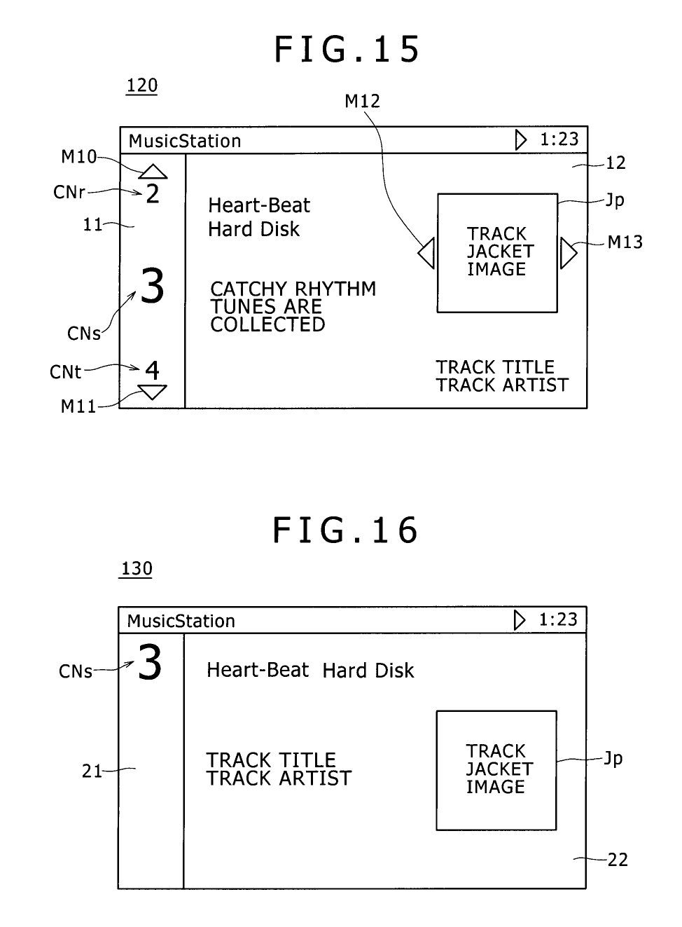

In particular, the music reproduction apparatus 110 starts the Music Station function in response to a Music Station function starting operation by the function changeover button B11 of the remote controller RM1, and controls the display section 113 to display a selection screen 120 shown in FIG. 15 as a GUI screen.

The selection screen 120 has a vertically elongated channel selection region 11 disposed at a left end thereof and has a tune selection region 12 disposed at the remaining portion thereof. At a central portion of the channel selection region 11, the channel number CNs (for example, “3”) of a currently selected channel is displayed. At upper and lower portions of the channel selection region 11, channel numbers CNr (for example, “2”) and CNt (for example, “4”) of channels which can be selected when the channel is changed over from the currently selected channel are displayed.

Further, a first mark M10 of a triangular shape with a vertex thereof directed upwardly is displayed in the proximity and on the upper side of the channel number CNr. Meanwhile, a second mark M11 of a triangular shape with a vertex thereof directed downwardly is displayed in the proximity and on the lower side of the channel number CNt. Each of the first mark M10 and the second mark M11 has a shape corresponding to that of the upward button B13 and the downward button B14 provided on the remote controller RM1 and indicates that, if the upward button B13 is depressed or operated, then the currently selected channel can be changed over to the channel of the channel number CNr, while if the downward button B14 is depressed or operated, then the currently selected channel can be changed over to the channel of the channel number CNt.

Then, the control section 112 of the music reproduction apparatus 110 changes over the channel number CNs displayed in the channel selection region 11 in accordance with the order of the channel numbers CN (CN1, CN2, CN3, . . . ) in the channel list CL (that is, changes over the channel) in response to a channel changeover operation for the upward button B13 or the downward button B14 of the remote controller RM1 thereby the user can recognize channel changeover readily.

On the other hand, at a left portion of the tune selection region 12, the list name of a channel playlist PL (currently selected list) allocated to the channel currently selected and a list explanation are displayed. Thus, the control section 112 of the music reproduction apparatus 110 changes over the list name and the list explanation displayed in the tune selection region 12 in response to a channel changeover operation for the upward button B13 or the downward button B14 of the remote controller RM1 thereby to allow the user to recognize the substance of the currently selected channel readily.

Meanwhile, at a right portion of the tune selection region 12, a jacket image Jp corresponding to a currently selected tune (that is, tune based on music data Ad corresponding to the music data information Ai selected from the currently selected list PL) is displayed. Further, the title and the artist name of the currently reproduced tune are displayed on the lower side of the jacket image Jp.

Further, on the left side and in the proximity of the jacket image Jp, a third mark M12 of a triangular shape with a vertex thereof directed leftwardly is displayed. Meanwhile, on the right side and in the proximity of the jacket image Jp, a fourth mark M13 of a triangular shape with a vertex thereof directed rightwardly is displayed. Each of the third mark M12 and the fourth mark M13 has a shape corresponding to the leftward button B15 and the rightward button B16 provided on the remote controller RM1 and indicates that, if the leftward button B15 is depressed or operated, then the tune to be selected can be changed over to another tune based on the immediately preceding music data Ad in accordance with the selected list PL, but if the rightward button B16 is depressed or operated, then the tune to be selected can be changed over to another tune based on the immediately succeeding music data Ad in accordance with the selected list PL.

Thus, the control section 112 of the music reproduction apparatus 110 can change over the jacket image Jp, music name and artist name displayed in the tune selection region 12 (that is, change over the tune) in response to a music changeover operation through the leftward button B15 or the rightward button B16 of the remote controller RM1 thereby to allow the user to recognize the substance of the tune based on the currently reproduced music data Ad readily.

In this manner, the music reproduction apparatus 110 selectively changes over the channel in response to a user operation of the upward button B13 or the downward button B14 of the remote controller RM1 and selectively changes over the tune in response to a user operation of the leftward button B15 or the rightward button B16 of the remote controller RM1 while it causes the user to visually observe the substance of the channel and the substance of the tune through the selection screen 120.

Further, if the determination button B17 of the remote controller RM1 is depressed while such a selection screen 120 as described above is displayed, then the control section 112 of the music reproduction apparatus 110 changes over the GUI screen from the selection screen 120 to such a reproduction screen 130 as shown in FIG. 16.

Referring to FIG. 16, the reproduction screen 130 includes a selection channel display region 21 disposed at a left end portion thereof and a selected tune display region 22 disposed at the remaining portion thereof. In the selection channel display region 21, only the channel number CNs (for example, “3”) of a currently selected channel is displayed. Meanwhile, in the selected tune display region 22, the list name of a channel playlist PL (that is, currently selected list) to which the currently selected channel is allocated and the music name and the artist name corresponding to the currently selected tune are displayed at a left portion. Meanwhile, a jacket image Jp corresponding to the currently selected tune is displayed at a right portion of the selected tune display region 22.

In this manner, the music reproduction apparatus 110 can cause the user to visually recognize the substance of the selected channel and tune through the reproduction screen 130.

Incidentally, also where no user operation is performed for the remote controller RM1 for a predetermined period of time after the selection screen 120 is displayed, the control section 112 of the music reproduction apparatus 110 changes over the GUI screen from the selection screen 120 to the reproduction screen 130 similarly as in the case wherein the determination button B17 of the remote controller RM1 is depressed.

Further, if the control section 112 of the music reproduction apparatus 110 recognizes that a channel changeover operation is performed through the upward button B13 or the downward button B14 of the remote controller RM1 or a tune changeover operation is performed through the leftward button B15 or the rightward button B16 while the reproduction screen 130 is displayed, then it changes over the GUI screen from the reproduction screen 130 back to the selection screen 120.

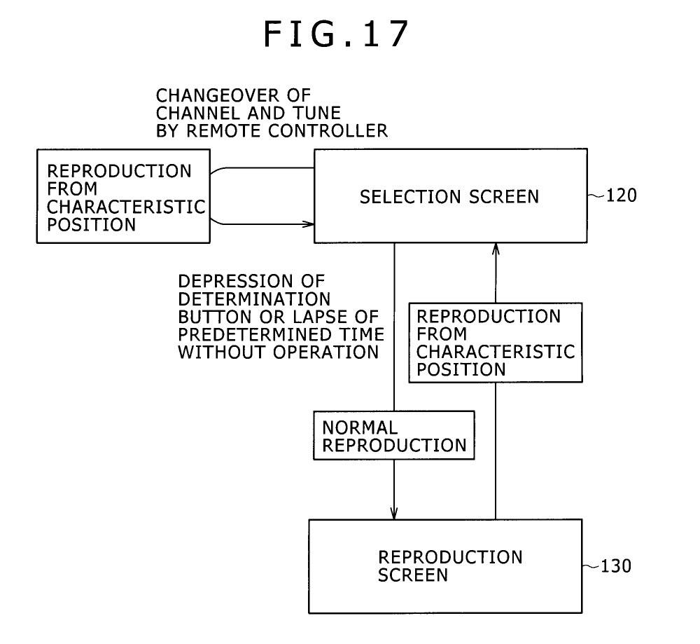

Here, changeover of the GUI screen described above and reproduction control of music data Ad upon such changeover are described with reference to FIG. 17. After the Music Station function is started, the control section 112 of the music reproduction apparatus 110 causes the selection screen 120 to be displayed and enters a partial reproduction mode wherein the music data Ad is reproduced from a characteristic position.

In the partial reproduction mode, the control section 112 of the music reproduction apparatus 110 changes over the channel and changes over the tune to a tune of the channel after the changeover in response to a channel changeover operation by the remote controller RM1 on the selection screen 120 and then changes over the tune within the same channel in response to a tune changeover operation. Then, every time the tune is changed over, the control section 112 of the music reproduction apparatus 110 reproduces the music data Ad corresponding to the tune after the changeover from a characteristic position.

Then, if, in the partial reproduction mode, the determination button B17 of the remote controller RM1 is depressed or if a predetermined interval of time elapses without any user operation for the remote controller RM1, then the control section 112 of the music reproduction apparatus 110 changes over the display screen to the reproduction screen 130 and enters the normal reproduction mode in which the music data Ad is reproduced normally.

Thereafter, the control section 112 of the music reproduction apparatus 110 causes the music data Ad to be reproduced successively from the respective top position in accordance with the selection list PL until a channel changeover operation or a tune changeover operation through the remote controller RM1 is performed. Then, if a channel changeover operation or a tune changeover operation through the remote controller RM1 is performed, then the control section 112 of the music reproduction apparatus 110 enters the partial reproduction mode again.

In this manner, the control section 112 of the music reproduction apparatus 110 suitably performs changeover between the partial reproduction mode and the normal reproduction mode and, whichever mode is selected, successively reproduces the music data Ad without interruption during execution of the Music Station function.

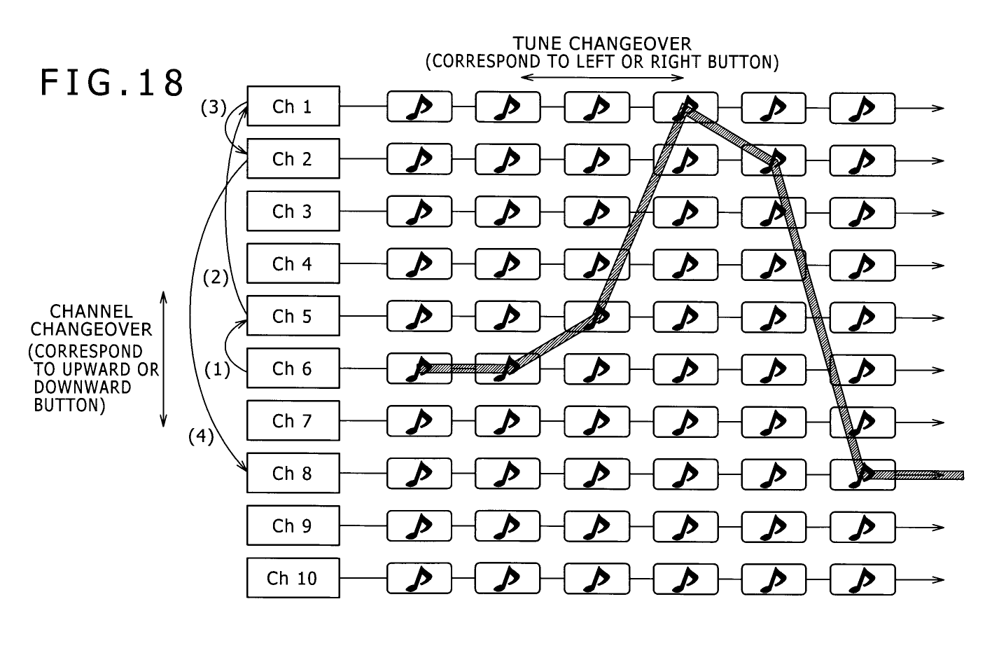

In this instance, when the Music Station function is executed, the music reproduction apparatus 110 allows the user to change over the channel playlist PL in a unit of a channel in accordance with an operation of the upward button B13 or the downward button B14 of the remote controller RM1 in such a sense that the preset radio broadcasting station is changed over as seen in FIG. 18. Further, the music reproduction apparatus 110 can change over the tune to be reproduced in the channel in accordance with an operation of the leftward button B15 or the rightward button B16. Consequently, the music reproduction apparatus 110 allows the user to enjoy a desired tune further readily in such a sense that it enjoys music broadcast from a radio broadcasting station.

Here, the procedure of the Music Station function starting process, channel changeover process and tune changeover process is described. Also in the processes mentioned, the processing substance is substantially similar to that of the processes by the basic configuration described hereinabove. However, the processes mentioned correspond to operations of the remote controller RM1, and therefore, the following description is given in this regard.

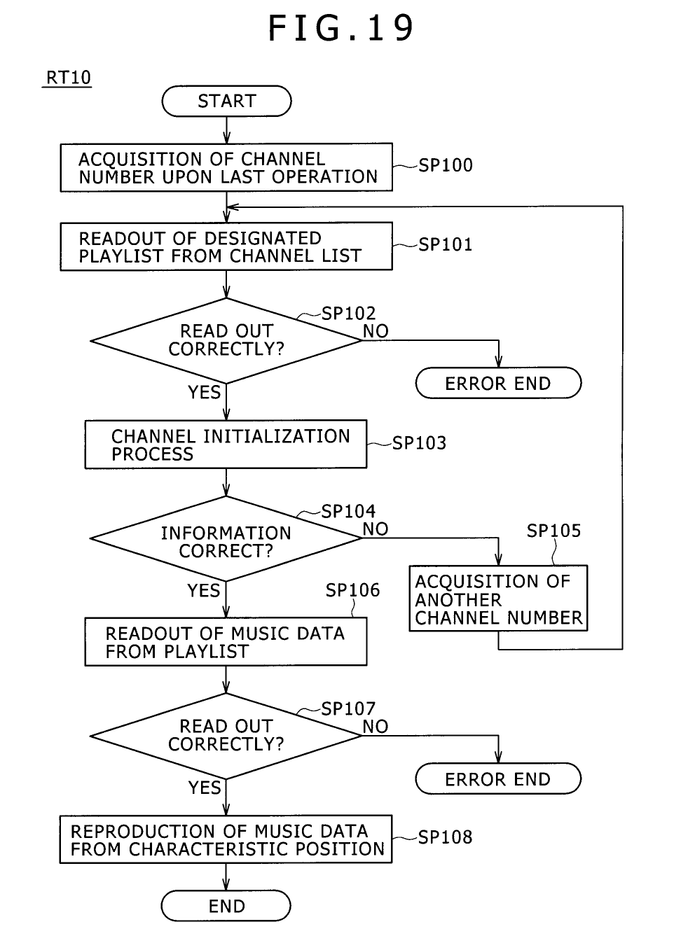

First, the procedure of the Music Station function starting process is described. Referring to FIG. 19, if the control section 112 of the music reproduction apparatus 110 recognizes that a changeover operation to the Music Station function is performed through the remote controller RM1, then it starts a Music Station function starting processing procedure RT10 and advances the processing to step SP100.

At step SP100, the control section 112 acquires the channel number CN of the channel selected last during last operation of the Music Station function and then advances the processing to step SP101. Incidentally, the control section 112 of the music reproduction apparatus 110 is in a state wherein it stores currently selected channel information representative of the channel number CN of the currently selected channel in the content storage section 115 or the list storage section 117, and suitably updates the currently selected channel information at a timing at which the channel number CN is changed over.

At step SP101, the control section 112 designates a channel playlist PL corresponding to the acquired channel number CN based on the channel list CL and reads out the designated channel playlist PL (hereinafter referred to also as designated list) from the list storage section 117. Then, the processing advances to step SP102.

At step SP102, the control section 112 decides whether or not the designated list PL has been read out correctly. If a negative result is obtained at step SP102, then the control section 112 ends the Music Station function starting processing procedure RT10 as an error end. On the other hand, if an affirmative result is obtained at step SP102, then the control section 112 advances the processing to step SP103.

At step SP103, the control section 112 executes an initialization process for the designated list PL (for example, a process of re-arranging the reproduction order indicated in the channel playlist PL at random). Then, the control section 112 advances the processing to next step SP104. At step SP104, the control section 112 decides whether or not the information of the designated list PL after the channel initialization process (that is, the list information Li and the music data information Ai) is correct. If a negative result is obtained at step SP104, then the control section 112 advances the processing to step SP105. At step SP105, the control section 112 newly acquires the channel number CN of a channel to which, for example, the default playlist DPL is allocated. Thereafter, the processing returns to step SP101 so that the channel playlist PL corresponding to the newly acquired channel number CN is read out.

On the other hand, if an affirmative result is obtained at step SP104, then the control section 112 advances the processing to step SP106. At step SP106, the control section 112 designates one of music data Ad (for example, music data Ad whose reproduction order number is 1) from the designated list PL and reads out the designated music data Ad from the content storage section 115. Thereafter, the processing advances to step SP107.

At step SP107, the control section 112 decides whether or not the music data Ad has been read out correctly. If a negative result is obtained at step SP107, then the control section 112 ends the Music Station function starting processing procedure RT10 as an error end. On the other hand, if an affirmative result is obtained at step SP107, then the control section 112 advances the processing to step SP108.

At step SP108, the control section 112 causes the display section 113 to display the selection screen 120 which displays the channel number CN obtained at step SP100 or SP105 described hereinabove as the channel number CNs of the currently selected channel. The selection screen 120 further displays the list information Li (list name Lt and list explanation Lde) of the designated list PL read out at step SP101 described hereinabove and the attribute information Ti (jacket image, tune name and artist name) of the designated music data Ad read out at step SP106 described hereinabove. Further, the control section 112 starts reproduction of the music data Ad from a characteristic position (for example, a position indicated by one of the three positions of the characteristic position information Ct1 to Ct3) and then ends the Music Station function starting processing procedure RT10.

The music reproduction apparatus 110 starts the Music Station function in accordance with such a Music Station function starting processing procedure RT10 as described above.

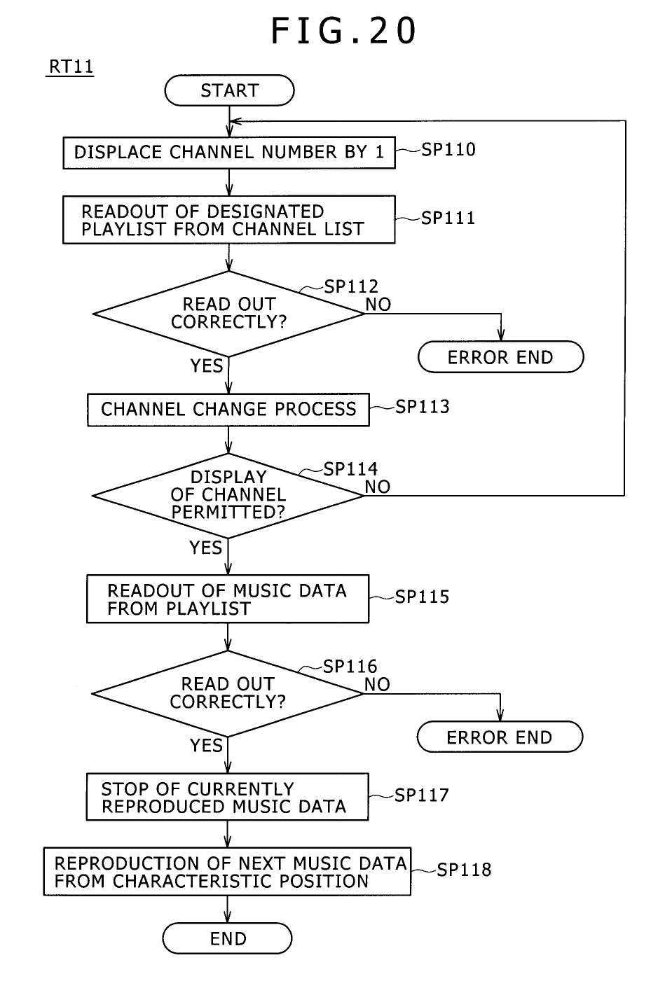

Now, a procedure of the channel changeover process by the Music Station function is described with reference to FIG. 20. If the control section 112 of the music reproduction apparatus 110 starts the Music Station function and then recognizes, while music data Ad is reproduced, that a channel changeover operation is performed through the upward button B13 or the downward button B14 of the remote controller RM1, then it starts a channel changeover processing procedure RT11 and advances the processing to step SP110.

At step SP110, if the upward button B13 of the remote controller RM1 is depressed, then the control section 112 displaces the channel number CN (that is, the channel number CNs displayed on the selection screen 120) of the channel, which has been selected before the channel changeover operation, by −1 from the channel number CN (that is, to the channel number CNr). However, if the downward button B14 of the remote controller RM1 is depressed, then the control section 112 displaces the channel number CN described above by +1 from the channel number CN (that is, to the channel number CNt). Then, the control section 112 sets the thus displaced channel number CN as the channel number CN after the changeover. Thereafter, the processing advances to step SP111.

Incidentally, the control section 112 controls the changeover of the channel number CN annularly such that the top one and the tail one of the channel number CN are connected to each other.

At step SP111, the control section 112 designates the channel playlist PL corresponding to the channel number CN after the changeover based on the channel list CL and reads out the designated channel playlist PL (designated list) from the list storage section 117. Then, the processing advances to step SP112.

At step SP112, the control section 112 decides whether or not the designated list PL has been read out correctly. If a negative result is obtained at step SP112, then the control section 112 ends the channel changeover processing procedure RT11 as an error end. On the other hand, if an affirmative result is obtained at step SP112, then the control section 112 advances the processing to step SP113.

At step SP113, the control section 112 executes a channel change process for the designated list PL (for example, a process of re-constructing the designated list PL). Thereafter, the control section 112 advances the processing to step SP114. At step SP114, the control section 112 decides based on the list reproduction setting Ldi included in the list information Li of the designated list PL after the channel change process whether or not display of the channel to which the designated list PL is allocated is permitted. If a negative result is obtained at step SP114, then the control section 112 returns the processing to step SP110, at which it sets a number obtained by displacing the formerly obtained channel number CN after the changeover by +1 or −1 as a channel number CN after the changeover.

On the other hand, if an affirmative result is obtained at step SP114, then the control section 112 advances the processing to step SP115. At step SP115, the control section 112 designates one music data Ad (for example, music data Ad whose reproduction order number is 1) from within the designated list PL and reads out the designated music data Ad from the content storage section 115. Thereafter, the processing advances to step SP116.

At step SP116, the control section 112 decides whether or not the designated music data Ad has been read out correctly. If a negative result is obtained at step SP116, then the control section 112 ends the channel changeover processing procedure RT11 as an error end. On the other hand, if an affirmative result is obtained at step SP116, then the control section 112 advances the processing to step SP117.

At step SP117, the control section 112 stops the reproduction of the currently reproduced music data Ad. Then at step SP118, the control section 112 controls the display section 113 to display the selection screen 120 which displays the channel number CN after the changeover obtained at step SP110 described hereinabove as the channel number CNs of the currently selected channel. The selection screen 120 further displays the list information Li (list name Lt and list explanation Lde) of the designated list PL read out at step SP111 described hereinabove and the attribute information Ti (jacket image, tune name and artist name) of the designated music data Ad read out at step SP115 described hereinabove. Then, the control section 112 starts reproduction of the music data Ad from a characteristic position (for example, a position indicated by one of the three positions of the characteristic position information Ct1 to Ct3) and then ends the channel changeover processing procedure RT11.

The music reproduction apparatus 110 changes over the channel in response to an operation of the remote controller RM1 by such a channel changeover processing procedure RT11 as described above.

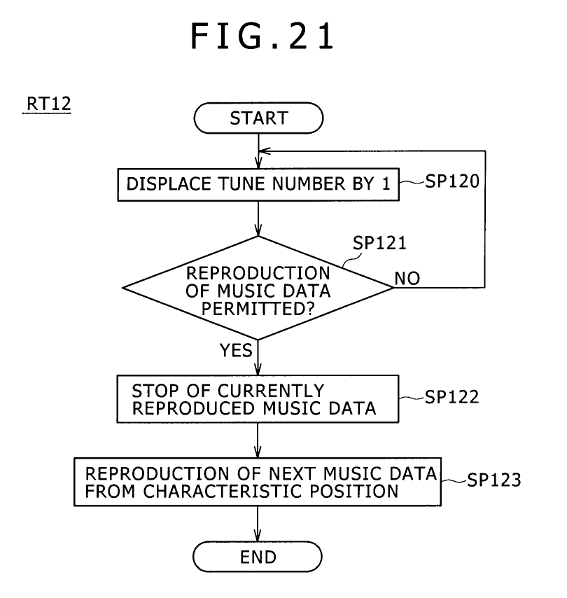

Now, a procedure of the tune changeover process by the Music Station function is described. Referring to FIG. 21, if the control section 112 of the music reproduction apparatus 110 starts the Music Station function and then recognizes, while music data Ad is reproduced, that a tune changeover operation is performed through the leftward button B15 or the rightward button B16 of the remote controller RM1, then it starts a tune changeover processing procedure RT12 and advances the processing to step SP120.

At step SP120, the control section 112 displaces, if the leftward button B15 of the remote controller RM1 is depressed, the tune number of the music data information Ai corresponding to the tune, which was selected immediately before the tune changeover operation, by −1 and sets the thus displaced tune number as the tune number after the changeover within the channel playlist PL allocated to the currently selected channel. However, if the rightward button B16 is depressed, then the control section 112 displaces the tune number of the music data information Ai by +1 and sets the thus displaced tune number as the tune number after the changeover within the channel playlist PL allocated to the currently selected channel. Thereafter, the processing advances to step SP121.

Incidentally, the control section 112 controls the changeover of the tune number annularly such that the top one and the tail one of the tune numbers are connected to each other.

At step S121, the control section 112 decides based on the music data reproduction setting Adi of the music data information Ai corresponding to the tune number after the changeover whether or not reproduction of the music data Ad (designated music data) designated by the music data information Ai is permitted. If a negative result is obtained at step SP121, then the control section 112 returns the processing to step SP120, at which it sets a number displaced by +1 or −1 from the tune number after the changeover acquired formerly as a new tune number after the changeover.

On the other hand, if an affirmative result is obtained at step SP121, then the control section 112 advances the processing to step SP122. At step SP122, the control section 112 stops the reproduction of the currently reproduced music data Ad and advances the processing to step SP123. At step SP123, the control section 112 controls the display section 113 to display the selection screen 120 which displays the attribute information Ti (jacket image, tune name and artist name) of the designated music data Ad. Further, the control section 112 starts reproduction of the designated music data Ad from a characteristic position (for example, a position indicated by one of the three positions of the characteristic position information Ct1 to Ct3) and then ends the tune changeover processing procedure RT12.

The music reproduction apparatus 110 changes over the tune in response to an operation of the remote controller RM1 by such a tune changeover processing procedure RT12 as described above.

Now, the tune display setting method is described. While also the tune display setting method is similar to that of the basic configuration described hereinabove, it is different in that it corresponds to operations of the remote controller RM1. Thus, the following description is given principally of such differences.

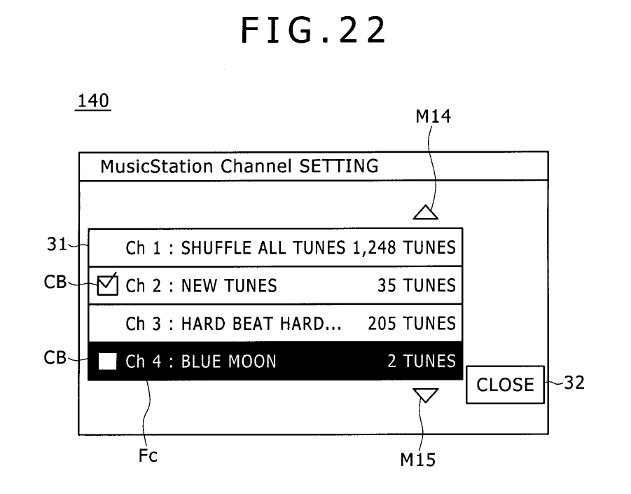

In particular, if the control section 112 of the music reproduction apparatus 110 recognizes that the setting button B12 provided on the remote controller RM1 is depressed during execution of the Music Station function, then it controls the display section 113 to display such a channel display setting screen 140 as shown in FIG. 22.

On the channel display setting screen 140, a channel information list 31 in which channel information of those channels which can be utilized by the Music Station function is arranged in order of the channel list CL is disposed at a central portion. Further, a close button 32 for ending the setting to close the channel display setting screen 140 is displayed at a right lower corner portion of the channel display setting screen 140.

Further, in the channel information list 31, a focus Fc is displayed for the selected channel information.

Further, a fifth mark M14 of a triangular shape with a vertex thereof directed upwardly is displayed on the upper side and in the proximity of the channel information list 31. Meanwhile, a sixth mark M16 of a triangular shape with a vertex thereof directed downwardly is displayed on the lower side and in the proximity of the channel information list 31. Each of the fifth mark M14 and the sixth mark M16 has a shape corresponding to that of the upward button B13 and the downward button B14 provided on the remote controller RM1 and indicates that the focus Fc displayed in the channel information list 31 can be displaced upwardly by one stage to different channel information if the upward button B13 is depressed, but can be displaced downwardly by one stage to different channel information if the downward button B14 is depressed.

Then, the control section 112 of the music reproduction apparatus 110 moves, in response to a focus moving operation through the upward button B13 or the downward button B14 of the remote controller RM1, the focus Fc within the channel information list 31 to select one piece of the channel information.

Incidentally, although only channel information for four channels is displayed at a time on the channel information list 31, for example, if the upward button B13 of the remote controller RM1 is depressed while the focus Fc is displayed at the channel information at the uppermost stage or if the downward button B14 of the remote controller RM1 is depressed while the focus Fc is displayed at the channel information at the lowermost stage, then the channel information displayed in the channel information list 31 is scrolled by one stage in the upward direction or the downward direction. Consequently, the user can confirm the channel information of all channels.

At this time, the control section 112 of the music reproduction apparatus 110 allows the user to tentatively listen to the tunes which are enjoyable in the channel corresponding to the channel information selected by the focus Fc by successively reproducing the music data Ad registered in the channel playlist PL of the channel, for example, for several seconds for each music data Ad from a characteristic position.

Then, if the determination button B17 of the remote controller RM1 is depressed while some channel information is selected, then the control section 112 of the music reproduction apparatus 110 removes, if a check mark is applied to the check box CB of the selected channel information, the check mark thereby to change the channel display setting from “display” to “no display”. However, if no check mark is applied, then the control section 112 newly applies a check mark thereby to change the channel display setting from “no display” to “display”.

Thereafter, if the close button 32 of the channel display setting screen 140 is depressed by a user operation for the remote controller RM1, then the control section 112 of the music reproduction apparatus 110 reflects the channel display setting (that is, presence or absence of a check mark in the check box CB) on the channel display setting screen 140 on the list reproduction setting Ldi of the channel playlist PL allocated to each channel. Then, the control section 112 closes the channel display setting screen 140.

In this manner, the channel display setting can be changed for each channel on the channel display setting screen 140 in response to an operation of the remote controller RM1. Then, with regard to any channel whose channel display setting is changed to “no display”, no GUI screen (that is, none of the selection screen 120 and the reproduction screen 130) is displayed any more, and therefore, no selection is permitted naturally.

Consequently, since the music reproduction apparatus 110 allows the user to set which channel should be displayed on the selection screen 120 and the reproduction screen 130 so as to be selected, for example, the channel configuration to be displayed on the selection screen 120 and the reproduction screen 130 can be set so as to conform with the liking of the user.

Now, a procedure of the channel display setting process is described. If the control section 112 of the music reproduction apparatus 110 recognizes that the setting button B12 of the remote controller RM1 is depressed during execution of the Music Station function, then it changes over the GUI screen of the Music Station function to the channel display setting screen 140. Then, the control section 112 starts such a channel display setting processing procedure RT13 as illustrated in FIG. 23 and advances the processing to step SP130.

At step SP130, the control section 112 decides whether or not the determination button B17 of the remote controller RM1 is depressed while channel information is selected through the focus Fc, that is, whether or not a display setting changing operation is accepted. If an affirmative result is obtained at step SP130, then the control section 112 advances the processing to step SP131.

At step SP131, the control section 112 decides whether or not the display setting at present of the currently selected channel information is “display”. If an affirmative result is obtained at step SP131, then the control section 112 advances the processing to step SP132.

At step SP132, the control section 112 removes the check mark applied to the check box CB of the currently selected channel information to change the display setting from “display” to “no display”, and then advances the processing to step SP134.

On the other hand, if a negative result is obtained at step SP131, then the control section 112 advances the processing to step SP133. At step SP133, the control section 112 applies a check mark to the check box CB of the currently selected channel information to change the display setting from “no display” to “display”, and then advances the processing to step SP134.

On the other hand, if a negative result is obtained at step SP130, then the control section 112 advances the processing directly to step SP134 while omitting the processes at steps SP131 to SP133.

At step SP134, the control section 112 decides whether or not the close button 32 of the channel display setting screen 140 is depressed through the remote controller RM1. If a negative result is obtained at step SP134, then the control section 112 returns the processing to step SP130, at which it performs an acceptance decision of a display setting changing operation.

On the other hand, if an affirmative result is obtained at step SP134, then the control section 112 advances the processing to step SP135. At step SP135, the control section 112 reflects the channel display setting performed on the channel display setting screen 140 on the list reproduction setting Ldi of the channel playlist PL allocated to each channel. Then, the control section 112 closes the channel display setting screen 140 and ends the channel display setting processing procedure RT13.

The music reproduction apparatus 110 changes the channel display setting in response to an operation of the remote controller RM1 in accordance with such a channel display setting processing procedure RT13 as described above.

As described above, the music reproduction apparatus 110 according to the first embodiment of the present invention has the Music Station function corresponding to operations of the remote controller RM1 and can readily perform starting of the Music Station function, channel changeover, tune changeover, channel display setting and so forth by operations of the remote controller RM1.

Incidentally, the music reproduction apparatus 110 according to the first embodiment prepares a special channel hereinafter referred to also as entrust channel as one of channels to be handled by the Music Station function. In the entrust channel, a channel playlist PL to be applied is automatically changed over in response to a time zone such as morning, daytime, evening, night or midnight.

Further, various channel playlists PL corresponding to different time zones are prepared as channel playlists PL to be applied as the entrust channel in the music reproduction apparatus 110. The channel playlists PL include a channel playlist PL (hereinafter referred to also as morning list) composed of music data Ad corresponding to tunes suitable for the morning and another channel playlist PL (hereinafter referred to also as daytime list) composed of music data Ad corresponding to tunes suitable for the daytime. The channel playlists PL further include a further channel playlist PL (hereinafter referred to also as evening list) composed of music data Ad corresponding to tunes suitable for the evening and a still further channel playlist PL (hereinafter referred to also as night list) composed of music data Ad corresponding to tunes suitable for the night. The channel playlists PL further include a channel playlist PL (hereinafter referred to also as midnight list) composed of music data Ad corresponding to tunes suitable for the midnight.

Here, the channel playlists PL corresponding to the time zones are automatically updated when music data Ad is stored into the content storage section 115.

In particular, for example, it is assumed that the night list PL has “quiet” described as a keyword therein. In this instance, after the control section 112 of the music reproduction apparatus 110 newly stores music data Ad into the content storage section 115, it selects, based on the keyword “quiet”, those music data Ad whose value indicative of the quietness of an impression value of the tune is higher than a predetermined value from among the music data Ad stored in the content storage section 115. Then, the control section 112 updates the configuration of the night list PL so as to be composed of the thus selected music data Ad.

Then, if the control section 112 of the music reproduction apparatus 110 selects the entrust channel in accordance with a channel changeover operation through the upward button B13 or the downward button B14 of the remote controller RM1 during execution of the Music Station function, then it specifies the present time zone based on time obtained from a time counting section 118. Then, the control section 112 designates one of the morning list PL, daytime list, PL evening list PL, night list PL and midnight list PL allocated to the entrust channel in response to the specified time zone and reproduces music data Ad in accordance with the designated list.

In this manner, when the entrust channel is selected, the music reproduction apparatus 110 can allow the user to enjoy a tune suitable for the present time zone by selecting a channel playlist PL in response to the present time zone and reproducing music data Ad in accordance with the selected channel playlist PL.

Further, when the entrust button B18 provided on the remote controller RM1 is depressed, the control section 112 of the music reproduction apparatus 110 can change over the currently selected channel immediately to the entrust channel irrespective of the order of the channel number CN of the channel list CL. Where the music reproduction apparatus 110 immediately changes over to the entrust channel in this manner if the entrust button B18 of the remote controller RM1 is depressed, channel changeover operations through the upward button B13 and the downward button B14 of the remote controller RM1 can be omitted, and consequently, the music reproduction apparatus 110 allows the user to enjoy a tune suitable for the present time zone by simpler operations.

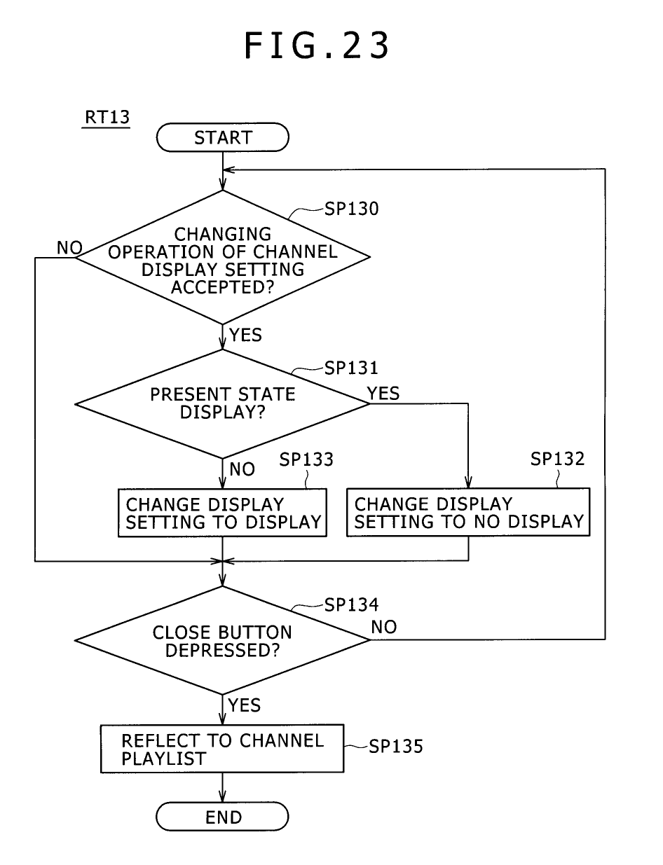

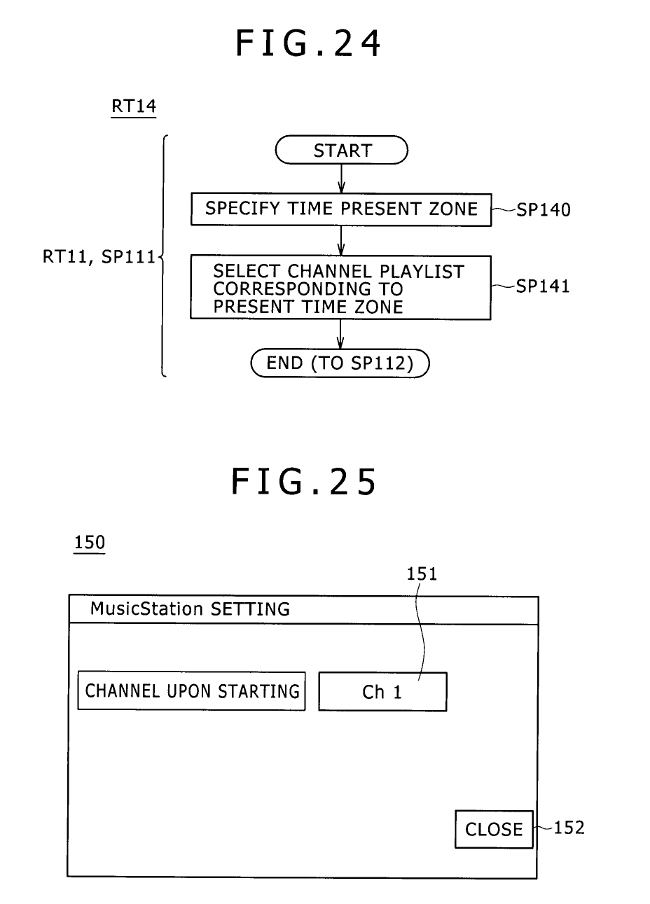

Here, a designation process of a channel playlist PL (the process is hereinafter referred to also as list designation process) upon changeover to the entrust channel is described with reference to FIG. 24. The list designation process is executed at step SP111 of the channel changeover processing procedure RT11 described hereinabove with reference to FIG. 20 when the channel number CN after the changeover at step SP110 is the channel number CN of the entrust channel.

In particular, if the channel number CN after the changeover is the channel number CN of the entrust channel, then the control section 112 of the music reproduction apparatus 110 starts a list designation processing procedure RT14 illustrated in FIG. 24 as the process at step SP111 and advances the processing to step SP140.

At step SP140, the control section 112 specifies a present time zone based on time obtained from the time counting section 118 and the advances the processing to step SP141. At step SP141, the control section 112 designates one of the morning list PL, daytime list PL, evening list PL, night list PL and midnight list PL allocated to the entrust channel and reads out the designated list PL from the list storage section 117. Thereafter, the control section 112 ends the list designation processing procedure RT14 and advances the processing to step SP112 of the channel changeover processing procedure RT11.

According to the list designation processing procedure RT14, the music reproduction apparatus 110 designates one of the morning list PL, daytime list PL, evening list PL, night list PL and midnight list PL allocated to the entrust channel.

Incidentally, when the entrust button B18 is depresses, since the channel number CN after the changeover is the channel number CN of the entrust channel, the list designation processing procedure RT14 may be started immediately while the step SP110 of the channel changeover processing procedure RT11 described hereinabove is omitted.

### 2-3. Operation and Effects of the First Embodiment

In the music reproduction apparatus 110 having the configuration described above, a plurality of music data Ad stored in the content storage section 115 are managed using a plurality of channel playlists PL stored in the list storage section 117 and each including a list of music data information Ai which is content identification information of the music data Ad.

The control section 112 of the music reproduction apparatus 110 selects one of the channel playlists PL through selection of a channel in response to an operation of the upward button B13 or the downward button B14 of the remote controller RM1. Further, the control section 112 arbitrarily selects and reproduces one of the music data Ad registered in the selected channel playlist PL. Furthermore, the control section 112 selects and reproduces one of the music data Ad registered in the currently selected channel playlist PL in response to an operation of the leftward button B15 or the rightward button B16 of the remote controller RM1.

As a result, in order for the user to reproduce desired music data Ad on the music reproduction apparatus 110, it is necessary for the user to perform only two selection operations in the maximum including selection of a channel playlist PL by means of the upward button B13 or the downward button B14 of the remote controller RM1 and selection of music data Ad by means of the leftward button B15 or the rightward button B16. Further, since the upward button B13 and the downward button B14 corresponding to the selection of a channel playlist PL and the leftward button B15 and the rightward button B16 corresponding to the selection of music data Ad are formed as separate buttons, the selection of a channel playlist PL by the upward button B13 or the downward button B14 and the selection of music data Ad by the leftward button B15 or the rightward button B16 can be performed concurrently.

Further, the control section 112 of the music reproduction apparatus 110 controls so that information (allocated channel number, list name and list explanation) of the currently selected channel playlist PL and information (jacket image, tune name and artist name) of currently selected music data Ad are displayed on the same screen. Consequently, the music reproduction apparatus 110 allows the user to confirm the substance of the channel playlist PL and the substance of the music data Ad on the same screen while allowing the user to perform a selection operation of the channel playlist PL and the music data Ad.

Further, the control section 112 of the music reproduction apparatus 110 allows the user to select a tune suitable for a time zone at present by storing channel playlists PL suitable for different times zones such as the morning list PL, daytime list PL, evening list PL, night list PL and midnight list PL in the list storage section 117, selecting one of the channel playlists PL in response to the time zone at present and reproducing music data Ad in accordance with the selected channel playlist PL.

With the music reproduction apparatus 110 according to the first embodiment having the configuration described above, in order for the user to reproduce desired music data Ad, it is necessary for the user to perform only two selection operations in the maximum including selection of a channel playlist PL by means of the upward button B13 or the downward button B14 of the remote controller RM1 and selection of music data Ad by means of the leftward button B15 or the rightward button B16. Further, since the upward button B13 and the downward button B14 corresponding to the selection of a channel playlist PL and the leftward button B15 and the rightward button B16 corresponding to the selection of music data Ad are formed as separate buttons, the selection of a channel playlist PL by the upward button B13 or the downward button B14 and the selection of music data Ad by the leftward button B15 or the rightward button B16 can be performed concurrently. Therefore, reproduction of a desired content can be performed further readily when compared with that by the ones in the past.

### 2-4. Modifications to the First Embodiment

While, in the first embodiment described above, the Music Station function is started in a state wherein a channel selected last during last operation thereof is selected similarly as in the basic configuration described hereinabove, according to the present invention, the setting of the channel to be selected upon starting of the Music Station function is not limited to this, but may otherwise be fixed to an arbitrary channel.

In this instance, the setting of the channel to be selected upon starting is performed, for example, using such a starting channel setting screen 150 as shown in FIG. 25. In particular, when the control section 112 of the music reproduction apparatus 110 recognizes that the setting button B12 of the remote controller RM1 is depressed during execution of the Music Station function, then it controls the display section 113 to display the starting channel setting screen 150.

Since also the calling instruction of the channel display setting screen 140 described hereinabove is allocated to the setting button B12, for example, every time the setting button B12 is depressed, the channel display setting screen 140 and the starting channel setting screen 150 may be displayed alternately. Alternatively, two setting buttons including a setting button for the calling instruction of the channel display setting screen 140 and a setting button for the starting channel setting screen 150 may be provided on the remote controller RM1.

Referring to FIG. 25, the starting channel setting screen 150 includes a starting channel display box 151 in which the channel number (for example, “Ch1”) of a channel which is selected upon starting and a close button 152 for ending the setting to close the starting channel setting screen 150.

Then, the control section 112 of the music reproduction apparatus 110 changes over the channel number to be displayed in the starting channel display box 151 in accordance with an operation of the upward button B13 or the downward button B14 of the remote controller RM1. Then, if the close button 152 is depressed by an operation of the remote controller RM1, then the control section 112 stores the channel number displayed in the starting channel display box 151 at this time as information (hereinafter referred to also as starting channel information) representative of the channel number of the channel to be selected upon starting into the content storage section 115 or the list storage section 117.

In this manner, the control section 112 of the music reproduction apparatus 110 allows the user to set a channel to be selected upon starting. In this instance, the process at step SP100 of the Music Station function starting processing procedure RT10 described hereinabove should be changed so as to acquire not the channel number of the channel selected last during last operation but the channel number indicated by the starting channel information.

Or otherwise, the music reproduction apparatus 110 may be configured so as to allow the user to select the channel to be selected upon starting of the Music Station function between the channel selected last during last operation and the channel set as the channel to be used upon starting. In this instance, for example, one of the channels selected last during last operation and the channel set as the channel to be used upon starting may be described in the starting channel information.

While the starting channel information is used here as the information indicative of the channel number of the channel to be selected upon starting, that is, as the list selection information indicative of the channel playlist PL to be selected first, any other information may be used instead only if it indicates a channel playlist PL to be selected first.

Further, in the first embodiment described above, where the tune order setting Ls of a channel playlist PL indicates shuffle reproduction, the reproduction tune order indicated in the channel playlist PL is re-arranged at random in the channel initialization process (at step SP103 of the Music Station function starting processing procedure RT10) to implement random reproduction within the channel playlist PL similarly as in the basic configuration described hereinabove. However, according to the embodiment of the present invention, the implementation of random reproduction is not limited to this, but the reproduction tune order indicated in the channel playlist PL may otherwise be re-arranged at random in the channel changing process (at step SP113 of the channel changeover processing procedure RT11).

Or otherwise, for example, every time tune changeover is performed, one of music data Ad registered in the channel playlist PL may be selected at random to implement random reproduction in the channel playlist PL. More particularly, the process at step SP120 of the tune changeover processing procedure RT12 may additionally include a process of selecting, where the tune order setting Ls of the channel playlist PL allocated to the currently selected channel describes shuffle reproduction, a tune number at random within the channel playlist PL and setting the selected tune number as a tune number after the changeover.

Further, while, in the first embodiment described above, the remote controller RM1 is used as the operation section, according to the embodiment of the present invention, the operation section is not limited to this, but, for example, various buttons having functions similar to those of the buttons provided on the remote controller RM1 may be provided as the operation section on the housing of the music reproduction apparatus 110.

Further, in the first embodiment described above, the upward button B13 and the downward button B14 of the remote controller RM1 are used as the first inputting section 101, and the leftward button B15 and the rightward button B16 of the remote controller RM1 are used as the second inputting section 102. However, according to the embodiment of the present invention, the first inputting section 101 and the second inputting section 102 are not limited to those, but a jog dial which can be turned in upward and downward directions may be used as the first inputting section 101 while another jog dial which can be turned in the leftward and rightward directions is used as the second inputting section 102. Or else, different inputting devices may be used for the first inputting section 101 and the second inputting section 102.

Further, in the first embodiment described above, reproduction of selected music data Ad is started from a characteristic position (a catchy position, a position at which the melody changes or the like) in response to a channel changeover operation or a tune changeover operation through the remote controller RM1. However, according to the embodiment of the present invention, the starting position of reproduction is not limited to this, but reproduction may otherwise be started from the top of selected music data Ad.

Further, in the first embodiment described above, when the entrust channel as a specific list which collectively includes the morning list PL, daytime list PL, evening list PL, night list PL and midnight list PL is selected, the control section 112 of the music reproduction apparatus 110 selects one of the morning list PL, daytime list PL, evening list PL, night list PL and midnight list PL in response to the time zone at the time and then reproduces music data Ad in accordance with the selected channel playlist PL. However, according to the embodiment of the present invention, what is changed in response to the time zone is not limited to this, but the sound volume or the sound quality upon reproduction of music data Ad may be changed in response to the time zone.

In this instance, for example, morning sound volume setting, daytime sound volume setting, evening sound volume setting, night sound volume setting and midnight sound volume setting are prepared as the sound volume setting upon reproduction of music data Ad. More particularly, the sound volume is set such that, for example, it is greatest with the morning sound volume setting and decreases in order of the daytime sound volume setting, evening sound volume setting, night sound volume setting and midnight sound volume setting.

Then, upon reproduction of music data Ad, the control section 112 of the music reproduction apparatus 110 selects one of the morning sound volume setting, daytime sound volume setting, evening sound volume setting, night sound volume setting and midnight sound volume setting in response to the time zone at the time and controls the amplification by the reproduction section 116 so that the music data Ad may be reproduced with a sound volume based on the selected sound volume setting. Consequently, the music reproduction apparatus 110 allows the user to listen to music with a sound volume suitable for the time zone at present.

On the other hand, as the sound quality setting upon reproduction of music data Ad, for example, morning sound quality setting, daytime sound quality setting, evening sound quality setting, night sound quality setting and midnight sound quality setting are prepared in the music reproduction apparatus 110. More particularly, the low sound modulation degree is set such that, for example, it is highest with the morning sound quality setting and decreases in order of the morning sound quality setting, daytime sound quality setting, evening sound quality setting, night sound quality setting and midnight sound quality setting.

Then, upon reproduction of music data Ad, the control section 112 of the music reproduction apparatus 110 selects one of the morning sound quality setting, daytime sound quality setting, evening sound quality setting, night sound quality setting and midnight sound quality setting in response to the time zone at the time and controls the equalization by the reproduction section 116 so that the music data Ad may be reproduced with a sound volume based on the selected sound quality setting. Consequently, the music reproduction apparatus 110 allows the user to listen to music with sound quality suitable for the time zone at present.

Further, not only the sound volume or the sound quality but also the brightness or the coloring of the display section 113 may be changed. In this instance, for example, morning brightness setting, daytime brightness setting, evening brightness setting, night brightness setting and midnight brightness setting are prepared as the brightness setting for the display section 113. More particularly, the brightness is set such that, for example, it is highest with the morning brightness setting and decreases in order of the daytime brightness setting, evening brightness setting, night brightness setting and midnight brightness setting.

Then, upon starting of the apparatus, the control section 112 of the music reproduction apparatus 110 selects one of the morning brightness setting, daytime brightness setting, evening brightness setting, night brightness setting and midnight brightness setting in response to the time zone at the time and controls the display section 113 to display a GUI screen with a brightness based on the selected brightness setting. Consequently, the music reproduction apparatus 110 allows the user to observe the GUI screen with a brightness suitable for the time zone at present.

On the other hand, as the coloring setting for the display section 113, for example, morning coloring setting, daytime coloring setting, evening coloring setting, night coloring setting and midnight coloring setting are prepared in the music reproduction apparatus 110. More particularly, the coloring for the display section 113 is set such that, for example, the brightness thereof is highest with the morning coloring setting and decreases in order of the morning coloring setting, daytime coloring setting, evening coloring setting, night coloring setting and midnight coloring setting.

Then, upon starting of the apparatus, the control section 112 of the music reproduction apparatus 110 selects one of the morning coloring setting, daytime coloring setting, evening coloring setting, night coloring setting and midnight coloring setting in response to the time zone at the time and controls the display section 113 to display a GUI screen with coloring based on the selected coloring setting. Consequently, the music reproduction apparatus 110 allows the user to observe the GUI screen with coloring suitable for the time zone at present.

Further, in the first embodiment described above, list reproduction setting Ldi included in list information Li is used as list selection permission/inhibition information indicative of whether selection of a channel playlist PL is permitted or inhibited, that is, whether or not a channel playlist PL is to be displayed. However, according to the embodiment of the present invention, the information to be used as the list selection permission/inhibition information is not limited to this, but any other information may be used only if it indicates whether selection of a channel playlist PL is permitted or inhibited, that is, whether or not a channel playlist PL is to be displayed.

Further, in the first embodiment described above, tune order setting Ls is used as list reproduction order information which defines a reproduction order in a channel playlist PL. However, according to the embodiment of the present invention, the information which defines such a reproduction order is not limited to this, but any other information may be used only if it defines a reproduction order in a channel playlist PL.

Further, in the first embodiment described above, the reproduction screen 130 as first display and the selection screen 120 as second display are switchably displayed. However, according to the embodiment of the present invention, the first and second screens to be switchably displayed are not limited to them, but screens different from the selection screen 120 and the reproduction screen 130 may be switchably displayed as the first and second screens.

Further, in the first embodiment described above, a keyword representing a characteristic of a channel playlist PL is described as character information (for example, “bright”) in list explanation Lde of list information Li. However, according to the embodiment of the present invention, the keyword is not limited to this, but it may be described as information other than character information. For example, the keyword may be represented as identification information for identifying the keyword like, for example, “KW01”. In this instance, the control section 112 of the music reproduction apparatus 110 recognizes the keyword “bright” based on the identification information “KW01”, for example, described in the list explanation Lde.

Further, in the first embodiment described above, if a channel changeover operation or a tune changeover operation is performed in a state wherein the reproduction screen 130 is displayed, then the GUI screen is changed over from the reproduction screen 130 to the selection screen 120. However, according to the embodiment of the present invention, the changeover between the selection screen 120 and the reproduction screen 130 is not limited to this, but where a tune changing operation is performed such that the GUI screen is changed over from the reproduction screen 130 to the selection screen 120 only when a channel changing operation is performed in a state wherein the reproduction screen 130 is displayed, while the reproduction screen 130 is maintained, the tune name, artist name and jacket image Jp to be displayed on the reproduction screen 130 may be changed over.

### 3. Second Embodiment

### 3-1. Outline of the Second Embodiment

Now, an outline of a second embodiment of the present invention is described. After the outline is described, detailed description of the second embodiment is given herein.

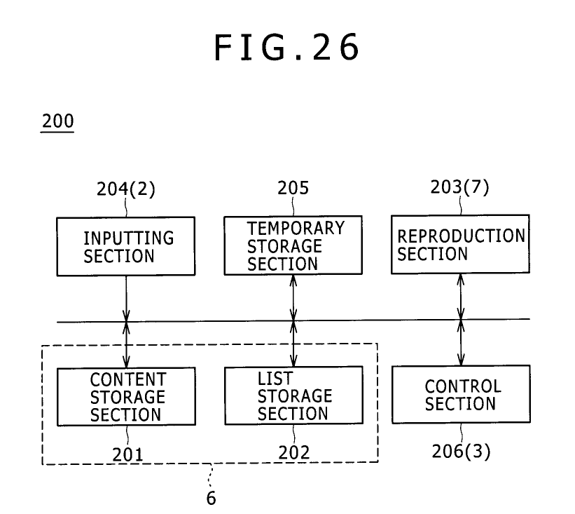

Referring to FIG. 26, there is shown a content reproduction apparatus 200 according to the second embodiment of the present invention. The content reproduction apparatus 200 includes a content storage section 201 for storing one or more contents, a list storage section 202 for storing a plurality of lists having content identification information for identifying contents, a reproduction section 203 for reproducing a content stored in the content storage section 201 based on a list stored in the list storage section 202. The content reproduction apparatus 200 further includes an inputting section 204 for accepting an operation input, a temporary storage section 205, and a control section 206. The control section 206 selects one of the lists stored in the list storage section 202, and stores, if it detects a predetermined operation input from the inputting section 204 while the reproduction section 203 reproduces a content based on the selected list, content identification information of the content being reproduced and list identification information of the selected list to the temporary storage section 205. Further, if the control section 206 detects a predetermined operation input from the inputting section 204 again, then it decides whether or not the list identification information of the currently selected list and the list identification information stored in the temporary storage section 205 coincide with each other. Then, if coincidence of the list identification information is not detected, then the control section 206 adds the content identification information stored in the temporary storage section 205 to the currently selected list.

It is to be noted that the content storage section 201 and the list storage section 202 correspond to the storage section 6 of the content reproduction apparatus 1 which has the basic configuration described hereinabove with reference to FIG. 1, and the inputting section 204 corresponds to the operation section 2 of the content reproduction apparatus 1. Further, the reproduction section 203 and the control section 206 correspond to the reproduction section 7 and the control section 3 of the content reproduction apparatus 1, respectively.

The content reproduction apparatus 200 according to the second embodiment having such a configuration as described above allows the user to recognize the substance of a content and perform simple operation of repeating a predetermined operation twice to add a desired content to another list. Therefore, a content can be edited more readily in accordance with an intention of the user than ever.

### 3-2. Particular Configuration of the Second Embodiment

Now, a particular configuration of the second embodiment is described. Referring to FIG. 27, a music reproduction apparatus 210 shown is a particular example of the content reproduction apparatus 200 described hereinabove. The music reproduction apparatus 210 is similar in configuration to but different from the music reproduction apparatus 110 of the first embodiment described hereinabove in that it does not include the time counting section 118 but includes a temporary storage section 211 instead.

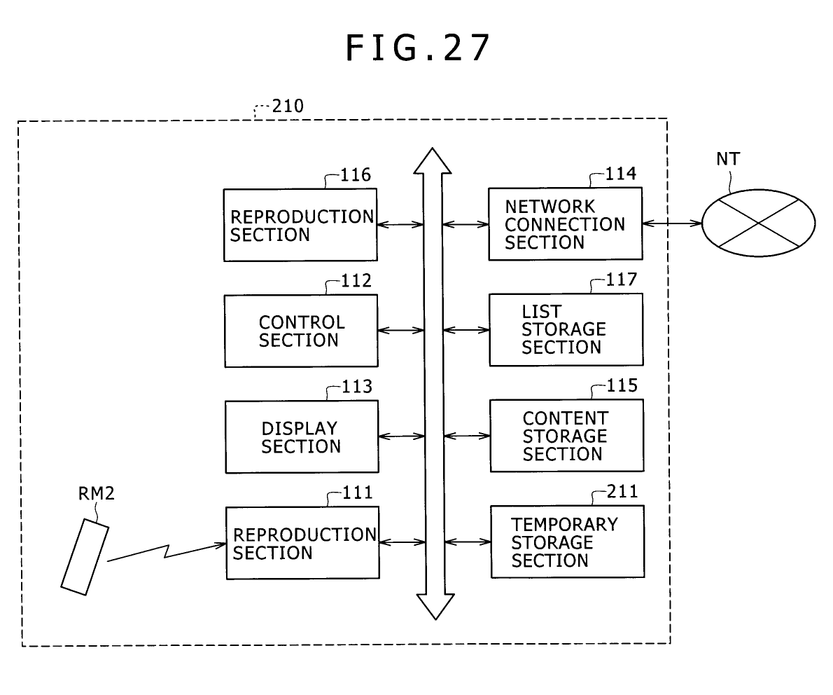

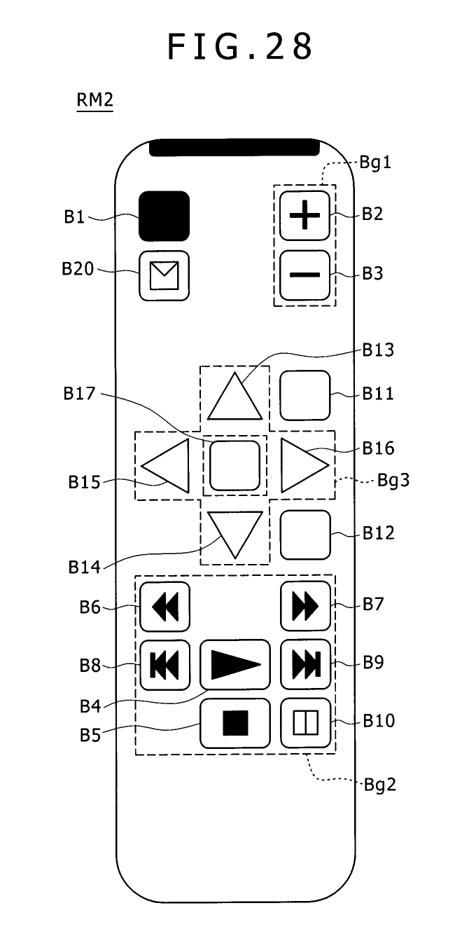

Meanwhile, FIG. 28 shows a remote controller RM2 for use with the music reproduction apparatus 210. The remote controller RM2 is similar in configuration to but different from the remote controller RM1 for the music reproduction apparatus 110 of the first embodiment in that it includes a request button B20 in place of the entrust button B18.

It is to be noted that the request button B20 provided on the remote controller RM2 corresponds to the inputting section 204 of the content reproduction apparatus 200 described hereinabove with reference to FIG. 26, and the control section 112, content storage section 115, reproduction section 116, list storage section 117 and temporary storage section 211 of the music reproduction apparatus 210 correspond to the control section 206, content storage section 201, reproduction section 203, list storage section 202 and temporary storage section 205 of the content reproduction apparatus 200 described hereinabove, respectively.

The music reproduction apparatus 210 has a download function, a CD recording function, a normal reproduction function, a CD reproduction function and a Music Station function similarly to the music reproduction apparatus 110 of the first embodiment described hereinabove. The control section 112 executes processes according to the functions in response to operations for the remote controller RM2.

Here, the Music Station function of the music reproduction apparatus 210 is described. First, a management method of music data Ad by the Music Station function of the music reproduction apparatus 210 is described. The management method is similar to the management method by the music reproduction apparatus 110 of the first embodiment described hereinabove, and for details thereof, the description of the first embodiment given hereinabove should be referred to.

In particular, the music reproduction apparatus 210 according to the present second embodiment uses the channel list CL to manage a plurality of channel playlists PL and manages the reproduction tune order of the music data Ad in accordance with each of the channel playlists PL.

Further, similarly as in the first embodiment described hereinabove, the Music Station function prepares a channel playlist PL for each of classes which are considered to be requested by users such as a newly added tune, a tune whose reproduction time number is small, a catchy tune, a bright tune, a classical tune, or a heavy metal tune. Thus, the control section 112 of the music reproduction apparatus 210 automatically updates the channel playlists PL in response to storage or reproduction of music data Ad such that the music data Ad stored in the content storage section 115 is registered into a pertaining one of the prepared channel playlists PL based on the reproduction time number, an impression value of the tune, the genre and so forth of the music data Ad.

Then, the music reproduction apparatus 210 selects one of the channel playlists PL classified in a newly added tune, a tune whose reproduction time number is small, catchy music, bright music, classical music, heavy metal music and so forth as a channel in response to a user operation for the remote controller RM2 on a GUI screen. Consequently, the user can find out a desired tune readily in such a feeling of changing over of the channel of a radio broadcast.

Also the GUI screens used by the Music Station function are similar in screen configuration to those of the music reproduction apparatus 110 of the first embodiment described hereinabove. Thus, for details of the GUI screens, the description of the first embodiment given hereinabove should be referred to.

In particular, the music reproduction apparatus 210 according to the present second embodiment allows the user to visually observe the substance of a channel and the substance of a tune through the selection screen 120 described hereinabove with reference to FIG. 15. Further, the music reproduction apparatus 210 switchably selects a channel in accordance with a user operation for the upward button B13 or the downward button B14 of the remote controller RM2 and switchably selects a tune in accordance with a user operation for the leftward button B15 or the rightward button B16 of the remote controller RM2.

Further, the music reproduction apparatus 210 can change over the selection screen 120 to the reproduction screen 130 in accordance with a predetermined condition (that is, lapse of a predetermined interval of time without depression or operation of the determination button B17) such that the user can visually recognize the substance of the selected channel and tune through the reproduction screen 130.

Also the reproduction control of music data Ad upon such changeover of the GUI screen is similar to that by the music reproduction apparatus 110 of the first embodiment, and for details thereof, the description of the first embodiment given hereinabove should be referred to.

In particular, the music reproduction apparatus 210 according to the present second embodiment enters, when the selection screen 120 is displayed, the partial reproduction mode in which currently selected music data Ad is reproduced from a characteristic position, but enters, when the reproduction screen 130 is displayed, the normal reproduction mode in which currently selected music data Ad is reproduced normally. Whichever mode is entered, music data Ad is normally reproduced without being interrupted during execution of the Music Station function.

In particular, when the Music Station function is executed, the music reproduction apparatus 210 according to the present second embodiment allows the user to change over the channel playlist PL in a unit of a channel in accordance with an operation of the upward button B13 or the downward button B14 of the remote controller RM2 in such a sense that the preset radio broadcasting station is changed over similarly as in the case of the music reproduction apparatus 110 of the first embodiment described hereinabove. Further, the music reproduction apparatus 210 can change over the tune to be reproduced in the channel in accordance with an operation of the leftward button B15 or the rightward button B16. Consequently, the music reproduction apparatus 210 allows the user to enjoy a desired tune further readily in such a sense that it enjoys music broadcast from a radio broadcasting station.

Also the procedure of the Music Station function starting process, channel changeover process and tune changeover process is similar to the procedure of the processes executed by the music reproduction apparatus 110 of the first embodiment. Thus, for details of the procedure, the description of the first embodiment given hereinabove should be referred to.

Also the channel display setting process by the Music Station function is similar to the process executed by the music reproduction apparatus 110 of the first embodiment described hereinabove, and for details thereof, the description of the first embodiment given hereinabove should be referred to.

In particular, the music reproduction apparatus 210 according to the second embodiment is configured such that the channel display setting can be changed over between “display” and “no display” for each channel through the channel display setting screen 140 described hereinabove with reference to FIG. 22.

As described above, the music reproduction apparatus 210 of the second embodiment has the Music Station function corresponding to operations of the remote controller RM2 similarly as in the first embodiment described hereinabove. Thus, the music reproduction apparatus 210 can readily perform starting of the Music Station function, channel changeover, tune changeover, channel display setting and so forth by operations of the remote controller RM2.

Incidentally, the Music Station function of the music reproduction apparatus 210 of the second embodiment prepares a channel playlist PL for each of classes which are estimated to be requested by users. Then, the control section 112 of the music reproduction apparatus 210 automatically registers any of music data Ad stored in the content storage section 115 into a pertaining one of the prepared channel playlists PL based on the reproduction time number, impression values of the tune, genre and so forth of the music data Ad.

Where the music reproduction apparatus 210 automatically registers music data Ad into a channel playlist PL corresponding to the class of the music data Ad in this manner, the burden on the user can be reduced. On the other hand, when registration of music data Ad into a channel playlist PL is performed automatically in this manner, the registration of music data Ad into a channel playlist PL may not necessarily be performed as indented by the user.

Therefore, the music reproduction apparatus 210 of the second embodiment is configured such that, after registration of music data Ad into a channel playlist PL is performed automatically, music data Ad which is currently reproduced can be deleted from the channel playlist PL in which the music data Ad is registered at present or can be registered additionally into another channel playlist PL in accordance with a request from the user.

Here, a method (hereinafter referred to as list editing method) of deleting currently reproduced music data Ad from a channel playlist PL in which the music data Ad is registered at present or additionally registering currently reproduced music data Ad into another channel playlist PL is described.

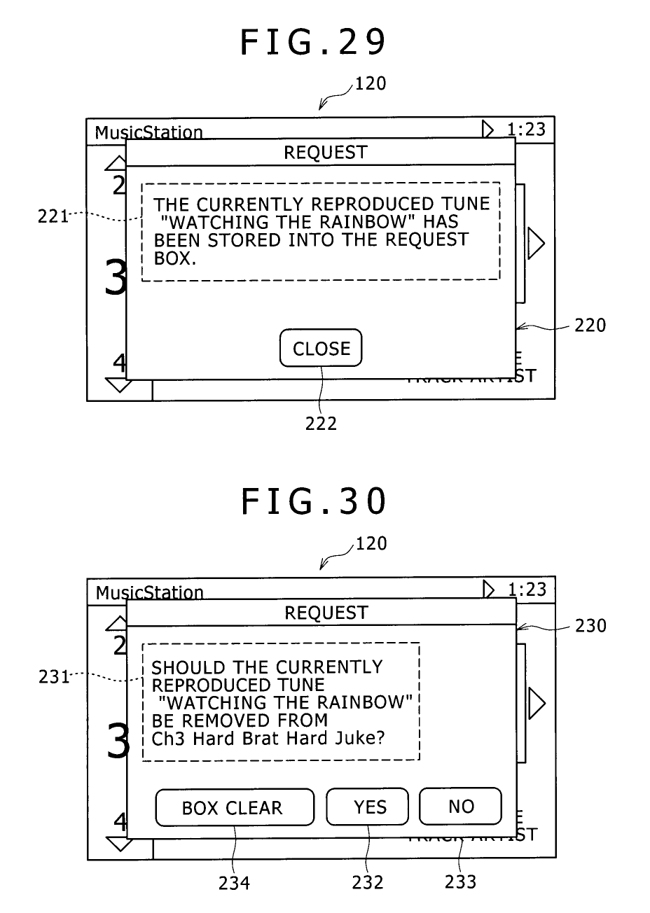

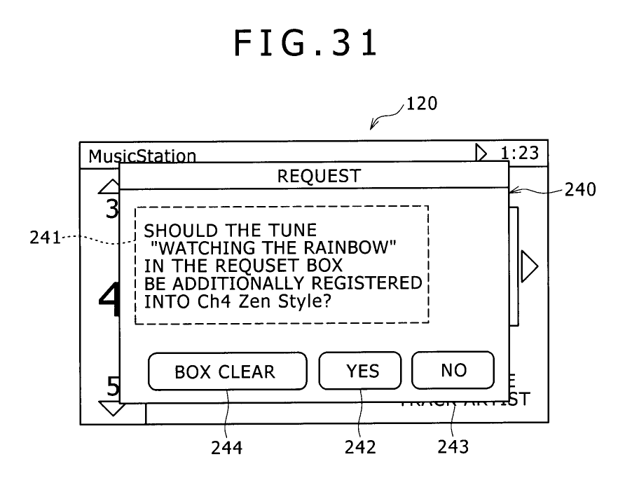

If the request button B20 provided on the remote controller RM2 is depressed during execution of the Music Station function, then the control section 112 of the music reproduction apparatus 210 recognizes that an instruction to designate music data Ad reproduced currently as an object of the request (deletion from the channel playlist PL in which the music data Ad is currently registered or additional registration into another channel playlist PL) is issued by the user. Then, the control section 112 stores music information data Ai of the currently reproduced music data Ad and list information Li of the channel playlist PL allocated to the currently selected channel (that is, the channel playlist PL in which the currently music data Ad is registered at present) into the temporary storage section 211 to designate the currently reproduced music data Ad as a request object. Further, the control section 112 controls a request acceptance dialog 220 for notifying the user that the currently reproduced music data Ad is designated as a request object to be displayed in an overlapping relationship with a currently displayed one of the selection screen 120 or the reproduction screen 130 as seen in FIG. 29.

The request acceptance dialog 220 describes character information 221 representing that the currently reproduced music data Ad is designated as a request object (for example, “The currently reproduced tune “watching the rainbow” has been stored into the request box.”) and includes a close button 222 disposed thereon for closing the request acceptance dialog 220.

Then, if the close button 222 is depressed by a user operation for the remote controller RM2, then the control section 112 of the music reproduction apparatus 210 closes the request acceptance dialog 220.

If the request button B20 is thereafter depressed again, then the control section 112 of the music reproduction apparatus 210 decides from the list information Li stored in the temporary storage section 211 whether or not the channel playlist PL of the currently selected channel is same as the channel playlist PL of the channel which was selected when the request button B20 was depressed last.

Then, if the control section 112 of the music reproduction apparatus 210 decides that the two channel playlists PL are same, then since the request button B20 is depressed again in a state wherein the channel same as that when the request button B20 was depressed last is selected, the control section 112 recognizes that it is requested by the user to delete the music data Ad designated as the request object upon last depression of the request button B20 from the channel playlist PL of the currently selected channel (that is, the channel playlist PL in which the music data Ad of the request object is currently registered). Then, the control section 112 causes a deletion confirmation dialog 230 for the confirmation of whether or not the music data Ad of the request object may be deleted from the channel playlist PL of the currently selected channel to be displayed in an overlapping relationship with the currently displayed selection screen 120 or reproduction screen 130 as seen in FIG. 30.

The deletion confirmation dialog 230 describes character information 231 for the confirmation of whether or not the music data Ad of the request object may be deleted from the channel playlist PL of the currently selected channel (such as, for example, “Should the currently reproduced tune “watching the rainbow” be removed from Ch3 Hard Beat Hard Juke?”). The deletion confirmation dialog 230 further includes display of a deletion execution button 232 for executing a deletion process, a deletion interruption button 233 for interrupting a deletion process, and a request cancellation button 234 for removing the music data Ad of the request object from the request object thereby to cancel the request.

Then, if the deletion execution button 232 is depressed by a user operation for the remote controller RM2, then the control section 112 of the music reproduction apparatus 210 executes a deletion process.

In particular, the control section 112 of the music reproduction apparatus 210 changes the music data reproduction setting Adi of the music data information Ai in the currently selected channel playlist PL which coincides with the music data information Ai stored in the temporary storage section 211 from “reproduction permitted” to “reproduction inhibited”. Here, the Music Station function operates such that, if the music data reproduction setting Adi is “reproduction permitted”, then the control section 112 permits display of attribute information Ti (jacket information, tune name and artist name) of music data information Ai corresponding to the music data reproduction setting Adi on a GUI screen. However, if the music data reproduction setting Adi is “reproduction inhibited”, then the control section 112 inhibits display of the attribute information Ti of the corresponding music data Ad on the GUI screen.

In particular, to set the music data reproduction setting Adi of the music data Ad of the request object to “reproduction inhibited” signifies that the music data Ad is not reproduced any more from the channel playlist PL in which the music data Ad is registered and the attribute information Ti is not displayed any more on the GUI screen. This is synonymous with deletion of the music data Ad of the request object from the currently registered channel playlist PL.

Therefore, if the deletion execution button 232 is depressed, then the control section 112 of the music reproduction apparatus 210 changes the music data reproduction setting Adi of the music data Ad of the request object to “reproduction inhibited” thereby to place the music data Ad into a state wherein it is substantially deleted from the currently selected channel playlist PL and close the deletion confirmation dialog 230. After the deletion process is executed in this manner, the control section 112 of the music reproduction apparatus 210 erases the music data information Ai and the list information Li from the temporary storage section 211 to cancel the designation of the request object.

On the other hand, if the deletion interruption button 233 is depressed, then the control section 112 of the music reproduction apparatus 210 closes the deletion confirmation dialog 230 without executing the deletion process. In this instance, since the control section 112 of the music reproduction apparatus 210 does not execute the process according to the request, the music data information Ai and the list information Li stored in the temporary storage section 211 remain stored as they are.

Further, if the request cancellation button 234 is depressed, then the control section 112 of the music reproduction apparatus 210 deletes the music data information Ai and the list information Li from the temporary storage section 211 to cancel the designation of the request object and close the deletion confirmation dialog 230.

In this manner, where a request to delete music data Ad of a request object from a channel playlist PL in which music data Ad is currently registered is received, then the control section 112 of the music reproduction apparatus 210 urges the user to confirm whether or not the music data Ad should be deleted through the deletion confirmation dialog 230 and then performs execution or interruption of the deletion process or cancellation of the request in accordance with an instruction of the user.

On the other hand, if the channel playlist PL of the channel currently selected when the request button B20 is depressed again is different from the channel playlist PL of the channel selected when the request button B20 was depressed last, then since the request button B20 is depressed again in a state wherein the channel different from that when the request button B20 was depressed last, the control section 112 of the music reproduction apparatus 210 recognizes that it is requested by the user to additionally register the music data Ad designated as the request object when the request button B20 was depressed last into the channel playlist PL of the currently selected channel. Further, the control section 112 causes an addition confirmation dialog 240 for the confirmation of whether or not the music data Ad of the request object should be additionally registered into the channel playlist PL of the currently selected channel to be displayed in an overlapping relationship with a currently displayed one of the selection screen 120 and the reproduction screen 130.

The addition confirmation dialog 240 describes character information 241 of the substance for the confirmation of whether or not the music data Ad of the request object may be additionally registered into the currently selected channel (such as, for example, “Should the tune “watching the rainbow” in the request box be additionally registered into Ch4 Zen Style?”). The addition confirmation dialog 240 further includes an additional registration execution button 242 for executing an additional registration process, an additional registration interruption button 243 for interrupting the additional registration process, and a request deletion button 244 for removing music data Ad of the request object from the request object to cancel the request.

If the additional registration execution button 242 is depressed by a user operation for the remote controller RM2, then the control section 112 of the music reproduction apparatus 210 additionally registers music data information Ai stored in the temporary storage section 211 to the tail end of the currently selected channel playlist PL thereby to additionally register the music data Ad of the request object into the currently selected channel playlist PL. Thereafter, the control section 112 closes the addition confirmation dialog 240. Further, after the additional registration process is executed in this manner, the control section 112 of the music reproduction apparatus 210 erases the music data information Ai and the list information Li from the temporary storage section 211 to cancel the designation of the request object.

On the other hand, if the additional registration interruption button 243 is depressed, then the control section 112 of the music reproduction apparatus 210 closes the addition confirmation dialog 240 without performing the additional registration process. In this instance, since the control section 112 of the music reproduction apparatus 210 does not execute a process in accordance with the request, the music data information Ai and the list information Li stored in the temporary storage section 211 remain stored as they are.

Further, if the request deletion button 244 is depressed, then the control section 112 of the music reproduction apparatus 210 erases the music data information Ai and the list information Li from the temporary storage section 211 to cancel the designation of the request object and then closes the addition confirmation dialog 240.

In this manner, if a request to additionally register music data Ad of a request object into another channel playlist PL, then the control section 112 of the music reproduction apparatus 210 urges the user to confirm whether or not the additional registration should be performed through the addition confirmation dialog 240 and then performs execution or interruption of the additional registration process or cancellation of the request.

As described above, if the channel currently selected when the request button B20 is depressed again designating music data Ad which is currently reproduced when the request button B20 is depressed as a request object is same as the channel which was currently selected when the request button B20 was depressed last, then the music reproduction apparatus 210 deletes the music data Ad of the request object from the channel playlist PL of the currently selected channel. However, if the channels are not same as each other, then the music reproduction apparatus 210 additionally registers the music data Ad of the request object into the channel playlist PL of the currently selected channel.

Consequently, the music reproduction apparatus 210 can delete music data Ad from a channel playlist PL in which the music data Ad is currently registered or additionally register the music data Ad into another channel playlist PL, that is, can perform editing of the channel playlist PL, by simple operation of repeating depression of the request button B20 twice after it allows the user to listen to a tune based on the music data Ad so as to confirm the substance of the tune.

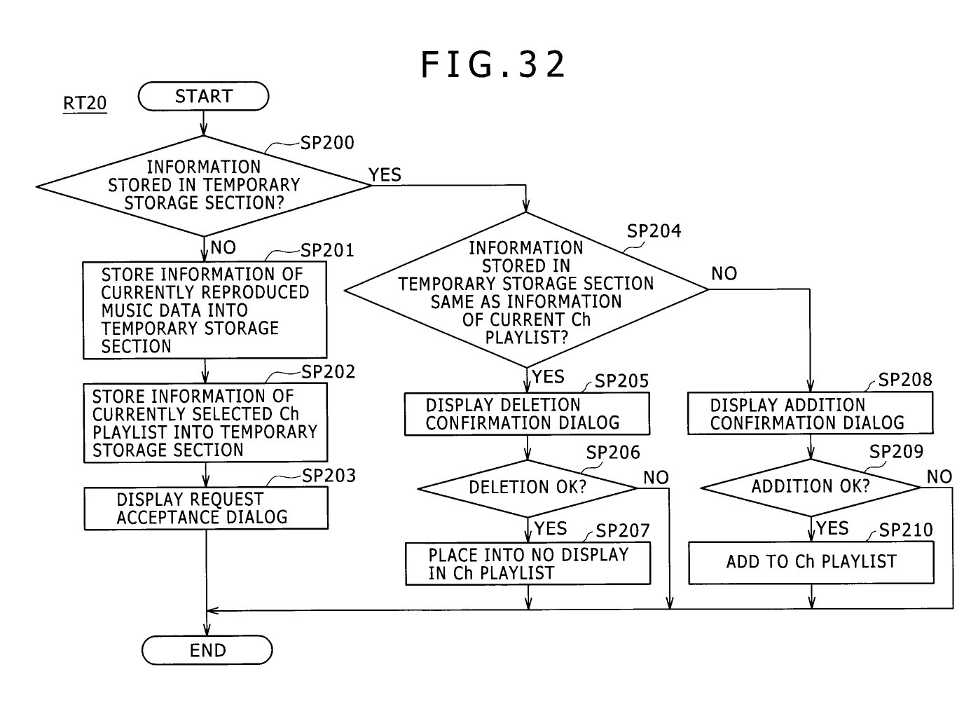

Now, a procedure of such a process of list editing (hereinafter referred to as list editing process) is described. If the control section 112 of the music reproduction apparatus 210 recognizes during execution of the Music Station function that the request button B20 of the remote controller RM2 is depressed, then it starts a list editing processing procedure RT20 illustrated in FIG. 32 and advances the processing to step SP200.

Referring to FIG. 32, first at step SP200, the control section 112 decides whether or not music data information Ai and list information Li are stored already in the temporary storage section 211. If a negative result is obtained at step SP200, then this signifies that music data Ad which is a request object is not designated as yet, and the control section 112 advances the processing to step SP201.

At step SP201, the control section 112 stores music data information Ai of the currently reproduced music data Ad into the temporary storage section 211, and then advances the processing to step SP202. At step SP202, the control section 112 stores the list information Li of the channel playlist PL allocated to the currently selected channel into the temporary storage section 211, and then advances the processing to step SP203. At step SP203, the control section 112 displays the request acceptance dialog 220 and then ends the list editing processing procedure RT20.

On the other hand, if an affirmative result is obtained at step SP200, then this signifies that music data Ad which is a request object is designated already. In this instance, the control section 112 advances the processing to step SP204.

At step SP204, the control section 112 decides whether or not the channel playlist PL identified from the list information Li stored in the temporary storage section 211 is same as the channel playlist PL of the currently selected channel. If an affirmative result is obtained at step SP204, then this signifies that the request button B20 is depressed again in a channel same as that when the request button B20 was depressed last, that is, it is requested to delete the music data of the request object from the channel playlist PL of the currently selected channel. In this instance, the control section 112 advances the processing to step SP205.

At step SP205, the control section 112 causes the deletion confirmation dialog 230 to be displayed, and then advances the processing to step SP206. At step SP206, the control section 112 decides whether or not the deletion execution button 232 of the deletion confirmation dialog 230 is depressed. If an affirmative result is obtained at step SP206, then the control section 112 advances the processing to step SP207. At step SP207, the control section 112 changes the music data reproduction setting Adi of the music data Ad of the request object to “reproduction inhibited” (that is, changes the display setting of the attribute information Ti to “no display”) to place the music data Ad into a state in which the music data Ad is substantially deleted from the currently selected channel playlist PL. Further, the control section 112 closes the deletion confirmation dialog 230 and deletes the music data information Ai and the list information Li from the temporary storage section 211 thereby to cancel the designation of the request object. Thereafter, the control section 112 ends the list editing processing procedure RT20.

On the other hand, if a negative result is obtained at step SP206, then the control section 112 closes the deletion confirmation dialog 230 without executing the deletion process and then ends the list editing processing procedure RT20.

Further, if a negative result is obtained at step SP204, then this signifies that the request button B20 is depressed again in a channel different from that when the request button B20 was depressed last, that is, it is requested to additionally register the music data of the request object into the channel playlist PL of the currently selected channel. In this instance, the control section 112 advances the processing to step SP208.

At step SP208, the control section 112 displays the addition confirmation dialog 240, and then advances the processing to step SP209. At step SP209, the control section 112 decides whether or not the additional registration execution button 242 of the addition confirmation dialog 240 is depressed. If an affirmative result is obtained at step SP209, then the control section 112 advances the processing to step SP210. At step SP210, the control section 112 additionally registers the music data information Ai of the music data Ad of the request object into the currently selected channel playlist PL and then closes the addition confirmation dialog 240. Further, the control section 112 erases the music data information Ai and the list information Li from the temporary storage section 211 to cancel the designation of the request object and then ends the list editing processing procedure RT20.

On the other hand, if a negative result is obtained at step SP209, then the control section 112 closes the addition confirmation dialog 240 without executing the additional registration process and then ends the list editing processing procedure RT20.

The music reproduction apparatus 210 performs list editing in accordance with such a list editing processing procedure RT20 as described above.

Incidentally, as described hereinabove, the Music Station function is for providing a tune based on music data Ad stored in the content storage section 115 to the user in such a manner as to provide the user with a sense in which the user listens to a radio broadcast. Therefore, naturally the Music Station function cannot provide a tune to the user unless at least one music data Ad is stored in the content storage section 115. In other words, the Music Station function can provide a variety of channels which increase as the number of music data Ad stored in the content storage section 115 increases.

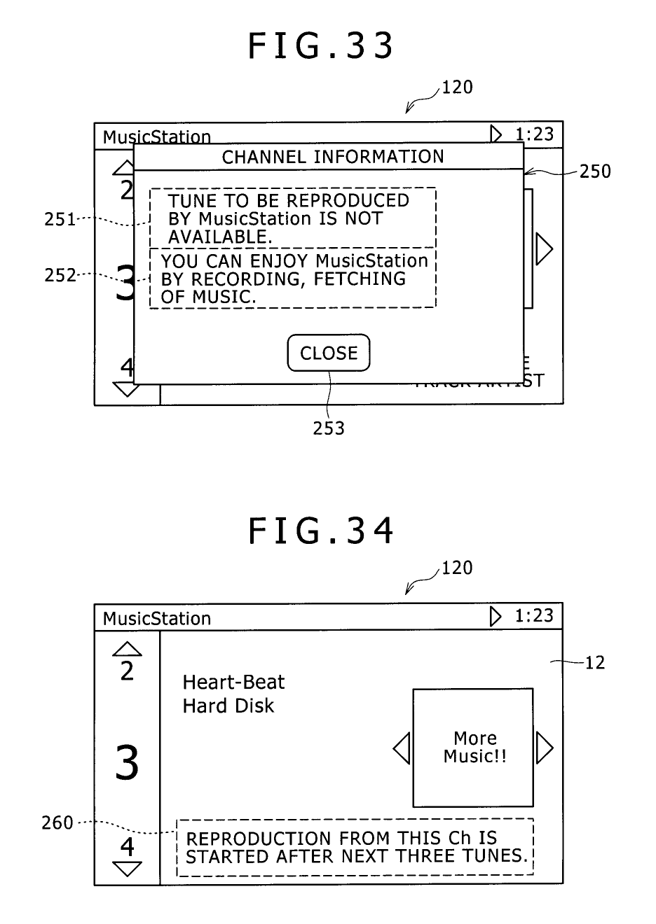

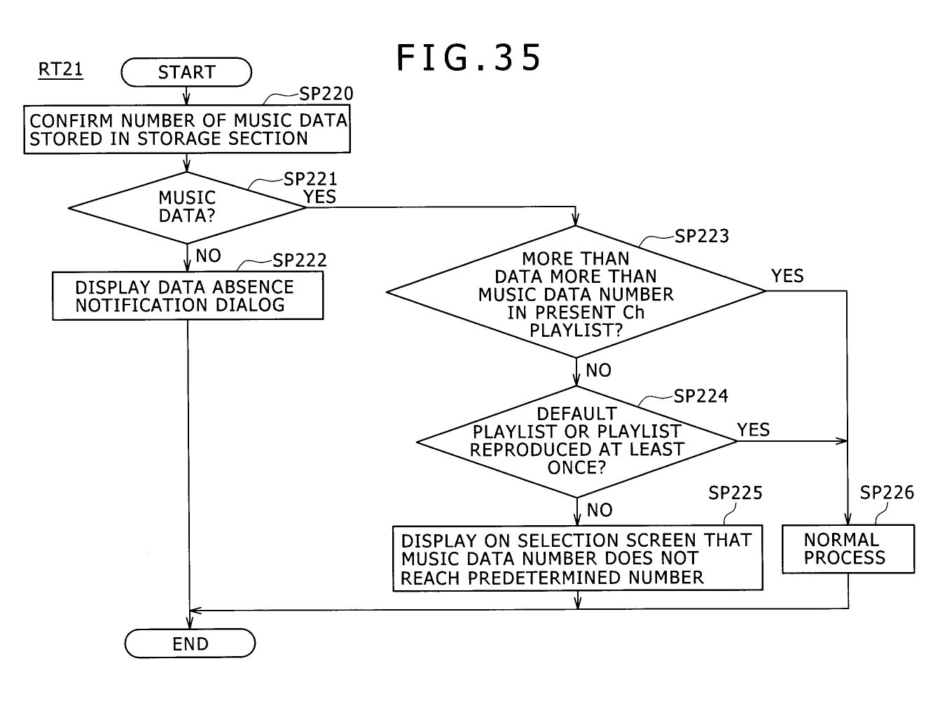

Therefore, for example, if no music data Ad is stored in the content storage section 115, then upon starting of the Music Station function, the control section 112 of the music reproduction apparatus 210 controls the display section 113 to display such a no-data notification dialog 250 for notifying the user that no music data Ad is stored in the content storage section 115 as seen in FIG. 33.

The no-data notification dialog 250 describes character information 251 representing that no music data Ad is stored in the content storage section 115 (for example, “Tune to be reproduced by Music Station is not available.”) and character information 252 of the substance for urging the user to add (record, download or the like) music data Ad (for example, “You can enjoy Music Station by recording, fetching of music.”). Further, the no-data notification dialog 250 has a close button 253 for closing the no-data notification dialog 250 provided thereon.

Then, if the close button 253 is depressed by a user operation for the remote controller RM2, then the control section 112 of the music reproduction apparatus 210 closes the no-data notification dialog 250 and ends the Music Station function.

Thus, when no music data Ad is stored in the content storage section 115, the control section 112 of the music reproduction apparatus 210 can notify the user of this fact through the no-data notification dialog 250. Further, the control section 112 can let the user recognize that the user can enjoy the Music Station function by adding music data Ad. As a result, it is possible to urge the user to add music data Ad.

In addition, the Music Station function can prevent reproduction of music data Ad registered in a channel playlist PL if the number of music data Ad registered in the channel playlist PL is smaller than a predetermined number (for example, smaller than 3) even if the list reproduction setting Ldi of the channel playlist PL is “reproduction permitted” (that is, a channel playlist PL displayed as a channel on the GUI screen).

Actually, if a channel to which a channel playlist PL in which no music data Ad is registered is allocated while the list reproduction setting Ldi is “reproduction permitted” is selected in response to a channel changeover operation during execution of the Music Station function, then the control section 112 of the music reproduction apparatus 210 stops reproduction of currently reproduced music data Ad. Further, the control section 112 controls the display section 113 to display, in the tune selection region 12 of the selection screen 120, character information 260 representing that, if the number of music data Ad registered in the channel playlist PL of the currently selected channel reaches a predetermined number, then reproduction of music data Ad in the channel is started (for example, “Reproduction from this Ch is started after next three tunes.”) as seen in FIG. 34.

In this manner, the music reproduction apparatus 210 can let the user recognize that the user can enjoy a new channel if music data Ad is added and can further urge the user to add music data Ad.

Thus, the music reproduction apparatus 210 can notify the user that, as the number of music data Ad stored in the content storage section 115 increases, the user can enjoy the Music Station function still more thereby to further urge the user to add music data Ad.

Incidentally, as an exceptional case, the control section 112 of the music reproduction apparatus 210 causes music data Ad to be reproduced without displaying the character information 260 only if, when the default channel or a channel including music data Ad which has been reproduced at least once in the past is selected, at lease one music data Ad is registered in a channel playlist PL to which the channel is allocated even if the number of music data Ad registered in the channel playlist PL is smaller than the predetermined number.

According to the configuration just described, such a situation that, although music data Ad is stored in the content storage section 115, no reproducible channel playlist PL is available can be prevented.

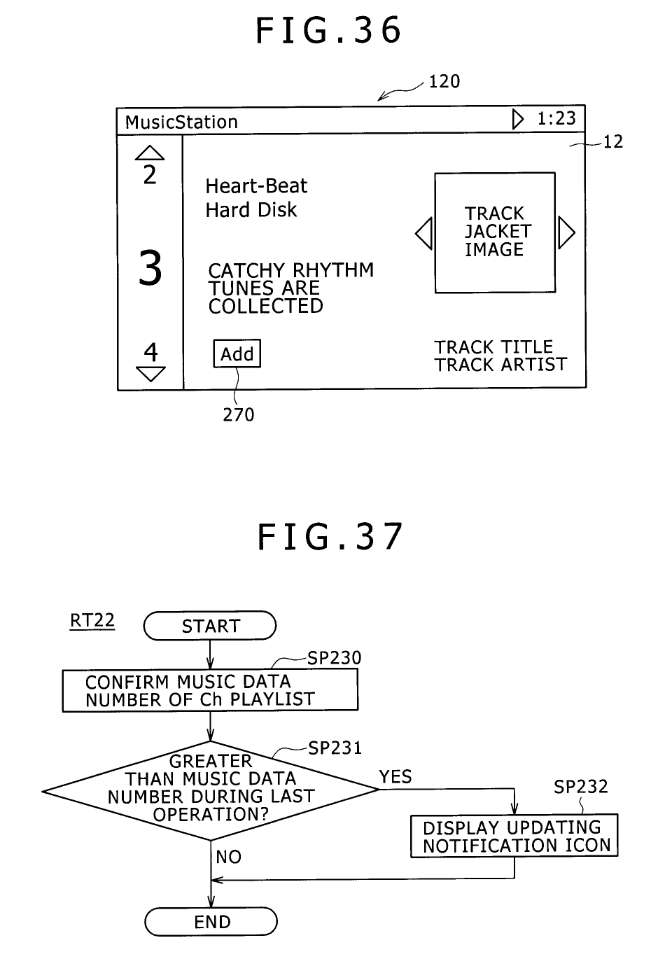

Now, a procedure of such a process of urging a user to add music data Ad (the process is hereinafter referred to also as addition urging process) is described. After the Music Station function is started, the control section 112 of the music reproduction apparatus 210 starts such an addition urging processing procedure RT21 as illustrated in FIG. 36 and advances the processing to step SP220.

At step SP220, the control section 112 confirms the number of music data Ad stored in the content storage section 115, and then advances the processing to step SP221. At step S221, the control section 112 decides based on a result of the confirmation at step SP220 whether or not the content storage section 115 includes music data Ad.

If a negative result is obtained at step SP221, then this signifies that no music data Ad is stored in the content storage section 115. In this instance, the control section 112 advances the processing to step SP222. At step SP222, the control section 112 displays the no-data notification dialog 250, and then ends the addition urging processing procedure RT21.

On the other hand, if an affirmative result is obtained at step SP221, then this signifies that at least one music data Ad is stored in the content storage section 115. In this instance, the control section 112 advances the processing to step SP223. At step SP223, the control section 112 decides whether or not more than a predetermined number of music data Ad are registered in the channel playlist PL of the currently selected channel.

If a negative result is obtained at step SP223, then this signifies that the number of music data Ad registered in the channel playlist PL of the currently selected channel does not reach the predetermined number. In this instance, the control section 112 advances the processing to step SP224.

At step SP224, the control section 112 decides whether not the currently selected channel playlist PL is the default playlist DPL or a channel playlist PL which includes music data Ad which has been reproduced at least once in the past. Incidentally, the information representing whether or not any music data Ad in the channel playlist PL has been reproduced at least once is stored in the content storage section 115 or the list storage section 117 and updated when music data Ad is reproduced for the first time in accordance with the channel playlist PL.

If a negative result is obtained at step SP224, then this signifies that the currently selected channel playlist PL is not the default playlist DPL but a channel playlist PL which includes music data Ad which have not been reproduced at all. In this instance, the control section 112 advances the processing to step SP225.

At step S225, the control section 112 stops reproduction of the currently reproduced music data Ad and controls the display section 113 to display, in the tune selection region 12 of the selection screen 120, the character information 260 representing that, if the number of music data Ad registered in the channel playlist PL of the currently selected channel reaches the predetermined number, then reproduction of music data Ad in the channel is started. Then, the control section 112 ends the addition urging processing procedure RT21.

On the other hand, if an affirmative result is obtained at step SP223, then this signifies that the number of music data Ad registered in the channel playlist PL of the currently selected channel is equal to or greater than the predetermined number. In this instance, the control section 112 advances the processing to step SP226. Also when an affirmative result is obtained at step SP224, the control section 112 advances the processing to step SP226.

At step SP226, the control section 112 executes a normal process for channel selection (that is, the processes at steps SP106 to SP108 of the Music Station function starting processing procedure RT10 illustrated in FIG. 19 or the processes at steps SP115 to SP118 of the channel changeover processing procedure RT11 illustrated in FIG. 20. Thereafter, the control section 112 ends the addition urging processing procedure RT21.

The music reproduction apparatus 210 urges the user to add music data Ad in response to the number of music data Ad stored in the content storage section 115 in accordance with such an addition urging processing procedure RT21 as described above.

It is to be noted here that, while the addition urging processing procedure RT21 is described separately from the Music Station function starting processing procedure RT10 (FIG. 19) and the channel changeover processing procedure RT11 (FIG. 20) for the convenience of description, actually it is executed in the Music Station function starting processing procedure RT10 and the channel changeover processing procedure RT11.

For example, the processes at steps SP220 and SP221 of the addition urging processing procedure RT21 are executed at preceding stage of the process at step SP100 of the Music Station function starting processing procedure RT10, and the process at step SP222 of the addition urging processing procedure RT21 is executed in place of the processes at steps SP100 to SP108 of the Music Station function starting processing procedure RT10. Further, the processes at steps SP223 and SP224 of the addition urging processing procedure RT21 are executed at the preceding stage of the process at step SP106 of the Music Station function starting processing procedure RT10 and at the preceding stage of the process at step SP115 of the channel changeover processing procedure RT11. Further, the process at step SP225 of the addition urging processing procedure RT21 is executed in place of the processes executed at steps SP106 to S108 of the Music Station function starting processing procedure RT10 and at steps SP115 to SP118 of the channel changeover processing procedure RT11. Further, the process at step SP226 of the addition urging processing procedure RT21 corresponds to the processes at steps SP106 to SP108 of the Music Station function starting processing procedure RT10 and at steps SP115 to SP118 of the channel changeover processing procedure RT11.

Further, while the music reproduction apparatus 210 urges the user to add music data Ad in this manner, if music data Ad is added (that is, if music data Ad is newly stored into the content storage section 115), then the music reproduction apparatus 210 notifies the user that the channel playlist PL is updated in response to the addition.

Actually, if music data Ad is newly stored into the content storage section 115, the control section 112 of the music reproduction apparatus 210 additionally registers the music data Ad into the pertaining channel playlist PL based on the impression value, genre and so forth of the tune thereby to update the channel playlist PL.

Then, if the channel to which the updated channel playlist PL is allocated in response to a channel changeover operation or the like during execution of the Music Station function, then the control section 112 of the music reproduction apparatus 210 controls the display section 113 to display an updating notification icon 270 for notifying the user that the channel playlist PL of the channel is updated in the tune selection region 12 of the selection screen 120 as seen in FIG. 36. Though not shown, the updating notification icon 270 is displayed also in the selected tune display region 22 of the reproduction screen 130.

In this manner, the music reproduction apparatus 210 can let the user recognize that the channel playlist PL of the currently selected channel is updated.

Now, a procedure of a process (hereinafter referred to also as updating notification process) of notifying the user that a channel playlist PL is updated in this manner is described. When the control section 112 of the music reproduction apparatus 210 selects a channel playlist PL in response to a channel changeover operation or the like during execution of the Music Station function, it starts an updating notification procedure RT22 illustrated in FIG. 37 and advances the processing to step SP230.

At step SP230, the control section 112 confirms the number of music data Ad currently registered in the currently selected channel playlist PL, and then advances the processing to step SP231. Here, the control section 112 confirms the number of music data information Ai in the channel playlist PL to recognize the number of currently registered music data Ad.

At step SP231, the control section 112 decides whether or not the number of the currently stored music data Ad is greater than the number of music data Ad registered in the channel playlist PL during last operation of the Music Station function. Here, the control section 112 confirms the registered data number Tn of the channel playlist PL updated upon ending of the Music Station function to recognize the number of the music data Ad registered in the channel playlist PL during last operation of the Music Station function.

If a negative result is obtained at step SP231, then this signifies that the number of music data Ad currently registered in the currently selected channel playlist PL is smaller than the number of music data Ad registered in the last operation of the Music Station function, that is, the channel playlist PL has not been updated till now after the last operation of the Music Station function ended. In this instance, the control section 112 ends the updating notification procedure RT22.

On the other hand, if an affirmative result is obtained at step SP231, then this signifies that the number of music data Ad currently registered in the currently selected channel playlist PL is equal to or greater than the number of music data Ad registered in the last operation of the Music Station function, that is, the channel playlist PL has been updated till now after the last operation of the Music Station function ended. In this instance, the control section 112 advances the processing to step SP232.

At step SP232, the control section 112 controls the display section 113 to display the updating notification icon 270 for notifying the user that the channel playlist PL is updated in the tune selection region 12 of the selection screen 120 and ends the updating notification procedure RT22.

The music reproduction apparatus 210 notifies the user that the channel playlist PL is updated in accordance with such an updating notification procedure RT22 as described above.

It is to be noted here that, while the updating notification procedure RT22 is described separately from the Music Station function starting processing procedure RT10 and the channel changeover processing procedure RT11 for the convenience of description, actually it is executed in the Music Station function starting processing procedure RT10 and the channel changeover processing procedure RT11. In particular, the updating notification procedure RT22 is executed, for example, at step SP108 of the Music Station function starting processing procedure RT10 and at step SP118 of the channel changeover processing procedure RT11.

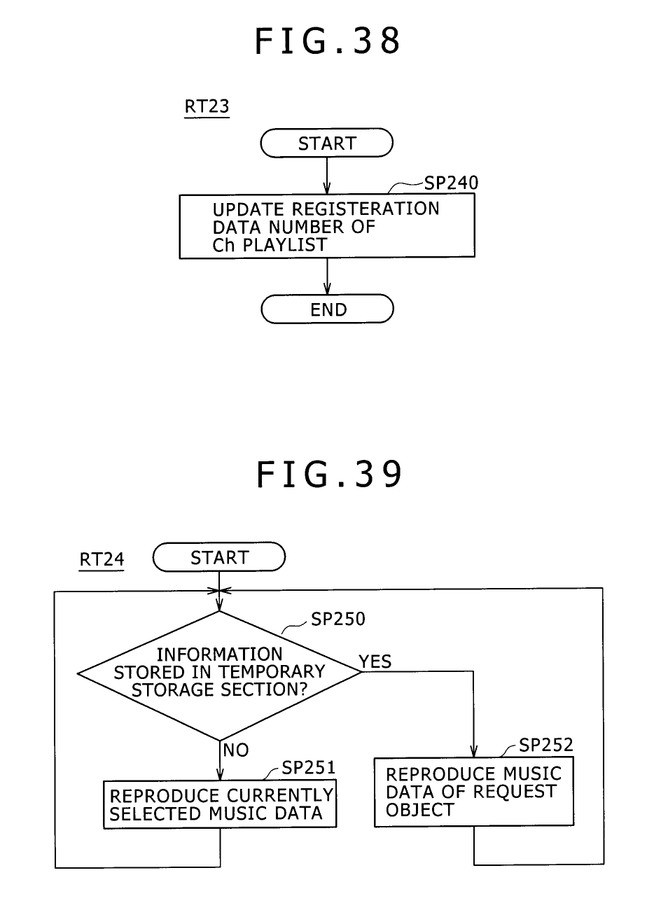

Further, a procedure of a process (hereinafter referred to also as registration data number updating process) for updating the registered data number Tn of a channel playlist PL described hereinabove is described. When the control section 112 of the music reproduction apparatus 210 recognizes that an ending operation of the Music Station function is performed, it starts a registered data number updating processing procedure RT23 illustrated in FIG. 38 and advances the processing to step SP240.

At step SP240, the control section 112 compares the number of music data Ad currently stored in each channel playlist PL with the registered data number Tn and updates, if the number is different from the registered data number Tn, the registered data number Tn to the number of the currently registered music data Ad. Then, the control section 112 ends the registered data number updating processing procedure RT23.

The music reproduction apparatus 210 updates the registered data number Tn of each channel playlist PL in accordance with such a registered data number updating processing procedure RT23 as just described.

### 3-3. Operation and Effects of the Second Embodiment

The music reproduction apparatus 210 having such a configuration as described above manages a plurality of music data Ad stored in the content storage section 115 using a plurality of channel playlists PL each of which is a list of music data information Ai which is content identification information of the music data Ad and stored in the list storage section 117.

The control section 112 of the music reproduction apparatus 210 selects one of the channel playlists PL through selection of a channel. Then, if the request button B20 of the remote controller RM2 is depressed while the music data Ad is reproduced in accordance with the selected channel playlist PL, then the control section 112 stores the music data information Ai for identifying the currently reproduced music data Ad and the list information Li for identifying the currently selected channel playlist PL into the temporary storage section 211 thereby to designate the currently reproduced music data Ad as a request object.

Thereafter, if the request button B20 is depressed again, then the control section 112 of the music reproduction apparatus 210 compares the list information Li of the currently selected channel playlist PL with the list information Li stored in the temporary storage section 211 to decide whether or not the currently selected channel playlist PL is same as the channel playlist PL selected upon the last depression of the request button B20.

Then, if the control section 112 of the music reproduction apparatus 210 decides coincidence of the music data information Ai, then it deletes the music data Ad of the request object from the currently selected channel playlist PL (that is, the channel playlist PL in which the music data Ad of the request object is currently registered). However, if the control section 112 decides incoincidence of the music data information Ai, then it additionally registers the music data Ad of the request object into the currently selected channel playlist PL (that is, into a channel playlist PL different from the channel playlist PL in which the music data Ad of the request object is currently registered).

As a result of the operation, the music reproduction apparatus 210 can let the user listen to a tune based on the music data Ad so as to recognize the substance of the tune while it allows the user to delete music data Ad desired by the user from the currently used list or additionally register such a desired music data Ad into another list through a simple operation of depressing the request button B20 twice.

In addition, the music reproduction apparatus 210 can reproduce music data Ad from a characteristic position so as to allow the user to listen to a characteristic portion of a tune based on the music data Ad. As a result, the user can recognize the substance of the tune further readily.

The music reproduction apparatus 210 according to the second embodiment having the configuration described above allows the user to recognize the substance of music data Ad of a content and add music data Ad desired by the user to another list by simple operation of repeating a depressing operation of the request button B20 twice. Consequently, editing conforming to an intention of the user can be performed further readily than ever.

### 3-4. Modifications to the Second Embodiment

In the second embodiment of the present invention described above, the reproduction control of music data Ad is performed such that the currently selected music data Ad is reproduced irrespective of whether the music reproduction apparatus 210 is in the partial reproduction mode or the normal reproduction mode similarly as in the case of the basic configuration and the first embodiment described hereinabove. However, according to the present invention, the reproduction control is not limited to this, but only the music data Ad of the request object may otherwise be reproduced continuously and repetitively while the music data Ad of the request object remains designated.

Here, a processing procedure of such reproduction control as just mentioned is described. After the Music Station function is started, the control section 112 of the music reproduction apparatus 210 starts a reproduction control processing procedure RT24 illustrated in FIG. 39 and advances the processing to step SP250. At step SP250, the control section 112 decides whether or not music data information Ai and list information Li are stored in the temporary storage section 211.

If a negative result is obtained at step SP250, then this signifies that that music data information Ai and list information Li are not stored in the temporary storage section 211, that is, music data Ad of a request object is not designated. In this instance, the control section 112 advances the processing to step SP251, at which it reproduces currently selected music data. Thereafter, the control section 112 returns the processing to step SP250.

On the other hand, if an affirmative result is obtained at step SP250, then this signifies that music data information Ai and list information Li are stored in the temporary storage section 211, that is, music data Ad of a request object is designated already. In this instance, the control section 112 advances the processing to step SP252, at which it reproduces the music data Ad of the request object (that is, music data Ad corresponding to the music data information Ai stored in the temporary storage section 211). Thereafter, the control section 112 returns the processing to step SP250. In this instance, the control section 112 repetitively reproduces the music data Ad of the request object until after the request is executed or canceled.

Consequently, the music reproduction apparatus 210 can let the user listen to music, for example, based on the music data Ad of the request object and changes over the channel in response to a user operation thereby to allow the user to select a channel playlist PL into which the music data Ad is to be additionally registered. Consequently, the convenience in use upon list editing can be enhanced significantly.

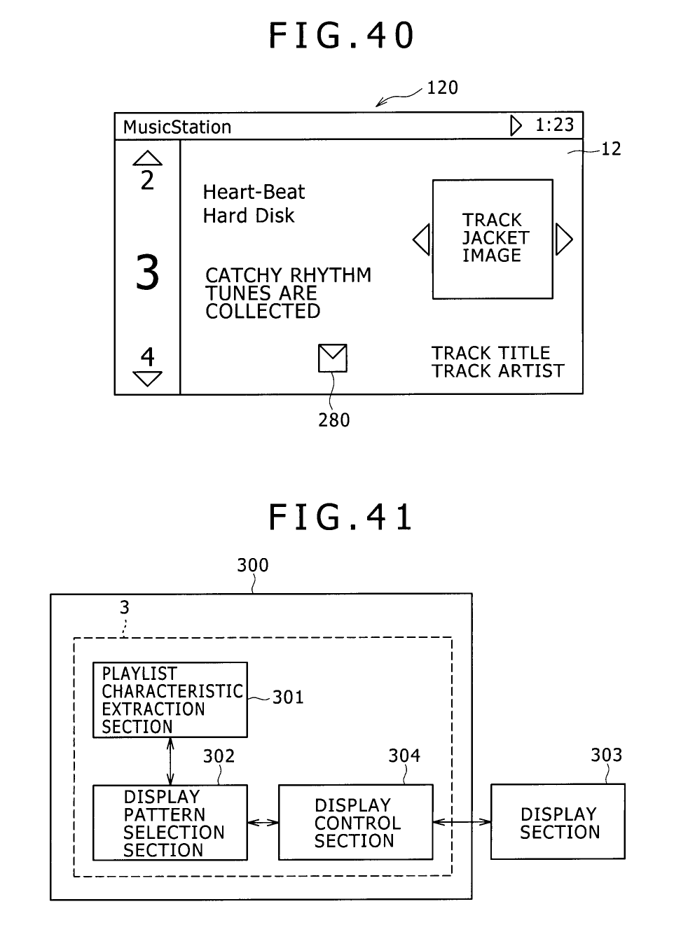

Or, while music data Ad of a request object remained designated, a request object designation icon 280 representing this may remain displayed in the tune selection region 12 of the selection screen 120 as seen in FIG. 40. Though not shown, the request object designation icon 280 is displayed also in the selected tune display region 22 of the reproduction screen 130.

Further, in the present second embodiment, if the request button B20 is depressed again in a state wherein a channel different from that when the request button B20 was depressed last is selected, then the music data Ad of the request object is additionally registered (that is, copied) into a channel playlist PL different from the channel playlist PL in which the music data Ad is currently registered. However, according to the embodiment of the present invention, the processing of the music data Ad is not limited to this, but the music data Ad may alternatively be deleted (that is, moved) from the channel playlist PL in which the music data Ad is originally registered.

Further, in the present second embodiment, when music data Ad of a request object is deleted from a channel playlist PL in which it is currently registered in response to depression of the request button B20, the music data reproduction setting Adi of music data information Ai corresponding to the music data Ad is set to “reproduction inhibited” to place the music data Ad of the request object into a state wherein the music data Ad of the request object is substantially deleted from the channel playlist PL in which it is currently registered. However, according to the embodiments of the present invention, the deletion of music data Ad of a request object is not limited to this, but music data information Ai corresponding to the music data Ad may actually be deleted from the channel playlist PL.

Incidentally, in the present second embodiment, since music data reproduction setting Adi of music data information Ai corresponding to music data Ad is set to “reproduction inhibited” to place the music data Ad of the request object substantially into a state wherein the music data Ad of the request object is deleted from a channel playlist PL in which the music data reproduction setting Adi of the request object is currently registered, for example, when it is desired to restore the deleted music data Ad, only it is necessary to change the music data reproduction setting Adi of the music data Ad back to “reproduction permitted”. Therefore, the convenience in use upon list editing can be further enhanced. Further, when the process of restoring the deleted music data Ad in this manner is executed, the process may be executed for all of the channel playlists PL or only for an arbitrary one or ones of the channel playlists PL.

Further, in the second embodiment described above, the deletion confirmation dialog 230 or the addition confirmation dialog 240 as a message for the confirmation that a deletion process or an additional registration process should be performed is displayed in an overlapping relationship with the selection screen 120 or the reproduction screen 130. However, according to the present embodiments of the invention, the display of a message is not limited to this, but, for example, character information representing that a deletion process or an additional registration process is performed may be displayed directly on the selection screen 120 or the reproduction screen 130. The point is that any of various kinds of information may be displayed as a message only if the user can confirm on a GUI screen that a deletion process or an additional registration process is performed.

Further, in the present second embodiment described above, the request acceptance dialog 220 or the no-data notification dialog 250 is closed in response to depression of the close button 222 or the close button 253 disposed thereon. However, according to the embodiments of the present invention, such closing of the request acceptance dialog 220 or the no-data notification dialog 250 is not limited to this, but, for example, the request acceptance dialog 220 or the no-data notification dialog 250 may be automatically closed when a predetermined interval of time elapses after it is displayed.

Further, in the present second embodiment described above, when the deletion interruption button 233 or the additional registration interruption button 243 is depressed, erasure of music data information Ai and list information Li from the temporary storage section 211 is interrupted. However, according to the embodiments of the present invention, the erasure is not limited to this, but also when the deletion interruption button 233 or the additional registration interruption button 243 is depressed, music data information Ai and list information Li may be erased from the temporary storage section 211.

Further, in the present second embodiment described above, when a default channel or a channel which includes music data Ad which has been reproduced at least once before then is selected, even if the number of music data Ad registered in the channel playlist PL of the channel is smaller than a predetermined number, music data Ad is reproduced if at least one music data Ad is registered in the channel playlist PL. However, according to the embodiments of the present invention, reproduction of music data Ad is not limited to this, but, for example, also when a channel whose channel display setting is changed to “display” on the channel display setting screen 140 in response to a user operation, music data Ad may be reproduced only if at least one music data Ad is registered in the channel playlist PL of the selected channel.

### 4. Third Embodiment

### 4-1. Outline of the Third Embodiment

Now, an outline of a third embodiment of the present invention is described. After the outline is described, detailed description of the third embodiment is given herein.

Referring to FIG. 41, there is shown a display control apparatus 300 which controls display of a playlist which defines a reproduction order of a plurality of contents. The display control apparatus 300 includes a playlist characteristic extraction section 301 (“playlist characteristic analysis section” can also be used synonymously) for extracting a characteristic of any of the playlists based on a plurality of contents registered in the playlist and a display pattern selection section 302 for selecting a display pattern in which a playlist is to be displayed based on the characteristic of the playlist extracted by the playlist characteristic extraction section 301. The display control apparatus 300 further includes a display control section 304 for controlling a display section 303 to display a playlist according to the display pattern selected by the display pattern selection section 302.

It is to be noted that the playlist characteristic extraction section 301, display pattern selection section 302 and display control section 304 correspond to the control section 3 of the content reproduction apparatus 1 (FIG. 1) having the configuration described hereinabove.

Since the display control apparatus 300 according to the third embodiment having such a configuration as described above can display a playlist in a display pattern suitable for a characteristic of the playlist, it can provide the user with a manner of enjoyment relating to a content different from that according to the related art.

### 4-2. Particular Configuration of the Third Embodiment

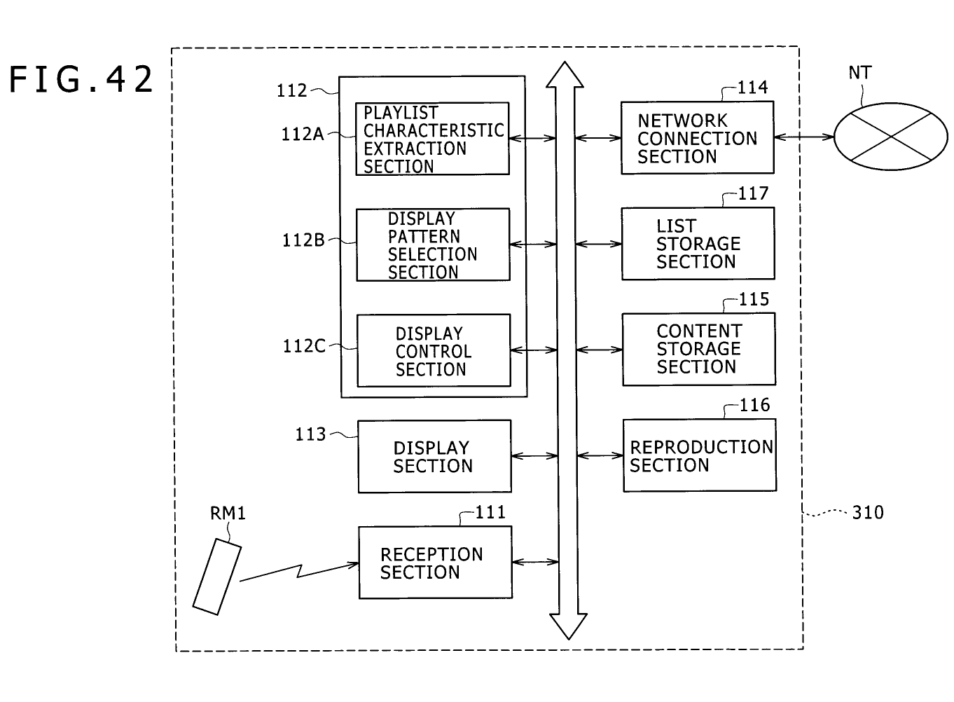

Now, a particular configuration of the third embodiment is described. FIG. 42 shows a music reproduction apparatus 310 which is a particular example of the display control apparatus 300 described hereinabove and is different in configuration from the music reproduction apparatus 110 of the first embodiment described hereinabove in that it does not include the time counting section 118.

Further, the music reproduction apparatus 310 includes a control section 112 which in turn includes a playlist characteristic extraction section 112A for extracting a characteristic of a channel playlist PL hereinafter described, a display pattern selection section 112B for selecting a display pattern upon display of the channel playlist PL based on the extracted characteristic of the channel playlist PL, and a display control section 112C for controlling the display section 113 to display a GUI screen in accordance with the selected display pattern.

Further, the music reproduction apparatus 310 includes a remote controller RM1 similar to that of the first embodiment.

It is to be noted that the playlist characteristic extraction section 112A, display pattern selection section 112B and display control section 112C of the music reproduction apparatus 310 correspond to the playlist characteristic extraction section 301, display pattern selection section 302 and display control section 304 of the display control apparatus 300 described hereinabove, respectively.

The music reproduction apparatus 310 has a download function, a CD recording function, a normal reproduction function, a CD reproduction function and a Music Station function similarly to the music reproduction apparatus 110 of the first embodiment described hereinabove. The control section 112 executes processes in accordance with the functions in response to an operation for the remote controller RM1.

The Music Station function of the music reproduction apparatus 310 is described here. First, a management method of music data Ad by the Music Station function of the music reproduction apparatus 310 is described. The management method is similar to the management method of the music reproduction apparatus 110 of the first embodiment described hereinabove, and for details thereof, the description of the first embodiment given hereinabove should be referred to.

In particular, the music reproduction apparatus 310 according to the third embodiment manages a plurality of channel playlists PL using a channel list CL as seen from FIG. 2, and manages a reproduction tune order of music data Ad in accordance with the channel playlists PL.

Further, similarly as in the first embodiment described hereinabove, the Music Station function prepares a channel playlist PL for each of classes which are considered to be requested by users such as a newly added tune, a tune whose reproduction time number is small, a catchy tune, a bright tune, a classical tune, or a heavy metal tune. Thus, the control section 112 of the music reproduction apparatus 310 automatically updates the channel playlists PL in response to storage or reproduction of music data Ad such that the music data Ad stored in the content storage section 115 is registered into a pertaining one of the prepared channel playlists PL based on the reproduction time number, impression value of the tune, genre and so forth of the music data Ad.

Then, the music reproduction apparatus 310 selects one of the channel playlists PL classified in a newly added tune, a tune whose reproduction time number is small, catchy music, bright music, classical music, heavy metal music and so forth as a channel in response to a user operation for the remote controller RM1 on a GUI screen. Consequently, the user can find out a desired tune readily in such a feeling of changing over of the channel of a radio broadcast.

Also the GUI screens used by the Music Station function are similar in screen configuration to those of the music reproduction apparatus 110 of the first embodiment described hereinabove. Thus, for details of the GUI screens, the description of the first embodiment given hereinabove should be referred to.

In particular, the music reproduction apparatus 310 according to the present third embodiment allows the user to visually observe the substance of a channel and the substance of a tune through the selection screen 120 described hereinabove with reference to FIG. 15. Further, the music reproduction apparatus 310 switchably selects a channel in accordance with a user operation for the upward button B13 or the downward button B14 of the remote controller RM1 and switchably selects a tune in accordance with a user operation for the leftward button B15 or the rightward button B16 of the remote controller RM1.

Further, the music reproduction apparatus 310 can change over the selection screen 120 to the reproduction screen 130 in accordance with a predetermined condition (that is, lapse of a predetermined interval of time without depression or operation of the determination button B17) such that the user can visually recognize the substance of the selected channel and tune through the reproduction screen 130.

Also the reproduction control of music data Ad upon such changeover of the GUI screen is similar to that by the music reproduction apparatus 110 of the first embodiment, and for details thereof, the description of the first embodiment given hereinabove should be referred to.

In particular, the music reproduction apparatus 310 according to the present third embodiment enters, when the selection screen 120 is displayed, the partial reproduction mode in which currently selected music data Ad is reproduced from a characteristic position, but enters, when the reproduction screen 130 is displayed, the normal reproduction mode in which currently selected music data Ad is reproduced normally. Whichever mode is entered, music data Ad is normally reproduced without being interrupted during execution of the Music Station function.

In particular, when the Music Station function is executed, the music reproduction apparatus 310 allows the user to change over the channel playlist PL in a unit of a channel in accordance with an operation of the upward button B13 or the downward button B14 of the remote controller RM1 in such a sense that the preset radio broadcasting station is changed over similarly as in the case of the music reproduction apparatus 110 of the first embodiment described hereinabove. Further, the music reproduction apparatus 310 can change over the tune to be reproduced in the channel in accordance with an operation of the leftward button B15 or the rightward button B16. Consequently, the music reproduction apparatus 310 allows the user to enjoy a desired tune further readily in such a sense that it enjoys music broadcast from a radio broadcasting station.

Also the procedure of the Music Station function starting process, channel changeover process and tune changeover process is similar to the procedure of the processes executed by the music reproduction apparatus 110 of the first embodiment described hereinabove. Thus, for details of the procedure, the description of the first embodiment given hereinabove should be referred to.

Also the channel display setting process by the Music Station function is similar to the display setting process executed by the music reproduction apparatus 110 of the first embodiment described hereinabove, and for details thereof, the description of the first embodiment given hereinabove should be referred to.

In particular, the music reproduction apparatus 310 according to the third embodiment is configured such that the channel display setting can be changed over between “display” and “no display” for each channel through the channel display setting screen 140 described hereinabove with reference to FIG. 22.

As described above, the music reproduction apparatus 310 of the third embodiment has the Music Station function corresponding to operations of the remote controller RM1 similarly as in the first embodiment described hereinabove. Thus, the music reproduction apparatus 310 can readily perform starting of the Music Station function, channel changeover, tune changeover, channel display setting and so forth by operations of the remote controller RM1.

Incidentally, the Music Station function handles a default playlist DPL whose list reproduction setting Ldi is fixed to “reproduction permitted” and other channel playlists PL, that is, channel playlists PL (hereinafter referred to as setting-changeable playlists) whose list reproduction setting Ldi can be changed from “reproduction permitted” to “reproduction inhibited” or vice versa. Thus, the music reproduction apparatus 310 changes the list reproduction setting Ldi of a setting-changeable playlist PL as channel display setting of a channel to which the setting-changeable playlist PL is allocated in response to a user operation on the channel display setting screen 140.

In this manner, whereas the list reproduction setting Ldi of each setting-changeable playlist PL (that is, channel display setting of each channel) is changed in response to a user instruction, the music reproduction apparatus 310 of the third embodiment automatically selects list reproduction setting Ldi (channel display setting of each channel) of each setting-changeable playlist PL in response to a characteristic of the channel playlist PL (for example, the number of music data registered in the channel playlist PL).

More particularly, the music reproduction apparatus 310 acquires the number of music data Ad registered in each setting-changeable playlist PL by means of the playlist characteristic extraction section 112A of the control section 112 and selects list reproduction setting Ldi (channel display setting of each channel) of the setting-changeable playlist PL in response to the acquired number by means of the display pattern selection section 112B of the control section 112.

In this instance, for example, if the number, acquired by the playlist characteristic extraction section 112A, of music data Ad registered in the setting-changeable playlist PL is zero, then the display pattern selection section 112B changes the list reproduction setting Ldi of the setting-changeable playlist PL to “reproduction inhibited” thereby to change the channel display setting of the channel to which the setting-changeable playlist PL is allocated to “no display”. On the other hand, where the number, acquired by the playlist characteristic extraction section 112A, of music data Ad registered in the setting-changeable playlist PL is one or more, then the control section 112 sets the list reproduction setting Ldi to “reproduction permitted” thereby to set the channel display setting of the channel to which the setting-changeable playlist PL is allocated to “display”.

Then, the display control section 112C of the control section 112 controls the display section 113 to display the selection screen 120 and the reproduction screen 130 in accordance with the channel display setting automatically selected by the display pattern selection section 112B.

In particular, if no music data Ad is registered in a setting-changeable playlist PL, for example, as in a case immediately after the music reproduction apparatus 310 is purchased, the control section 112 of the music reproduction apparatus 310 sets the channel display setting of the channel to which the setting-changeable playlist PL is allocated to “no display” (that is, to disable the selection screen 120 to display the setting-changeable playlist PL) thereby to make it unable to select the channel (that is, the setting-changeable playlist PL) on the selection screen 120. However, if at least one music data Ad is registered into the setting-changeable playlist PL as a result of addition of the music data Ad, then the control section 112 sets the channel display setting of the channel to which the setting-changeable playlist PL is allocated to “display” (that is, to display the list information Li of the setting-changeable playlist PL on the selection screen 120) thereby to enable selection of the channel (that is, the setting-changeable playlist PL) on the selection screen 120.

As a result, according to the Music Station function, although, for example, only the default channel can be selected (that is, only the default playlist DPL can be selected), as addition of music data Ad advances, the number of channels which can be selected (that is, setting-changeable playlists PL which can be selected) increases.

Consequently, if music data Ad is added, then the music reproduction apparatus 310 allows the user to recognize that the number of channels which can be enjoyed using the Music Station function increases. As a result, the music reproduction apparatus 310 can further urge the user to add music data Ad and can provide such a manner of enjoyment as enjoyment in increase of channels or search for a new channel in addition to enjoyment of mere listening to a tune.

Further, where a selectable channel is newly added in such a manner as described above, the music reproduction apparatus 310 notifies, upon starting of the Music Station function or upon channel selection, the user of such starting or channel selection.

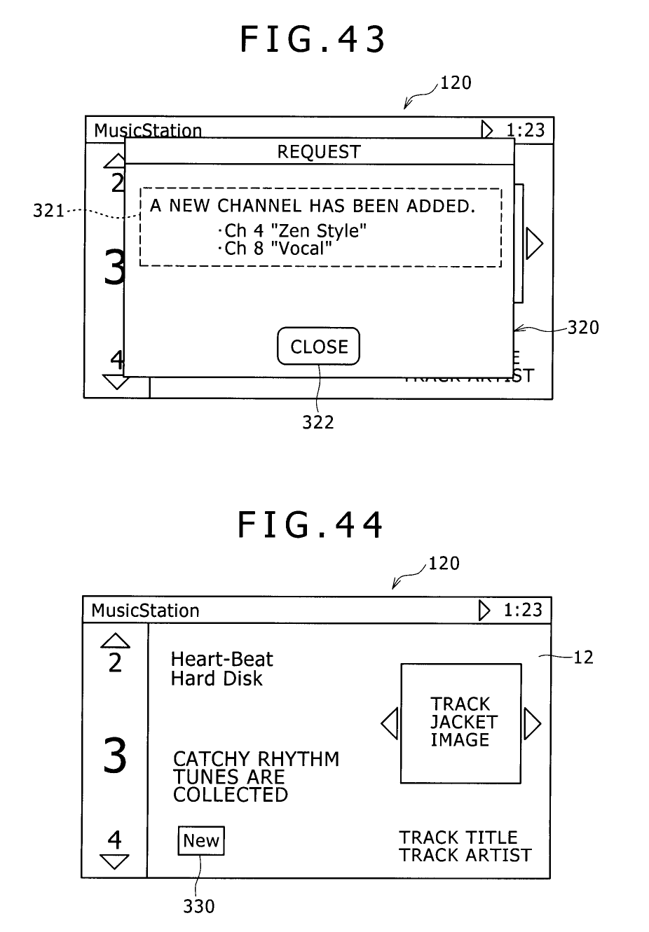

More particularly, if a selectable channel is newly added as described above, for example, upon starting of the Music Station function, the music reproduction apparatus 310 controls the display section 113 to display a channel addition notification dialog 320 for notifying the user that a selectable channel is newly added in an overlapping relation with the currently display selection screen 120 as seen in FIG. 43.

The channel addition notification dialog 320 describes character information 321 representing that a selectable channel is added newly (for example, “A new channel has been added. Ch4 “Zen Style” Ch8 “Vocal”. Further, the channel addition notification dialog 320 has a close button 322 for closing the channel addition notification dialog 320 disposed thereon.

Then, if the close button 322 is depressed by a user operation for the remote controller RM1, then the control section 112 of the music reproduction apparatus 310 closes the channel addition notification dialog 320.

Further, when a selectable channel is newly added, if the newly added channel is selected, for example, in response to a channel changeover operation, then the music reproduction apparatus 310 controls the display section 113 to display an addition notification icon 330 for notifying the user that the channel selected is the newly added channel in the tune selection region 12 of the selection screen 120 as seen in FIG. 44. Though not shown, the addition notification icon 330 is displayed also in the selected tune display region 22 of the reproduction screen 130.

The music reproduction apparatus 310 allows the user to recognize that a selectable channel is newly added in this manner. The channel addition notification dialog 320 and the addition notification icon 330 are displayed on the display section 113 by the display control section 112C in accordance with an instruction of the display pattern selection section 112B.

Now, a procedure of a process (hereinafter referred to also as channel display setting changing process) of automatically changing the list reproduction setting Ldi (that is, channel display setting) in response to a characteristic of a setting-changeable playlist PL described hereinabove is described.

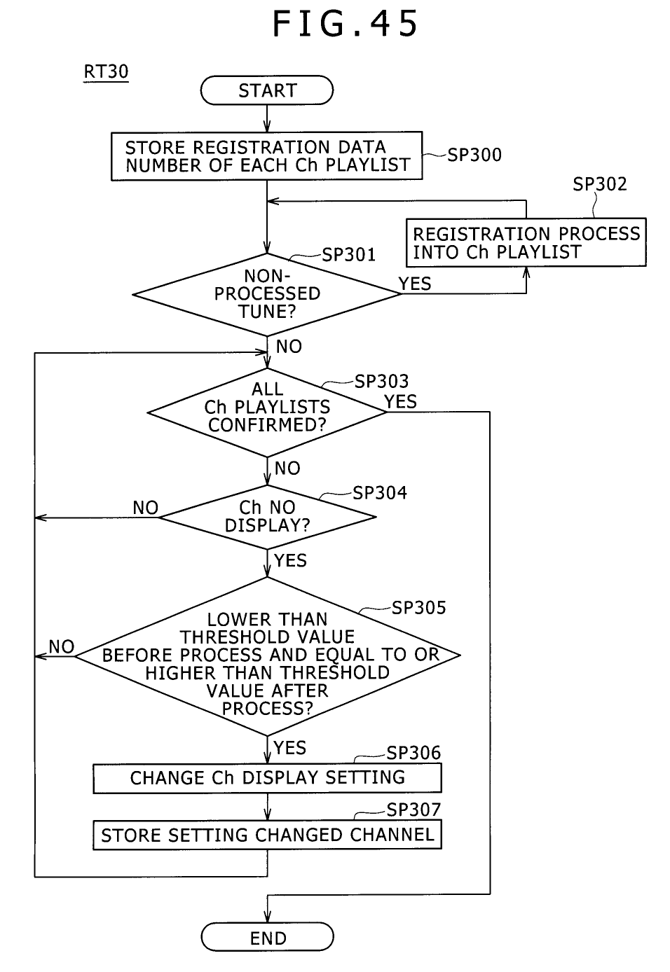

If music data Ad is downloaded, for example, by the download function in accordance with an instruction of the user and new music data Ad is added to (stored into) the content storage section 115, then the control section 112 of the music reproduction apparatus 310 starts a channel display setting changing processing procedure RT30 illustrated in FIG. 45 and advances the processing to step SP300.

At step SP300, the control section 112 acquires registration data number Tn from list information Li of all channel playlists PL by means of the playlist characteristic extraction section 112A and temporarily stores the registration data number Tn individually for the acquired channel playlists PL into the content storage section 115 or the list storage section 117, and then advances the processing to step SP301. Incidentally, since the registration data number Tn is updated when the Music Station function ends, each of them indicates the number of music data Ad registered in the channel playlist PL upon last operation, that is, the number of music data Ad registered in the channel playlist PL before the music data Ad is added to the channel playlist PL.

At step S301, the control section 112 decides based on the database DB constructed in the content storage section 115 and the channel playlists PL stored in the list storage section 117 whether or not the content storage section 115 includes unprocessed music data Ad (that is, music data Ad which is not registered in any channel playlist PL).

If an affirmative result is obtained at step SP301, then this signifies that all of newly added music data Ad are not completely registered into the channel playlists PL. In this instance, the control section 112 advances the processing to step SP302. At step S302, the control section 112 registers any music data Ad which is not registered as yet into a pertaining one of the prepared channel playlists PL based on the reproduction time number, impression value of the tune, genre and so forth of the music data Ad. Thereafter, the control section 112 returns the processing to step SP301.

If all of the newly added music data Ad are registered into the channel playlists PL in this manner, then the control section 112 obtains a negative result at step S301 and advances the processing to step SP303.

At step SP303, the control section 112 decides whether or not confirmation of the channel display setting has been completed for all channels in order to confirm the channel display setting for all channels (that is, the list reproduction setting Ldi of the channel playlists PL). Since no channel is confirmed at this point of time, a negative result is obtained at step SP303, and the control section 112 advances the processing to step SP304.

At step SP304, the control section 112 confirms the channel display setting of the channel which corresponds, for example, to a top one of the channel numbers CN of the channel list CL (the channel is hereinafter referred to as top channel) (that is, confirms the list reproduction setting Ldi of the channel playlist PL of the top channel). Then, the control section 112 decides whether or not the channel display setting is “no display” (that is, the list reproduction setting Ldi is “reproduction inhibited”). If a negative result is obtained at step SP304, then this signifies that the channel display setting of the top channel is “display”, that is, the top channel is a channel which already is displayed (can be selected) by the Music Station function. In this instance, the control section 112 returns the processing to step SP303.

On the other hand, if an affirmative result is obtained at step S304, then this signifies that the channel display setting of the top channel is “no display”, that is, the top channel currently is a channel which is not displayed (cannot be selected) by the Music Station function. In this instance, the control section 112 advances the processing to step SP305.

At step SP305, the control section 112 reads out the registered data number Tn of the channel playlist PL of the top channel from the content storage section 115 or the list storage section 117 in which the registered data number Tn for each channel playlist is stored. Further, the control section 112 confirms, by means of the playlist characteristic extraction section 112A thereof, the number of music data information Ai in the channel playlist PL of the top channel (that is, the number of music data Ad currently registered in the channel playlist PL). Then, the control section 112 decides whether or not the registered data number Tn is smaller than a threshold value (for example, is smaller than one and hence is zero) and the number of the music data information Ai is equal to or higher than a threshold value (for example, equal to or greater than one), that is, whether or not at least one music data Ad is registered in the channel playlist PL of the top channel.

If a negative result is obtained at step SP305, then this signifies that no music data Ad is registered in the channel playlist PL of the top channel as yet. In this instance, the playlist characteristic extraction section 112A returns the processing to step SP303.

On the other hand, if an affirmative result is obtained at step SP305, then this signifies that at least one music data Ad is registered in the channel playlist PL of the top channel. In this instance, the playlist characteristic extraction section 112A advances the processing to step SP306. At step SP306, the control section 112 changes the channel display setting of the top channel from “no display” to “display” thereby to set the top channel as a channel which is displayed (can be selected) newly by the Music Station function by means of the display pattern selection section 112B. Thereafter, the control section 112 advances the processing to step SP307.

At step SP307, the control section 112 stores information (hereinafter referred to also as channel addition information) representing that the top channel is a newly added channel into the content storage section 115 or the list storage section 117. Thereafter, the control section 112 returns the processing to step SP303. It is to be noted that the channel addition information is used to specify a newly added channel when the Music Station function is started.

Then, after the processing returns to step SP303, the control section 112 executes the processes at steps SP303 to SP307 also for all channels following the top channel. Then, if the control section 112 completes the execution for all channels (that is, completes confirmation of the channel display setting of all channels), then the music reproduction apparatus 310 obtains an affirmative result at step SP303 and thus ends the channel display setting changing processing procedure RT30.

The control section 112 of the music reproduction apparatus 310 automatically changes the channel display setting of all channels in accordance with such a channel display setting changing processing procedure as described above.

Further, the Music Station function changes the saturation (brilliance) of the selection screen 120 and the reproduction screen 130 when a channel to which a channel playlist PL is allocated is selected in response to a characteristic of the channel playlist PL (for example, the number of music data Ad registered in the channel playlist PL).

In particular, in the music reproduction apparatus 310, the display pattern selection section 112B selects the saturation of the selection screen 120 and the reproduction screen 130 when a channel to which the channel playlist PL acquired by the playlist characteristic extraction section 112A of the control section 112 is allocated is selected (that is, the selection screen 120 and the reproduction screen 130 when the list information Li of the channel playlist PL is displayed) in response to the number of music data Ad registered in the channel playlist PL.

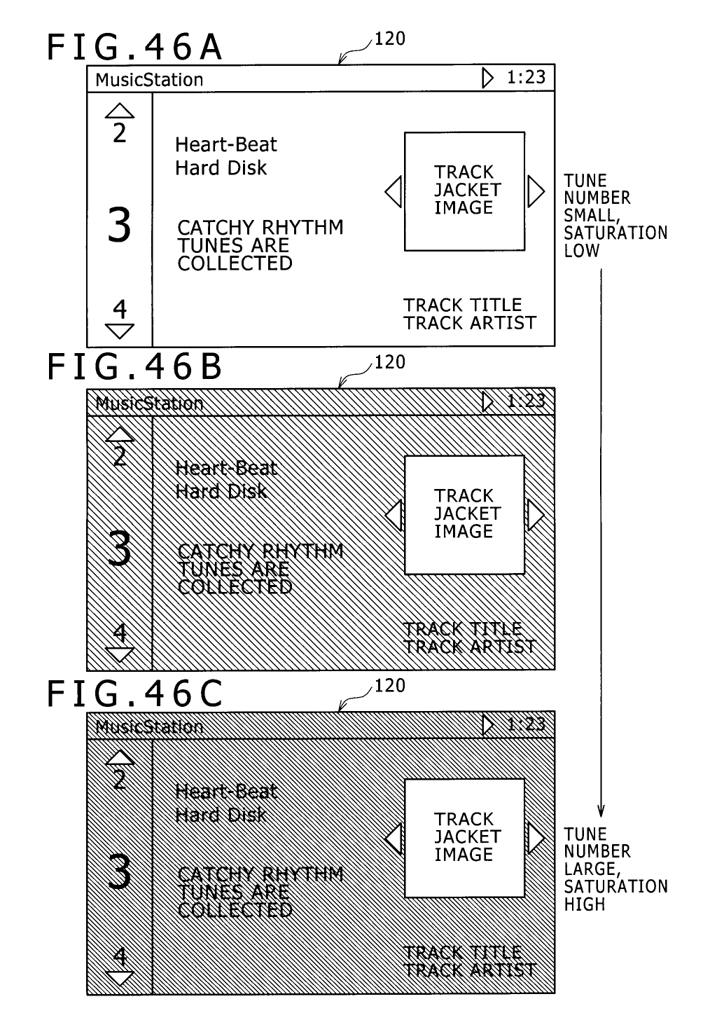

In this instance, if the number of music data Ad registered in the channel playlist PL acquired by the playlist characteristic extraction section 112A is, for example, equal to or smaller than 5, then the display pattern selection section 112B selects a first saturation which is lowest as the saturation of the selection screen 120 as seen in FIG. 46A when the list information Li of the channel playlist PL is displayed. However, if the number is equal to or greater than 6 but equal to or smaller than 10, then the display pattern selection section 112B selects a second saturation which is higher than the first saturation as seen in FIG. 46B. Further, if the number is equal to or greater than 11, then the display pattern selection section 112B selects a third saturation which is higher than the second saturation as seen in FIG. 46C. Though not shown, also the saturation of the reproduction screen 130 is selected similarly.

Then, the display control section 112C of the control section 112 controls the display section 113 to display the selection screen 120 or the reproduction screen 130 in accordance with the saturation automatically selected by the display pattern selection section 112B.

As a result, the music reproduction apparatus 310 can provide such a manner of enjoyment to the user that the user observes a channel playlist PL which is displayed vividly by addition of music data Ad in addition to a manner of enjoyment of mere listening to a new tune through addition of music data Ad. As a result, the music reproduction apparatus 310 can urge the user to add music data Ad furthermore.

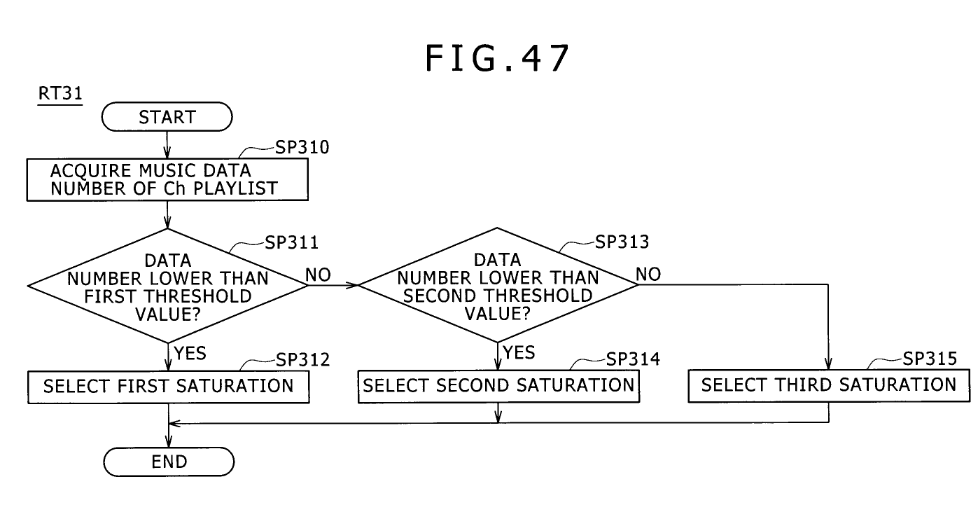

Now, a procedure of a process (hereinafter referred to also as screen saturation selection process) of selectively determining the saturation of the selection screen 120 and the reproduction screen 130 is described. It is to be noted that, for the convenience of description, the procedure where the saturation of the selection screen 120 is selectively determined is described as an example. If a channel playlist PL is selected through selection of a channel upon starting of the Music Station function, or if a channel playlist PL is selected through selection of a channel in response to a channel changeover operation during operation of the Music Station function, then the control section 112 of the music reproduction apparatus 310 starts a screen saturation selective determination processing procedure RT31 illustrated in FIG. 47 and advances the processing to step SP310.

At step SP310, the control section 112 acquires the number of music data Ad currently registered in the currently selected channel playlist PL by means of the playlist characteristic extraction section 112A, and then advances the processing to step SP311. Here, the playlist characteristic extraction section 112A acquires the number of music data information Ai in the channel playlist PL to acquire the number of the currently registered music data Ad.

At step SP311, the control section 112 decides whether or not the number of the acquired music data Ad is equal to or smaller than a first threshold value (for example, “5”). If an affirmative result is obtained at step SP311, then this signifies that the number of music data Ad registered in the currently selected channel playlist PL is equal to or smaller than 5. In this instance, the control section 112 advances the processing to step SP312.

At step SP312, the control section 112 selects, by means of the display pattern selection section 112B thereof, the lowest first saturation illustrated in FIG. 46A as the saturation of the selection screen 120 in which the list information Li of the currently selected channel playlist PL is displayed. Then, the control section 112 ends the screen saturation selective determination processing procedure RT31.

On the other hand, if a negative result is obtained at step SP311, then this signifies that the number of music data Ad registered in the currently selected channel playlist PL is equal to or greater than 6. In this instance, the control section 112 advances the processing to step SP313.

At step SP313, the control section 112 decides whether or not the number of the acquired music data Ad is equal to or lower than the second threshold value (for example, “10”). If an affirmative result is obtained at step SP313, then this signifies that the number of music data Ad registered in the currently selected channel playlist PL is equal to or greater than 6 but equal to or smaller than 10. In this instance, the playlist characteristic extraction section 112A advances the processing to step SP314.

At step SP314, the control section 112 selects, by means of the display pattern selection section 112B thereof, the second saturation higher than the first saturation and illustrated in FIG. 46B as the saturation of the selection screen 120 on which the list information Li of the currently selected channel playlist PL is displayed. Then, the control section 112 ends the screen saturation selective determination processing procedure RT31.

On the other hand, if a negative result is obtained at step SP313, then this signifies that the number of the music data Ad registered in the currently selected channel playlist PL is equal to or greater than 11. In this instance, the control section 112 advances the processing to step SP315.

At step SP315, the control section 112 selects, by means of the display pattern selection section 112B thereof, the third saturation higher than the second saturation and illustrated in FIG. 46C as the saturation of the selection screen 120 on which the list information Li of the currently selected channel playlist PL is displayed. Then, the control section 112 ends the screen saturation selective determination processing procedure RT31.

The control section 112 of the music reproduction apparatus 310 selectively determines the saturation of the selection screen 120 corresponding to the currently selected channel playlist PL in accordance with such a screen saturation selective determination processing procedure RT31 as described above.

It is to be noted here that, while the screen saturation selective determination processing procedure RT31 is described separately from the Music Station function starting processing procedure RT10 and the channel changeover processing procedure RT11 for the convenience of description, actually it is executed in the Music Station function starting processing procedure RT10 and the channel changeover processing procedure RT11. In particular, the screen saturation selective determination processing procedure RT31 is executed, for example, at step SP108 of the Music Station function starting processing procedure RT10 or at step SP118 of the channel changeover processing procedure RT11.

Therefore, the selection screen 120 displayed at step SP108 of the Music Station function starting processing procedure RT10 and at step SP118 of the channel changeover processing procedure RT11 is displayed with the saturation selected by the display pattern selection section 112B under the control of the display control section 112C.

### 4-3. Operation and Effects by the Third Embodiment

The music reproduction apparatus 310 having the configuration described above manages a plurality of music data Ad stored in the content storage section 115 using a plurality of channel playlists PL stored in the list storage section 117 and each including music data information Ai which is content identification information of music data Ad.

Then, if one of the channel playlists PL is selected in accordance with a user operation of the remote controller RM1, then the control section 112 of the music reproduction apparatus 310 controls the display section 113 to display the list information Li (list name Lt and list explanation Lde) of the selected channel playlist PL on the selection screen 120.

Here, the control section 112 of the music reproduction apparatus 310 extracts, by means of the playlist characteristic extraction section 112A, a characteristic (number of registered music data Ad) of each channel playlist PL and selectively determines, by means of the display pattern selection section 112B, a display pattern (display/no display and saturation) to be used to display the channel playlist PL on the selection screen 120 in response to the extracted characteristic.

More particularly, if the number of music data Ad registered in the channel playlist PL is zero, then the display pattern selection section 112B sets the channel playlist PL to no display, but if the number of music data Ad registered in the channel playlist PL is one or more, then the display pattern selection section 112B sets the channel playlist PL to display.

In other words, if at least one music data Ad is registered into a channel playlist PL in response to addition of the music data Ad by the user, then the music reproduction apparatus 310 causes the channel playlist PL to be displayed so as to tell the presence of such music data Ad to the user. Consequently, the music reproduction apparatus 310 can provide such a new manner of enjoyment which is not available with the related art to the user that the user adds music data Ad to increase channel playlists PL which can be selected or searches for a new channel playlist PL.

Further, if the number of music data Ad registered in a channel playlist PL is equal to or greater than the first threshold value (for example, 5), then the display pattern selection section 112B selectively determines the first saturation value as the saturation to be used when the channel playlist PL is displayed. However, if the number of such music data Ad is greater than the first threshold value but equal to or smaller than the second threshold value (for example, 10) higher than the first threshold value, then the display pattern selection section 112B selectively determines the second saturation value. On the other hand, if the number of such music data Ad is greater than the second threshold value, then the display pattern selection section 112B selects the third saturation.

In particular, since the music reproduction apparatus 310 displays a channel playlist PL with a saturation which depends upon the number of music data Ad registered in the channel playlist PL, it can provide such a new manner of enjoyment which is not available with related art to the user that the user observes a channel playlist PL which is displayed with a saturation which depends upon the number of music data Ad registered in the channel playlist PL.

Further, since the display pattern when each channel playlist PL is displayed on the selection screen 120 is selectively determined in response to the number of music data Ad registered in the channel playlist PL in this manner, the music reproduction apparatus 310 can let the user recognize that a new manner of enjoyment is provided by adding music data Ad. As a result, it is possible to further urge the user to add music data Ad.

Since the music reproduction apparatus 310 having the configuration described above can display a channel playlist PL in a display pattern conforming to a characteristic of the channel playlist PL, it can provide a new manner of enjoyment different from what used to be available manners of enjoyment relating to music data Ad to the user.

### 4-4. Modifications to the Third Embodiment

It is to be noted that, while, in the third embodiment, the saturation for the selection screen 120 and the reproduction screen 130 as a display pattern to be selectively determined in response to a characteristic of a channel playlist PL is selectively determined, according to the embodiment of the present invention, the display pattern is not limited to this, but the brightness (that is, the luminosity of the backlight of the display section 113) may be selectively determined instead.

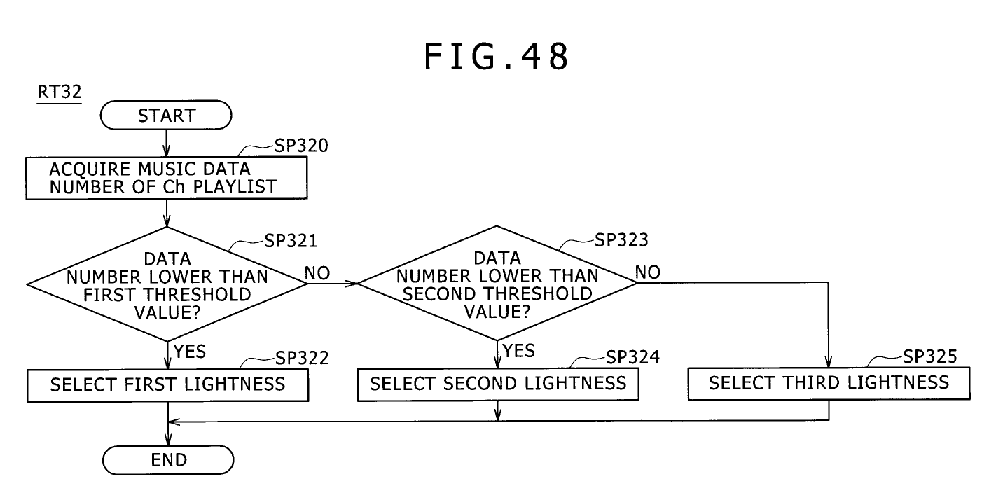

Here, a procedure of such a process (hereinafter referred to also as screen brightness selective determination process) of selectively determining the brightness of the screen as described above is described. Here, for the convenience of description, the process wherein the brightness of the selection screen 120 is selectively determined is described as an example. If a channel playlist PL is selected through selection of a channel upon starting of the Music Station function, or if a channel playlist PL is selected through selection of a channel in response to a channel changeover operation while the Music Station function is operating, then the control section 112 of the music reproduction apparatus 310 starts a screen brightness selective determination processing procedure RT32 illustrated in FIG. 48 and advances the processing to step SP320.

At step SP320, the control section 112 acquires the number of music data Ad currently registered in the currently selected channel playlist PL by means of the playlist characteristic extraction section 112A, and then advances the processing to step SP321. Here, the playlist characteristic extraction section 112A acquires the number of music data information Ai in the channel playlist PL to acquire the number of the currently registered music data Ad.

At step SP321, the control section 112 decides whether or not the number of the acquired music data Ad is equal to or smaller than a first threshold value (for example, “5”). If an affirmative result is obtained at step SP321, then the control section 112 advances the processing to step SP322.

At step SP322, the control section 112 selects, by means of the display pattern selection section 112B thereof, the lowest first brightness as the brightness of the selection screen 120 in which the list information Li of the currently selected channel playlist PL is displayed. Then, the control section 112 ends the screen brightness selective determination processing procedure RT32.

On the other hand, if a negative result is obtained at step SP321, then the control section 112 advances the processing to step SP323. At step SP323, the control section 112 decides whether or not the number of the acquired music data Ad is equal to or lower than the second threshold value (for example, “10”). If an affirmative result is obtained at step SP323, then the playlist characteristic extraction section 112A advances the processing to step SP324.

At step SP324, the control section 112 selects, by means of the display pattern selection section 112B thereof, a second brightness higher than the first brightness as the brightness of the selection screen 120 on which the list information Li of the currently selected channel playlist PL is displayed. Then, the control section 112 ends the screen brightness selective determination processing procedure RT32.

On the other hand, if a negative result is obtained at step SP323, then the control section 112 advances the processing to step SP325. At step SP325, the control section 112 selects, by means of the display pattern selection section 112B thereof, a third brightness higher than the second brightness as the brightness of the selection screen 120 on which the list information Li of the currently selected channel playlist PL is displayed. Then, the control section 112 ends the screen brightness selective determination processing procedure RT32.

As a result, the display control section 112C of the control section 112 controls the display section 113 to display the selection screen 120 or the reproduction screen 130 in accordance with the brightness selectively determined by the display pattern selection section 112B.

The music reproduction apparatus 310 having the configuration described can provide a new manner of enjoyment which is not available with related art to the user that the user watches a channel playlist PL which is displayed with a brightness which depends upon the number of music data Ad registered in the channel playlist PL. Further, the display pattern is not limited to the saturation or the brightness but may be selectively determined among the color, density, transparency and so forth.

Further, in this instance, not the entire display pattern but part of the display pattern of the selection screen 120 or the reproduction screen 130 may be selectively determined. In particular, for example, the display pattern of the turn selection region 12 of the selection screen 120 or the selected tune display region 22 of the reproduction screen 130 may be selectively determined, or the display pattern (font, character size, character color or the like) of character information displayed on the selection screen 120 or character information displayed on the reproduction screen 130 may be selectively determined.

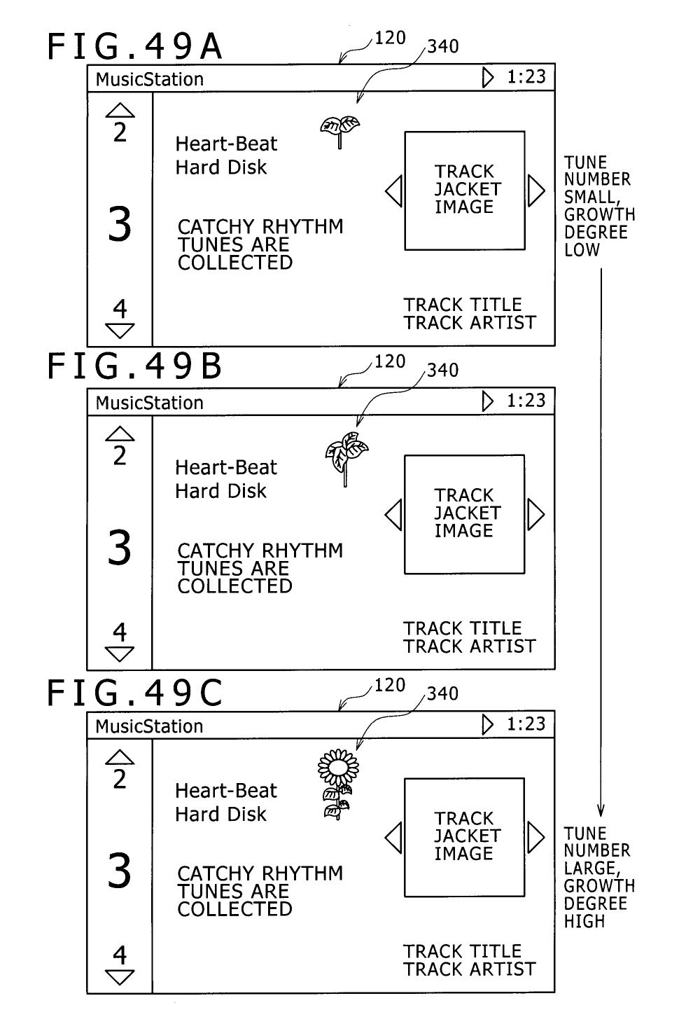

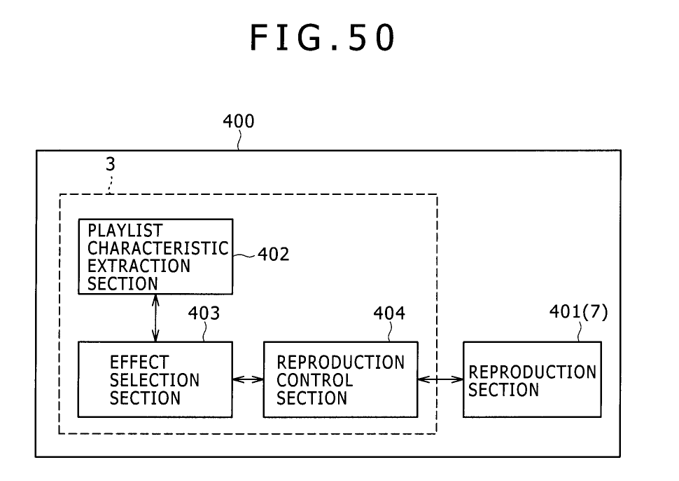

Further, a character icon 340 unique to each channel playlist PL may be displayed on the selection screen 120 as seen, for example, in FIGS. 49A, 49B and 49C, so as to selectively determine the display pattern of the character icon 340. In this instance, the music reproduction apparatus 310 causes a character icon 340, which imitates, for example, a living thing, to be displayed such that the display pattern of the character icon 340 is changed in such a manner that the character icon 340 grows as the number of music data Ad registered in the channel playlist PL increases. By the display just described, the music reproduction apparatus 310 can provide such a new manner of enjoyment which is not available with related art to the user that the channel playlist PL is brought up by addition of music data Ad.

Further, while, in the present third embodiment described hereinabove, the number of music data Ad registered in a channel playlist PL is acquired by confirming not the registered data number Tn of the channel playlist PL but the number of music data information Ai in the channel playlist PL, according to the embodiment of the present invention, the acquisition of the registered data number Tn is not limited to this. For example, updating of the registered data number Tn may be performed not upon ending of the Music Station function but upon registration of music data Ad into the channel playlist PL such that the registered data number Tn is acquired as the number of music data Ad registered in the channel playlist PL.

Further, while, in the third embodiment described above, a characteristic of a channel playlist PL is extracted based on the number of registered music data Ad which is a statistic value of the music data Ad registered in the channel playlist PL to selectively determine a display pattern, according to the embodiment of the present invention, the selection of a display pattern is not limited to this. In particular, a characteristic of a channel playlist PL may be extracted based on one of the date on which first music data Ad is registered into the channel playlist PL, the date on which music data Ad is registered last, the reproduction frequency of music data Ad registered in the channel playlist PL, the degree of importance of music data Ad registered in the channel playlist PL and so froth to selectively determine a display pattern.

In particular, the music reproduction apparatus 310 additionally describes, for example, the date on which first music data Ad is registered into each channel playlist PL into the list information Li of the channel playlist PL and selectively determines the display pattern based on the date. Where the display pattern is selectively determined in this manner, the music reproduction apparatus 310 displays, for example, a channel playlist PL whose date is latest in a striking color so that the user can recognize the novelty of the channel playlist PL from the display pattern.

Or, the music reproduction apparatus 310 additionally describes, for example, the date of last registration of music data Ad into each channel playlist PL into the list information Li of the channel playlist PL and selectively determines a display pattern based on the date. By such selective determination, the music reproduction apparatus 310 displays, for example, a channel playlist PL whose date is oldest in a dark color so that the user can recognize the oldness of the channel playlist PL from the display pattern.

Otherwise, the music reproduction apparatus 310 additionally describes a statistic value of the reproduction frequency (for example, a sum value or an average value of the reproduction time numbers) of music data Ad registered in each channel playlist PL into the list information Li of the channel playlist PL and selects a display pattern based on the reproduction frequency. By such selective determination, the music reproduction apparatus 310 can allow the user to recognize its liking of a channel playlist PL using a display pattern, for example, by raising the brightness for a channel playlist PL which is, for example, enjoyed comparatively frequently by the user. In this instance, while a statistic value of the reproduction time number is described in the list information Li, alternatively the reproduction time number of music data Ad or the like may be acquired from the attribute information Ti to calculate the statistic value every time.

Further, the music reproduction apparatus 310 additionally describes, for example, a statistic value of the importance degree (for example, a sum value or an average value of values representing the degree of importance) of music data Ad registered in each channel playlist PL into the list information Li of the channel playlist PL, and selectively determines a display pattern in accordance with the degree of importance. Where the display pattern is selectively determined in this manner, the music reproduction apparatus 310 displays, for example, a channel playlist PL whose degree of importance is comparatively high in a comparatively striking color or the like so that the user can recognize the degree of importance of the channel playlist PL from the display pattern. In this instance, while a statistic value of the degree of importance is described in the list information Li, a statistic value of the degree of importance of each music data Ad from the attribute information Ti may be calculated every time. It is to be noted that the degree of importance may be set in the music data Ad in advance or may be set by the user.

Or otherwise, a characteristic of a channel playlist PL may be extracted based on the genre, an impression value or the like included in the attribute information Ti which is additional information to music data Ad registered in the channel playlist PL to selectively determine a display pattern.

More particularly, the music reproduction apparatus 310 displays a channel playlist PL, for example, in a color whose brightness increases as the channel playlist PL is formed from music data Ad of a brighter genre (such as the popular music). Where the displaying method just described is used, the music reproduction apparatus 310 can let the user recognize the genre of music data Ad registered in the channel playlist PL from the display pattern.

Or, the music reproduction apparatus 310 calculates, for example, a statistic value (sum value or average value) of an impression value of tunes of music data Ad registered in a channel playlist PL and displays the channel playlist PL in a color whose brightness increases as the value indicative of the brightness of the statistic value increases. Where the displaying method just described is used, the music reproduction apparatus 310 can let the user recognize the impression of music data Ad registered in the channel playlist PL from the display pattern.

Or else, the display pattern may be selectively determined based on the degree of agreement between a keyword (for example, “bright”) representing a characteristic of a channel playlist PL which is attribute information of the channel playlist PL and a characteristic of music data Ad (for example, an impression value of a tune) actually registered in the channel playlist PL.

Actually, while the music reproduction apparatus 310 described above registers music data Ad whose value representative of the brightness of an impression value of the tune is equal to or higher than a predetermined value into a channel playlist (tune list) PL in which “bright” is described as a keyword, according to the embodiment of the present invention, the registration is not limited to this. In particular, from among music data Ad stored in the content storage section 115, those music data Ad whose value representing the brightness of an impression value of the tune is included in the top ten may be registered into the bright tune list PL.

Where this registration method is employed, in such a case that the number of music data Ad stored in the content storage section 115 is small, music data Ad of a bright tune may not necessarily be registered into the bright tune list PL. Therefore, for example, an average value of values representing the brightness of an impression value of a tune of music data Ad registered in the bright tune list PL is calculated, and the bright tune list PL is displayed in a color whose brightness increases as the average value increases. Where this displaying method is employed, the music reproduction apparatus 310 can let the user recognize the degree of agreement between a characteristic of the channel playlist PL and a characteristic of music data Ad actually registered in the channel playlist PL from the display pattern.

Further, in the screen saturation selective determination processing procedure RT31 in the present third embodiment described above, three display patterns including the first saturation, second saturation and third saturation are used in response to the number of music data Ad registered in a channel playlist PL. However, according to the embodiment of the present invention, the number of display patterns is not limited to this, but may be two or four or more. Or, for example, the number of music data Ad registered in a channel playlist PL and the value of the saturation may be set so as to correspond to each other such that the saturation is varied linearly in response to the number of registered music data Ad.

Furthermore, while, in the present third embodiment described above, the channel addition dialog 320 is closed in response to depression of the close button 322, according to the embodiment of the present invention, the closing of the channel addition dialog 320 is not limited to this, but, for example, the channel addition dialog 320 may be automatically closed when predetermined time elapses after the channel addition dialog 320 is displayed.

### 5. Fourth Embodiment

### 5-1. Outline of the Fourth Embodiment

Now, an outline of a fourth embodiment of the present invention is described. After the outline is described, detailed description of the third embodiment is given herein.

Referring to FIG. 50, there is shown a content reproduction apparatus 400 which reproduces a content based on a playlist which defines a reproduction order of a plurality of contents. The content reproduction apparatus 400 includes a reproduction section 401 for reproducing a content, and a playlist characteristic extraction section 402 for extracting a characteristic of any of the playlists based on a plurality of contents which belong to the playlist. The content reproduction apparatus 400 further includes an effect selection section 403 for selecting an effect to be used for reproduction of a content belonging to the playlist based on a characteristic of the playlist extracted by the playlist characteristic extraction section 402. The content reproduction apparatus 400 further includes a display control section 404 for controlling the reproduction section 401 to reproduce a content belonging to the playlist based on the effect selected by the 403.

It is to be noted that the reproduction section 401 corresponds to the reproduction section 7 of the content reproduction apparatus 1 (FIG. 1) having the basic configuration described hereinabove, and the playlist characteristic extraction section 402, effect selection section 403 and display control section 404 correspond to the control section 3 of the content reproduction apparatus 1.

Since the content reproduction apparatus 400 according to the fourth embodiment having such a configuration as described above can reproduce a content belonging to a playlist in an effect suitable for a characteristic of the playlist, it can provide the user with a new manner of enjoyment relating to a content different from that according to the related art.

### 5-2. Particular Configuration of the Fourth Embodiment

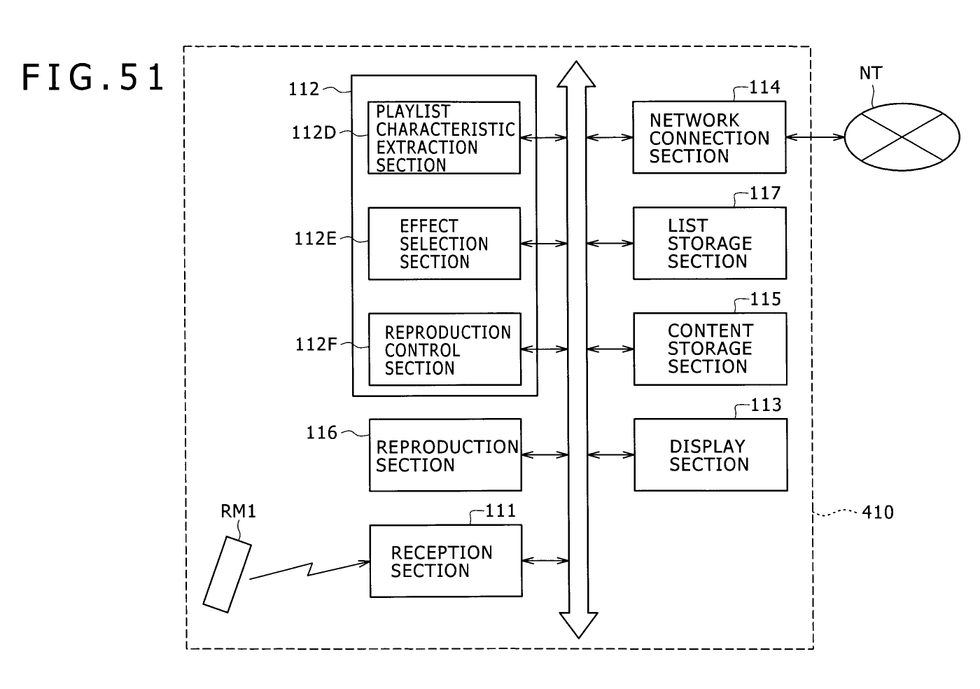

Now, a particular configuration of the fourth embodiment is described. FIG. 51 shows a music reproduction apparatus 410 which is a particular example of the content reproduction apparatus 400 described hereinabove and is different in configuration from the music reproduction apparatus 110 of the first embodiment described hereinabove in that it does not include the time counting section 118.

Further, the music reproduction apparatus 410 includes a control section 112 which in turn includes a playlist characteristic extraction section 112D for extracting a characteristic of a channel playlist PL hereinafter described, an effect selection section 112E for selecting an effect to be allocated when music data Ad registered in the extracted channel playlist PL is reproduced based on the characteristic of the channel playlist PL, and a reproduction control section 112F for controlling the reproduction section 116 to reproduce music data Ad in accordance with the selected effect.

Further, the music reproduction apparatus 410 includes a remote controller RM1 similar to that of the first embodiment.

It is to be noted that the playlist characteristic extraction section 112D, effect selection section 112E and reproduction control section 112F of the music reproduction apparatus 410 correspond to the playlist characteristic extraction section 402, effect selection section 403 and display control section 404 of the content reproduction apparatus 400 described hereinabove, respectively.

The music reproduction apparatus 410 has a download function, a CD recording function, a normal reproduction function, a CD reproduction function and a Music Station function similarly to the music reproduction apparatus 110 of the first embodiment described hereinabove. The control section 112 executes processes in accordance with the functions in response to an operation for the remote controller RM1.

The Music Station function of the music reproduction apparatus 410 is described here. First, a management method of music data Ad by the Music Station function of the music reproduction apparatus 410 is described. The management method is similar to the management method of the music reproduction apparatus 110 of the first embodiment described hereinabove, and for details thereof, the description of the first embodiment given hereinabove should be referred to.

In particular, the music reproduction apparatus 410 according to the fourth embodiment manages a plurality of channel playlists PL using a channel list CL as seen from FIG. 2, and manages a reproduction tune order of music data Ad in accordance with the channel playlists PL.

Further, similarly as in the first embodiment described hereinabove, the Music Station function prepares a channel playlist PL for each of classes which are considered to be requested by users such as a newly added tune, a tune whose reproduction time number is small, a catchy tune, a bright tune, a classical tune, or a heavy metal tune. Thus, the control section 112 of the music reproduction apparatus 410 automatically updates the channel playlists PL in response to storage or reproduction of music data Ad such that the music data Ad stored in the content storage section 115 is registered into a pertaining one of the prepared channel playlists PL based on the reproduction time number, impression value of the tune, genre and so forth of the music data Ad.

Then, the music reproduction apparatus 410 selects one of channels to which the channel playlists PL classified in a newly added tune, a tune whose reproduction time number is small, catchy music, bright music, classical music, heavy metal music and so forth are allocated in response to a user operation for the remote controller RM1 on a GUI screen. Consequently, the user can find out a desired tune readily in such a feeling of changing over of the channel of a radio broadcast.

Also the GUI screens used by the Music Station function are similar in screen configuration to those of the music reproduction apparatus 110 of the first embodiment described hereinabove. Thus, for details of the GUI screens, the description of the first embodiment given hereinabove should be referred to.

In particular, the music reproduction apparatus 410 according to the present fourth embodiment allows the user to visually confirm the substance of a channel and the substance of a tune through the selection screen 120 described hereinabove with reference to FIG. 15. Further, the music reproduction apparatus 410 switchably selects a channel in accordance with a user operation for the upward button B13 or the downward button B14 of the remote controller RM1 and switchably selects a tune in accordance with a user operation for the leftward button B15 or the rightward button B16 of the remote controller RM1.

Further, the music reproduction apparatus 410 can change over the selection screen 120 to the reproduction screen 130 in accordance with a predetermined condition (that is, operation of the determination button B17 or lapse of a predetermined interval of time without depression) such that the user can visually recognize the substance of the selected channel and tune through the reproduction screen 130.

Also the reproduction control of music data Ad upon such changeover of the GUI screen is similar to that by the music reproduction apparatus 110 of the first embodiment, and for details thereof, the description of the first embodiment given hereinabove should be referred to.

In particular, the music reproduction apparatus 410 according to the present fourth embodiment enters, when the selection screen 120 is displayed, the partial reproduction mode in which currently selected music data Ad is reproduced from a characteristic position, but enters, when the reproduction screen 130 is displayed, the normal reproduction mode in which currently selected music data Ad is reproduced normally. Whichever mode is entered, music data Ad is normally reproduced without being interrupted during execution of the Music Station function.

In particular, when the Music Station function is executed, the music reproduction apparatus 410 allows the user to change over the channel playlist PL in a unit of a channel in accordance with an operation of the upward button B13 or the downward button B14 of the remote controller RM1 in such a sense that the preset radio broadcasting station is changed over similarly as in the case of the music reproduction apparatus 110 of the first embodiment described hereinabove. Further, the music reproduction apparatus 410 can change over the tune to be reproduced in the channel in accordance with an operation of the leftward button B15 or the rightward button B16. Consequently, the music reproduction apparatus 410 allows the user to enjoy a desired tune further readily in such a sense that it enjoys music broadcast from a radio broadcasting station.

Also the procedure of the Music Station function starting process, channel changeover process and tune changeover process is similar to the procedure of the processes executed by the music reproduction apparatus 110 of the first embodiment described hereinabove. Thus, for details of the procedure, the description of the first embodiment given hereinabove should be referred to.

Also the channel display setting process by the Music Station function is similar to the display setting process executed by the music reproduction apparatus 110 of the first embodiment described hereinabove, and for details thereof, the description of the first embodiment given hereinabove should be referred to.

In particular, the music reproduction apparatus 410 according to the fourth embodiment is configured such that the channel display setting can be changed over between “display” and “no display” for each channel through the channel display setting screen 140 described hereinabove with reference to FIG. 22.

As described above, the music reproduction apparatus 410 of the fourth embodiment has the Music Station function corresponding to operations of the remote controller RM1 similarly as in the first embodiment described hereinabove. Thus, the music reproduction apparatus 410 can readily perform starting of the Music Station function, channel changeover, tune changeover, channel display setting and so forth by operations of the remote controller RM1.

Incidentally, the Music Station function of the music reproduction apparatus 410 according to the fourth embodiment changes equalization setting by the reproduction section 116 when a channel to which a channel playlist PL is allocated is selected in response to a characteristic of the channel playlist PL (for example, the number of music data Ad registered in the channel playlist PL).

In particular, the effect selection section 112E of the music reproduction apparatus 410 changes the equalization setting of the reproduction section 116 when a channel to which a channel playlist PL is allocated is selected (that is, when music data Ad registered in the channel playlist PL is reproduced) in response to the number of music data Ad registered in the channel playlist PL and acquired by the playlist characteristic extraction section 112D of the control section 112.

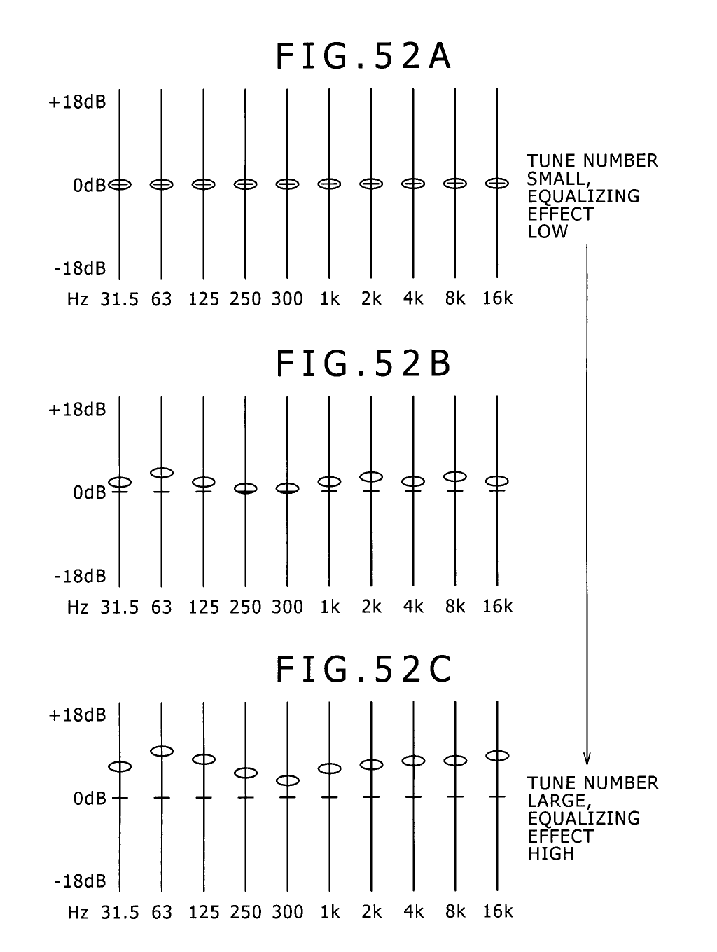

In this instance, for example, where the number of music data Ad registered in a channel playlist PL and acquired by the playlist characteristic extraction section 112D is equal to or smaller than 5, the effect selection section 112E selects first equalization setting wherein the signal level of each frequency band (for example, 31 Hz, 62 Hz, 125 Hz, 250 Hz, 300 Hz, 1 KHz, 2 KHz, 4 KHz, 8 KHz, 16 KHz) is set as a reference level (0 dB) as seen in FIG. 52A as the equalization setting to be used when music data Ad registered in the channel playlist PL is registered. However, where the number of music data Ad registered in the channel playlist PL is equal to or greater than 6 but equal to or smaller than 10, the effect selection section 112E selects second equalization setting wherein the signal level in a low frequency region and a high frequency region is raised higher than that of the first equalization setting as seen in FIG. 52B. Further, where the number of music data Ad registered in the channel playlist PL is equal to or greater than 11, the effect selection section 112E selects third equalization setting wherein the signal level in a low frequency region and a high frequency region is further raised higher than that in the second equalization setting as seen in FIG. 52C.

In particular, the effect selection section 112E changes the equalization setting such that, as the number of music data Ad registered in a channel playlist PL increases, the equalization effect when music data Ad registered in the channel playlist PL is reproduced is intensified.

Then, the reproduction control section 112F of the control section 112 controls the reproduction section 116 to reproduce the music data Ad in accordance with the equalization setting automatically selected by the effect selection section 112E.

Consequently, the music reproduction apparatus 410 can provide a new manner of enjoyment of adding music data Ad and listening to a tune reproduced in accordance with different equalization setting in addition to the manner of enjoyment of adding music data Ad and listening a new tune. As a result, it is possible to further urge the user to add music data Ad.

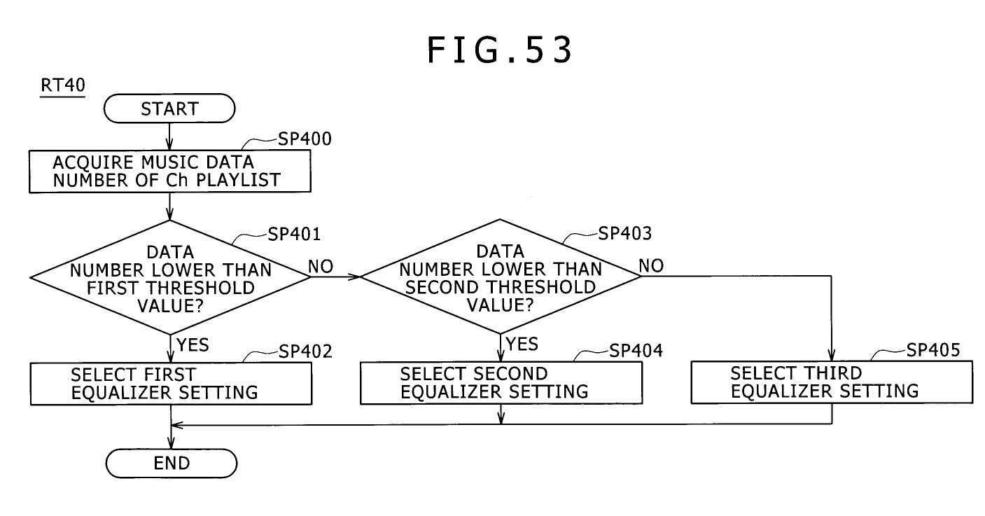

Now, a procedure of a process (hereinafter referred to also as equalization setting changing process) of changing such equalization setting as described above is described. If a channel playlist PL is selected through selection of a channel upon starting of the Music Station function, or if a channel playlist PL is selected through selection of a channel in response to a channel changeover operation during operation of the Music Station function, then the control section 112 of the music reproduction apparatus 410 starts an equalization setting changing processing procedure RT40 illustrated in FIG. 53 and advances the processing to step SP400.

At step SP400, the control section 112 acquires the number of music data Ad currently registered in the currently selected channel playlist PL by means of the playlist characteristic extraction section 112D, and then advances the processing to step SP401. Here, the playlist characteristic extraction section 112D acquires the number of music data information Ai in the channel playlist PL to acquire the number of the currently registered music data Ad.

At step SP401, the control section 112 decides whether or not the number of the acquired music data Ad is equal to or smaller than a first threshold value (for example, “5”). If an affirmative result is obtained at step SP401, then this signifies that the number of music data Ad registered in the currently selected channel playlist PL is equal to or smaller than 5. In this instance, the control section 112 advances the processing to step SP402.

At step SP402, the control section 112 selects, by means of the effect selection section 112E thereof, the first equalization setting wherein the equalization effect is lowest as seen in FIG. 52A as the equalization setting in the reproduction section 116. Then, the control section 112 ends the equalization setting changing procedure RT40.

On the other hand, if a negative result is obtained at step SP401, then this signifies that the number of music data Ad registered in the currently selected channel playlist PL is equal to or greater than 6. In this instance, the control section 112 advances the processing to step SP403.

At step SP403, the control section 112 decides whether or not the number of the acquired music data Ad is equal to or lower than the second threshold value (for example, “10”). If an affirmative result is obtained at step SP403, then this signifies that the number of music data Ad registered in the currently selected channel playlist PL is equal to or greater than 6 but equal to or smaller than 10. In this instance, the control section 112 advances the processing to step SP404.

At step SP404, the control section 112 selects, by means of the effect selection section 112E thereof, the second equalization setting whose equalization effect is higher than that of the first equalization setting as seen in FIG. 52B as the equalization setting of the reproduction section 116. Then, the control section 112 ends the equalization setting changing procedure RT40.

On the other hand, if a negative result is obtained at step SP403, then this signifies that the number of music data Ad registered in the currently selected channel playlist PL is equal to or greater than 11. In this instance, the control section 112 advances the processing to step SP405.

At step SP405, the control section 112 selects, by means of the effect selection section 112E thereof, the third equalization setting whose equalization effect is higher than that of the second equalization setting as seen in FIG. 52C as the equalization setting of the reproduction section 116. Then, the control section 112 ends the equalization setting changing procedure RT40.

The control section 112 of the music reproduction apparatus 410 changes the equalization setting to be used when music data Ad registered in the currently selected channel playlist PL is reproduced by the reproduction section 116 in accordance with such an equalization setting changing processing procedure RT40 as described above.

It is to be noted here that, while the equalization setting changing processing procedure RT40 is described separately from the Music Station function starting processing procedure RT10 and the channel changeover processing procedure RT11 for the convenience of description, actually it is executed in the Music Station function starting processing procedure RT10 and the channel changeover processing procedure RT11. In particular, the equalization setting changing processing procedure RT40 is executed, for example, at step SP108 of the Music Station function starting processing procedure RT10 or at step SP118 of the channel changeover processing procedure RT11.

Therefore, music data Ad reproduced at step SP108 of the Music Station function starting processing procedure RT10 or at step SP118 of the channel changeover processing procedure RT11 is reproduced in accordance with the equalization setting changed by the effect selection section 112E under the control of the reproduction control section 112F.

### 5-3. Operation and Effects of the Fourth Embodiment

The music reproduction apparatus 410 having the configuration described above manages a plurality of music data Ad stored in the content storage section 115 using a plurality of channel playlists PL stored in the list storage section 117 and each including music data information Ai which is content identification information of music data Ad.

If one of the channel playlists PL is selected in accordance with a user operation of the remote controller RM1, then the control section 112 of the music reproduction apparatus 410 controls the reproduction section 116 to start reproduction of music data Ad registered in the selected channel playlist PL.

Here, the control section 112 of the music reproduction apparatus 410 extracts, by means of the playlist characteristic extraction section 112D thereof, a characteristic (number of registered music data Ad) of each channel playlist PL and selectively determines, by means of the effect selection section 112E, an effect (effect for changing the equalization setting) in the reproduction section 116 in response to the extracted characteristic.

More particularly, if the number of music data Ad registered in a channel playlist PL is equal to or greater than a first threshold value (for example, 5), then the effect selection section 112E selectively determines first equalization setting as the equalization setting to be used when music data Ad registered in the channel playlist PL is reproduced. However, if the number of such music data Ad is greater than the first threshold value but equal to or smaller than a second threshold value (for example, 10) higher than the first threshold value, then the effect selection section 112E selectively determines the second equalization setting. On the other hand, if the number of such music data Ad is greater than the second threshold value, then the effect selection section 112E selects third equalization setting.

In particular, since the music reproduction apparatus 410 reproduces music data Ad in accordance with equalization setting which depends upon the number of music data Ad registered in a channel playlist PL, it can provide such a new manner of enjoyment which is not available with related art to the user that the user listens to a tune reproduced changing the equalization setting in response to the number of music data Ad registered in the channel playlist PL.

Further, since the effect to be used when music data Ad registered in each channel playlist PL is reproduced is selectively determined in response to the number of music data Ad registered in the channel playlist PL in this manner, the music reproduction apparatus 410 can let the user recognize that a new manner of enjoyment is provided by adding music data Ad. As a result, it is possible to further urge the user to add music data Ad.

Since the music reproduction apparatus 410 having the configuration described above can reproduce music data Ad belonging to a channel playlist PL in accordance with an effect suitable for a characteristic of the channel play list PL, it can provide a new manner of enjoyment different from conventionally available manners of enjoyment relating to music data Ad to the user.

### 5-4. Modifications to the Fourth Embodiment

It is to be noted that, while, in the fourth embodiment, the equalization setting is changed as an effect to be selected in response to a characteristic of a channel playlist PL, according to the present invention, the setting to be changed is not limited to this, but the tune order setting Ls in a channel playlist PL may be changed instead.

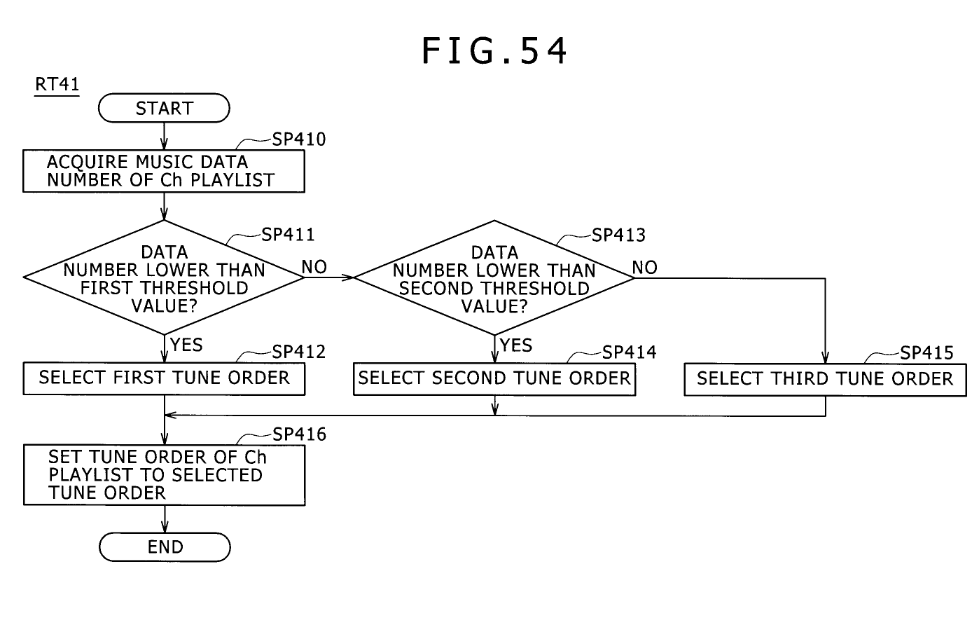

Here, a procedure of such a process (hereinafter referred to also as tune order changing process) of changing the turn order setting Ls as described above is described. If a channel playlist PL is selected through selection of a channel upon starting of the Music Station function, or if a channel playlist PL is selected through selection of a channel in response to a channel changeover operation while the Music Station function is operating, then the control section 112 of the music reproduction apparatus 410 starts a tune order changing processing procedure RT41 illustrated in FIG. 54 and advances the processing to step SP410.

At step SP410, the control section 112 acquires the number of music data Ad currently registered in the currently selected channel playlist PL by means of the playlist characteristic extraction section 112D, and then advances the processing to step SP411. Here, the playlist characteristic extraction section 112D acquires the number of music data information Ai in the channel playlist PL to acquire the number of the currently registered music data Ad.

At step SP411, the control section 112 decides whether or not the number of the acquired music data Ad is equal to or smaller than the first threshold value (for example, “5”). If an affirmative result is obtained at step SP411, then the control section 112 advances the processing to step SP412.

At step SP412, the control section 112 selects, by means of the effect selection section 112E thereof, for example, first tune order setting Ls which represents a random order as the tune order setting Ls in the currently selected channel playlist PL. Then, the control section 112 advances the processing to step sp416.

On the other hand, if a negative result is obtained at step SP411, then the control section 112 advances the processing to step SP413. At step SP413, the control section 112 decides whether or not the number of the acquired music data Ad is equal to or lower than a second threshold value (for example, “10”). If an affirmative result is obtained at step SP413, then the control section 112 advances the processing to step SP414. At step SP414, the control section 112 selects, by means of the effect selection section 112E thereof, second tune order setting Ls in which, for example, tunes are arranged in an ascending order of the value representative of the brightness of an impression value of the tune as the tune order setting Ls in the currently selected channel playlist PL. Then, the control section 112 advances the processing to step SP416.

On the other hand, if a negative result is obtained at step SP413, then the control section 112 advances the processing to step SP415. At step SP415, the control section 112 selects, by means of the effect selection section 112E thereof, third tune order setting Ls in which, for example, tunes are arranged in an ascending order of the value representative of the tempo of an impression value of the tune. Then, the control section 112 advances the processing to step SP416.

At step SP416, the control section 112 reflects the tune order setting Ls selected by the effect selection section 112E on the tune order setting Ls of the currently selected channel playlist PL and then ends the tune order changing processing procedure RT41.

As a result, the reproduction control section 112F of the control section 112 reproduces the music data Ad in accordance with the tune order setting Ls of the currently selected channel playlist PL.

Consequently, the music reproduction apparatus 410 can provide a new manner of enjoyment which is not available with related art to the user that the user listens to tunes reproduced changing the tune order in response to the number of registered music data Ad. As a result, even if the same channel playlist PL is selected, the music reproduction apparatus 410 allows the user to listen to tunes based on music data Ad normally in a fresh feeling.

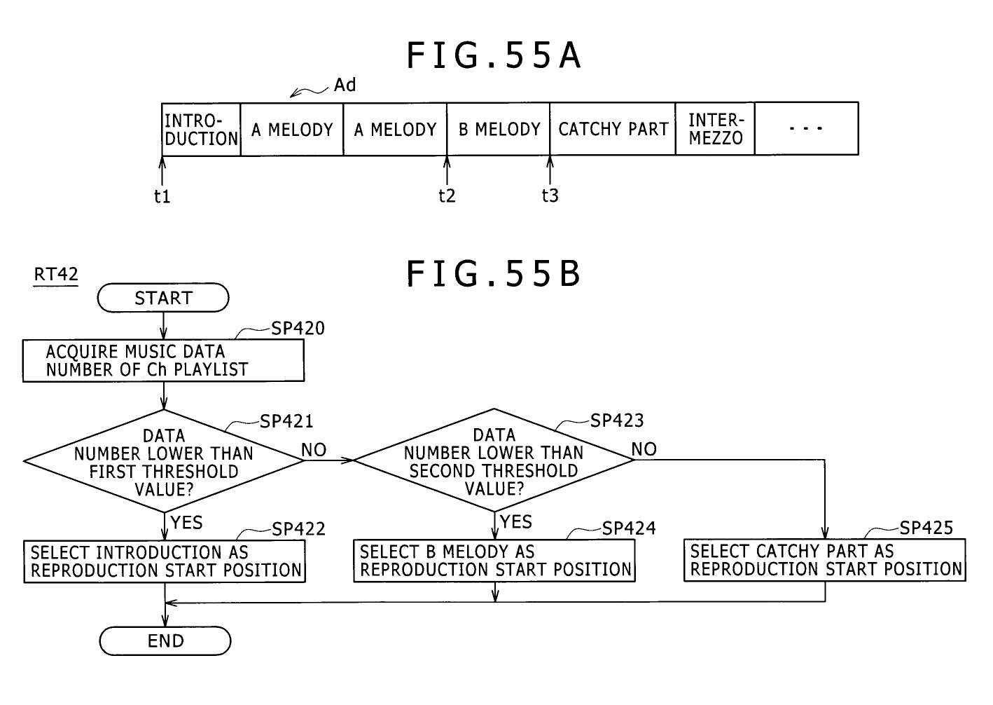

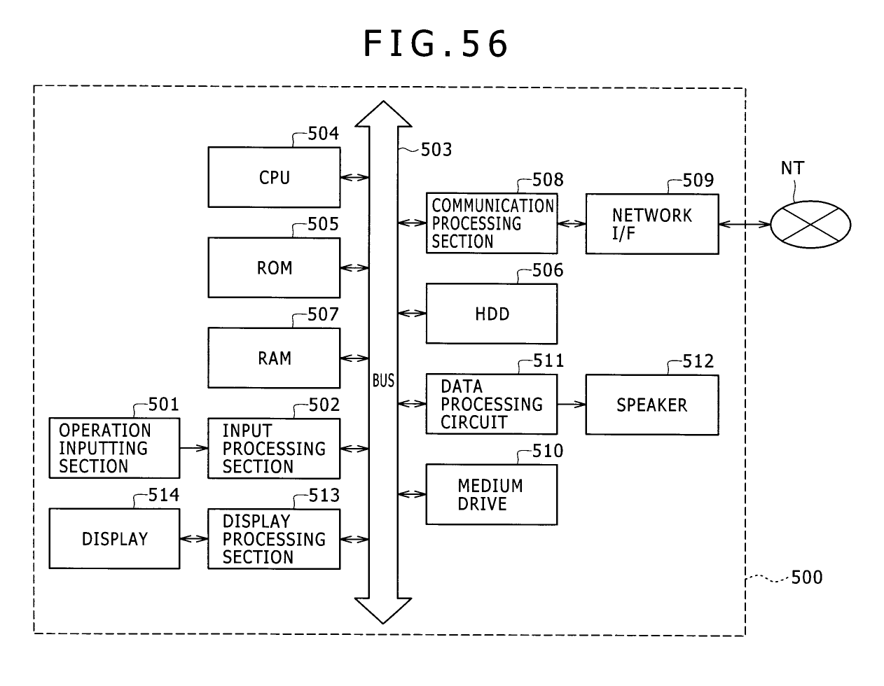

The effect to be changed is not limited to the tune order setting but may alternatively be the reproduction starting position of music data Ad (that is, the reproduction pattern). Here, a procedure of such a process (hereinafter referred to also as reproduction starting position changing process) of changing the reproduction starting position of music data Ad as just mentioned is described. It is assumed here that music data Ad is configured including an introduction, A melody, A melody, B melody, a catchy part, an intermezzo and so forth as seen in FIG. 55A.

If a channel playlist PL is selected through selection of a channel upon starting of the Music Station function, or if a channel playlist PL is selected through selection of a channel in response to a channel changeover operation while the Music Station function is operating, then the control section 112 of the music reproduction apparatus 410 starts a reproduction starting position changing process RT42 illustrated in FIG. 55B and advances the processing to step SP420.

At step SP420, the control section 112 acquires the number of music data Ad currently registered in the currently selected channel playlist PL by means of the playlist characteristic extraction section 112D, and then advances the processing to step SP421. Here, the playlist characteristic extraction section 112D acquires the number of music data information Ai in the channel playlist PL to acquire the number of the currently registered music data Ad.

At step SP421, the control section 112 decides whether or not the number of the acquired music data Ad is equal to or smaller than a first threshold value (for example, “5”). If an affirmative result is obtained at step SP421, then the control section 112 advances the processing to step SP422.

At step SP422, the control section 112 selects, by means of the effect selection section 112E thereof, for example, the start position t1 of the introduction (that is, the top of a tune) as the reproduction starting position of music data Ad registered in the currently selected channel playlist PL. Then, the control section 112 ends the tune reproduction starting position changing process RT42.

On the other hand, if a negative result is obtained at step SP421, then the control section 112 advances the processing to step SP423. At step SP423, the control section 112 decides whether or not the number of the acquired music data Ad is equal to or lower than a second threshold value (for example, “10”). If an affirmative result is obtained at step SP423, then the control section 112 advances the processing to step SP424. At step SP424, the control section 112 selects, by means of the effect selection section 112E thereof, for example, the start position t2 of the B melody as the reproduction starting position of the music data Ad registered in the currently selected channel playlist PL. Then, the control section 112 ends the tune reproduction starting position changing process RT42.

On the other hand, if a negative result is obtained at step SP423, then the control section 112 advances the processing to step SP425. At step SP425, the control section 112 selects, by means of the effect selection section 112E thereof, for example, the start position t3 of the catchy part as the reproduction starting position of music data Ad registered in the currently selected channel playlist PL. Then, the control section 112 ends the tune reproduction starting position changing process RT42.

As a result, the reproduction control section 112F of the control section 112 reproduces the music data Ad from the reproduction starting position selected by the effect selection section 112E.

Consequently, the music reproduction apparatus 410 can provide a new manner of enjoyment which is not available with related art to the user that the user listens to a tune reproduced changing the reproduction starting position in response to the number of registered music data Ad. Further, as the number of registered music data Ad increases, the reproduction starting position is changed from the start position t1 of the introduction to the start position t2 of the B melody and further to the start position t3 of the catchy part so that the user can recognize the tune more easily. Consequently, the music reproduction apparatus 410 can let the user recognize that, if music data Ad is added, then it becomes easier to search for a tune, and as a result, can urge the user to add music data.

It is assumed that the start position t1 of the introduction, start position t2 of the B melody and start position t3 of the catchy part to be utilized as the reproduction starting position are stored, for example, as the characteristic position information Ct1, Ct2 and Ct3 (FIG. 2) included in the music data management information Am of music data Ad in the content storage section 115, respectively. Further, the reproduction starting position is not limited to the start position t1 of the introduction, start position t2 of the B melody or start position t3 of the catchy part but may be the start position of any A melody or the intermezzo or the like.

Further, the reproduction pattern of music data Ad to be changed may not be the reproduction starting position but be selected, for example, at random from among catchy part reproduction, introduction reproduction, normal reproduction and accompaniment reproduction prepared for the reproduction pattern of music data Ad.

Meanwhile, the effect is not limited to changing of the equalization setting, changing of the tune order setting and changing of the reproduction pattern described hereinabove but may be selected also from among changing of the sound volume, changing of the sound quality (bit rate, compression ratio or the like), changing of the addition amount of noise and changing of the tempo.

In particular, for example, where the bit rate is to be changed, the effect selection section 112E changes the bit rate such that the sound quality when music data Ad registered in a channel playlist PL is reproduced is raised, for example, from FM radio sound quality to cassette tape sound quality, to MD sound quality and further to CD sound quality as the number of music data Ad registered in the channel playlist PL increases. As a result, the music reproduction apparatus 410 can provide a new manner of enjoyment to the user that the user adds music data Ad and enjoys a tune reproduced at a different bit rate. Further, in this instance, since the sound quality when music data Ad registered in the channel playlist PL is raised as the number of music data Ad registered in the channel playlist PL increases, the music reproduction apparatus 410 can urge the user to add music data Ad and provide such a manner of enjoyment that the user adds music data Ad to bring up the channel playlist PL.

Also where the addition amount of noise is to be changed, the effect selection section 112E may change the noise addition amount similarly so that, as the number of music data Ad registered in a channel playlist PL increases, the noise when music data Ad registered in the channel playlist PL is reproduced decreases (that is, the sound quality is raised).

Further, in the fourth embodiment described above, the number of music data Ad registered in a channel playlist PL is acquired by confirming not the registered data number Tn of the channel playlist PL but the number of music data information Ai in the channel playlist PL, according to the embodiment of the present invention, the acquisition of the registered data number Tn is not limited to this. For example, updating of the registered data number Tn may be performed not upon ending of the Music Station function but upon registration of music data Ad into the channel playlist PL such that the registered data number Tn is acquired as the number of music data Ad registered in the channel playlist PL.

Further, while, in the fourth embodiment described above, a characteristic of a channel playlist PL is extracted based on the number of registered music data Ad which is a statistic value of the music data Ad registered in the channel playlist PL to selectively determine an effect, according to the embodiment of the present invention, the selection of an effect is not limited to this. In particular, a characteristic of a channel playlist PL may be extracted based on one of the date on which first music data Ad is registered into the channel playlist PL, the date on which music data Ad is registered last, the reproduction frequency of music data Ad registered in the channel playlist PL, the degree of importance of music data Ad registered in the channel playlist PL and so froth to selectively determine an effect.

In particular, the music reproduction apparatus 410 additionally describes, for example, the date on which first music data Ad is registered into each channel playlist PL into the list information Li of the channel playlist PL and selectively determines the effect based on the date. Where the effect is selectively determined in this manner, the music reproduction apparatus 410, for example, raises the sound quality for a channel playlist PL having a comparatively late date to a comparatively high level so that the user can recognize the novelty of the channel playlist PL from the effect.

Or, the music reproduction apparatus 410 additionally describes, for example, the date of last registration of music data Ad into each channel playlist PL into the list information Li of the channel playlist PL and selectively determines an effect based on the date. By such selective determination, the music reproduction apparatus 410, for example, increases the addition amount of noise for a channel playlist PL whose date is older so that the user can recognize the oldness of the channel playlist PL from the effect.

Otherwise, the music reproduction apparatus 410 additionally describes, for example, a statistic value of the reproduction frequency (for example, a sum value or an average value of reproduction time numbers) of music data Ad registered in each channel playlist PL into the list information Li of the channel playlist PL and selects an effect based on the reproduction frequency. By such selective determination, the music reproduction apparatus 410 can allow the user to recognize the liking of a channel playlist PL from the effect, for example, by raising the equalization effect for a channel playlist PL which is enjoyed frequently. In this instance, while a statistic value of the reproduction time number is described in the list information Li, alternatively the reproduction time number of each music data Ad may be acquired from the attribute information Ti to calculate the statistic value.

Otherwise, the music reproduction apparatus 410 additionally describes, for example, a statistic value of the importance degree (for example, a sum value or an average value of values indicative of the degree of importance) of music data Ad registered in each channel playlist PL into the list information Li of the channel playlist PL and selects an effect based on the importance degree. By such selective determination, the music reproduction apparatus 410 can allow the user to recognize the degree of importance of a channel playlist PL from the effect, for example, by raising the sound quality for a channel playlist PL which has a comparatively high degree of importance. In this instance, while a statistic value of the degree of importance is described in the list information Li, alternatively the degree of importance of each music data Ad may be acquired from the attribute information Ti to calculate the statistic value. Or, the importance degree may be set in music data Ad in advance or may be set by the user.

Or else, a characteristic of a channel playlist PL may be extracted based on the genre, an impression value or the like included in the attribute information Ti which is additional information to music data Ad registered in the channel playlist PL to selectively determine an effect.

More particularly, when music data Ad of a channel playlist PL formed from music data Ad whose genre is, for example, the rock is to be reproduced, the music reproduction apparatus 410 sets equalization setting suitable for the rock. Consequently, the music reproduction apparatus 410 allows the user to enjoy a tune with an effect conforming to the genre of the music data Ad registered in the channel playlist PL.

Or, the music reproduction apparatus 410 calculates, for example, a statistic value (sum value or average value) of an impression value of tunes of music data Ad registered in a channel playlist PL and selects equalization setting suitable for the statistic value. As a result, the music reproduction apparatus 410 can let the user recognize the impression of music data Ad registered in the channel playlist PL from the effect.

Or else, the effect may be selectively determined based on the degree of agreement between a keyword (for example, “bright”) representing a characteristic of a channel playlist PL which is attribute information of the channel playlist PL and a characteristic of music data Ad (for example, an impression value of a tune) actually registered in the channel playlist PL.

Actually, while the music reproduction apparatus 410 described above registers music data Ad whose value representative of the brightness of an impression value of the tune is equal to or higher than a predetermined value into a channel playlist (tune list) PL in which “bright” is described as a keyword, according to the embodiment of the present invention, the registration is not limited to this. In particular, for example, from among music data Ad stored in the content storage section 115, those music data Ad whose value representing the brightness of an impression value of the tune is included in the top ten may be registered into the bright tune list PL.

Where this registration method is employed, in such a case that the number of music data Ad stored in the content storage section 115 is small, music data Ad of a bright tune may not necessarily be registered into the bright tune list PL. Therefore, for example, an average value of values representing the brightness of an impression value of a tune of music data Ad registered in the bright tune list PL is calculated, and the sound quality when music data Ad of the bright tune line PL is raised as the average value increases. As a result, the music reproduction apparatus 410 can let the user recognize the degree of agreement between a characteristic of the channel playlist PL and a characteristic of music data Ad actually registered in the channel playlist PL from the effect.

Further, in the equalization setting changing processing procedure RT40 in the present fourth embodiment described above, three patterns including the first equalization, second equalization and third equalization are used in response to the number of music data Ad registered in a channel playlist PL. However, according to the embodiment of the present invention, the number of patterns is not limited to this, but may be two or four or more.

### 6. Fifth Embodiment

Now, a fifth embodiment of the present invention is described. A content reproduction apparatus 500 shown in FIG. 56 is an embodiment wherein the content reproduction apparatus 1 of the functional block configuration which is the basic configuration described hereinabove is implemented by hardware. Referring to FIG. 56, the content reproduction apparatus 500 includes an operation inputting section 501 which is formed from various operation buttons provided on the surface of a housing of the content reproduction apparatus 500 or on a remote controller not shown. If the operation inputting section 501 is operated by the user, then it recognizes the operation and signals an operation input signal corresponding to the operation to an input processing section 502. The input processing section 502 performs a predetermined process for the operation input signal supplied thereto to convert the operation input signal into an operation command. Then, the input processing section 502 signals the operation command to a central processing unit (CPU) 504 through a bus 503.

The central processing unit 504 reads out various programs such as a basic program and an application program stored in advance in a ROM (Read Only Memory) 505 or a hard disk drive 506 into a RAM (Random Access Memory) 507 through the bus 503. Then, the central processing unit 504 controls the entire content reproduction apparatus 500 in accordance with such various programs developed on the RAM 507 and executes predetermined arithmetic operation processes and various processes in accordance with operation commands supplied thereto from the input processing section 502.

For example, the central processing unit 504 accesses a music providing server not shown on a network NT successively through a communication processing section 508 and a network interface (I/F) 509.

If an operation input signal for requesting downloading of desired music data is inputted through the operation inputting section 501 by the user, then the central processing unit 504 issues a downloading request for the desired music data to the music providing server in response to the operation input signal. As a result, the central processing unit 504 downloads the desired music data provided from the music providing server successively through the network interface 509 and the communication processing section 508. Then, the central processing unit 504 stores the downloaded music data into the hard disk drive 506.

On the other hand, if an operation input signal for recording music data recorded on a storage medium such as a CD is inputted through the operation inputting section 501 by the user, then the central processing unit 504 reads out music data from the recording medium using a medium drive 510 and signals the read out music data to a data processing circuit 511. The data processing circuit 511 compression codes and stores the music data received from the hard disk drive 510 into the hard disk drive 506.

Further, if music data in the hard disk driver 506 is designated and an operation input signal for requesting reproduction of the music data is inputted through the operation inputting section 501 by the user, then the central processing unit 504 signals the designated music data from the hard disk drive 506 in response to the operation input signal and signals the read out music data to the data processing circuit 511. The data processing circuit 511 decodes the music data and then performs sound processes such as an equalization process, a digital to analog conversion process and an amplification process for the decoded music data. Then, the data processing circuit 511 signals a music signal obtained by the sound processes to a speaker 512. Consequently, music (that is, a tune) based on the music signal is outputted from the speaker 512.

The hard disk drive 506 has a plurality of playlists stored therein. If one of the playlists is designated and an instruction input signal which requests to reproduce music data in accordance with the playlist is inputted through the operation inputting section 501 by the user, then the central processing unit 504 reads out the designated playlist from the hard disk drive 506 in response to the operation input signal.

Then, the central processing unit 504 reads out music data registered in the playlist in an order indicated by the playlist from the hard disk drive 506 and signals the music data to the data processing circuit 511. The data processing circuit 511 decodes the music data and then performs sound processes such as an equalization process, a digital to analog conversion process and an amplification process. Then, the data processing circuit 511 signals a music signal obtained by the sound processes to the speaker 512. As a result, music (tunes) based on the sound signal is outputted in the order of the playlist from the speaker 512.

Further, the central processing unit 504 produces display data in accordance with a result of execution of programs (for example, downloading, recording and reproduction of music data) and signals the display data to a display processing section 513. The display processing section 513 controls a display unit 514 to display a screen based on the display data.

Incidentally, in the content reproduction apparatus 500, the central processing unit 504 executes various processes in accordance with various programs stored in advance in the ROM 505 or the hard disk drive 506. In other words, in the content reproduction apparatus 500, the operation inputting section 501 and the input processing section 502 can function similarly to the operation section 2 of the content reproduction apparatus 1 if the programs to be stored into the ROM 505 or the hard disk drive 506 are selected suitably in accordance with the various functions (that is, the processes to be executed) of the content reproduction apparatus 1 (FIG. 1) having the functional block configuration described hereinabove. Further, it is possible to cause the display unit 514 to function similarly to the display section 4.

Further, in the content reproduction apparatus 500, it is possible to cause the central processing unit 504 and the display processing section 513 to function similarly to the control section 3 of the content reproduction apparatus 1. Furthermore, it is possible to cause the communication processing section 508 and the network interface 509 to function similarly to the communication section 5, and it is possible to cause the hard disk drive 506 to function similarly to the storage section 6. Further, it is possible to cause the medium drive 510, the data processing circuit 511 and the speaker 512 to function similarly to the reproduction section 7.

Further, in the content reproduction apparatus 500, also it is possible to cause the functional blocks of the content reproduction apparatus 100, 200 and 400 and the display control apparatus 300 which have the basic configuration of the content reproduction apparatus 1 to function similarly by the hardware configuration of the content reproduction apparatus 500 itself. Incidentally, as regards the temporary storage section 205 of the content reproduction apparatus 200 which is not included in the basic configuration of the content reproduction apparatus 1, the RAM 507 of the content reproduction apparatus 500 may be caused to function similarly.

Therefore, according to the content reproduction apparatus 500, the various functions of the content reproduction apparatus 1, 100, 200 and 400 and the display control apparatus 300 (that is, the processes which are executed by the content reproduction apparatus 1, 100, 200 and 400 and the display control apparatus 300) can be implemented by the hardware configuration of the content reproduction apparatus 500 itself. Thus, effects similarly to those achieved by the first to fourth embodiments described above can be achieved.

It is to be noted that, while, in the present fifth embodiment, the central processing unit 504 implements the various functions of the content reproduction apparatus 1 and the content reproduction apparatus 100, 200 and 400 and the display control apparatus 300 which have the basic function of the content reproduction apparatus 1 in accordance with the programs stored in advance in the ROM 505 or the hard disk drive 506, according to the present invention, the implementation of the functions is not limited to this. In particular, it is otherwise possible to record the various programs in a recording medium such as a CD or a DVD (Digital Versatile Disc) such that the central processing unit 504 implements the various functions of the content reproduction apparatus 100, 200 and 400 and the display control apparatus 300 in accordance with the programs read out from the recording medium. Or, the programs read out from the recording medium may be installed into the hard disk drive 506.

### 7. Other Modifications to the First to Fifth Embodiments

While, in the first to fifth embodiments described above, music data of tunes are used as contents, according to the present invention, the contents are not limited to music data. In particular, various other contents such as music data other than music data of tunes, image data and program data may be used. Further, the present invention can be applied widely to a personal computer, a portable telephone set, a PDA (Personal Digital Assistant), a portable audio player, an audio component system, a DVD (Digital Versatile Disc) recorder, a hard disc recorder and various other apparatus which handle various contents and may be applied as the content reproduction apparatus 1, 100, 200 and 400 and the display control apparatus 300.

Further, in the first to fourth embodiments described hereinabove, an impression value of a tune obtained by twelve-tone analysis is used as a characteristic of a tune indicated by the attribute information Ti. However, according to the present invention, the characteristic of a tune is not limited to this, but a value obtained by various other analysis methods such as, for example, frequency analysis may be used as a characteristic of a tune, or an impression value of a tune digitized by a human being may be used.

In summary, the present invention can be applied widely to content reproduction apparatus such as an audio player which reproduces music data in accordance with a playlist.

While preferred embodiments of the present invention have been described using specific terms, such description is for illustrative purpose only, and it is to be understood that changes and variations may be made without departing from the spirit or scope of the following claims.

What is claimed is:

1. A content reproduction apparatus for reproducing a content based on a playlist to which a plurality of contents belong, comprising:
a reproduction section configured to reproduce a content; and
a control section configured to select a predetermined one of playlists in response to an input to an inputting section and control said reproduction section so as to apply a predetermined effect based on the selected playlist to a content of the playlist to reproduce the content.

2. The content reproduction apparatus according to claim 1, further comprising:
a playlist characteristic extraction section configured to extract a characteristic of the selected playlist based on a plurality of contents which belong to the playlist; and
an effect selection section configured to select the effect to be applied relating to reproduction of the contents which belong to the playlist based on the characteristic of the playlist extracted by said playlist characteristic extraction section.

3. The content reproduction apparatus according to claim 2, wherein said playlist characteristic extraction section extracts the characteristic of the playlist based on a statistic value obtained from the contents which belong to the playlist.

4. The content reproduction apparatus according to claim 3, wherein the statistic value is one of the number of the contents which belong to the playlist, the day on which a first one of the contents comes to belong to the playlist, the date on which a last one of the contents comes to belong the playlist, a reproduction order of the contents which belong to the playlist, and the degree of importance of the contents which belong to the playlist.

5. The content reproduction apparatus according to claim 1, wherein the predetermined effect is an effect of changing the sound volume.

6. The content reproduction apparatus according to claim 1, wherein the predetermined effect is an effect of changing equalization setting.

7. The content reproduction apparatus according to claim 1, wherein the predetermined effect is an effect of changing the sound quality of the content.

8. The content reproduction apparatus according to claim 1, wherein the predetermined effect is an effect of adding noise.

9. The content reproduction apparatus according to claim 1, wherein the predetermined effect is an effect of changing the reproduction pattern of the content.

10. The content reproduction apparatus according to claim 9, wherein the reproduction pattern is one of catchy part reproduction, introduction reproduction, normal reproduction and accompaniment reproduction.

11. The content reproduction apparatus according to claim 1, wherein the predetermined effect is an effect of changing the tempo of the content.

12. The content reproduction apparatus according to claim 2, wherein said playlist characteristic extraction section extracts a characteristic of the playlist based on content additional information included in the contents which belong to the playlist.

13. The content reproduction apparatus according to claim 12, wherein said playlist characteristic extraction section extracts a characteristic of the playlist based on a statistic value of a particular item of the content additional information.

14. The content reproduction apparatus according to claim 2, wherein said effect selection section selects an effect based on attribute information of the playlist and a characteristic of the playlist extracted by said playlist characteristic extraction section.

15. A recording medium on which a computer-readable program is recorded, the program comprising the steps of:
selecting a predetermined one of playlists to which a plurality of contents belong in response to an input to an inputting section; and
reproducing a content which belongs to the selected playlist based on the predetermined playlist by applying a predetermined effect to the content.

16. The recording medium according to claim 15, wherein the program further comprising the steps of:
extracting a characteristic of the playlist based on a plurality of contents which belong to the playlist; and
selecting an effect to be applied relating to reproduction of the contents which belong to the playlist based on the characteristic of the playlist extracted by the playlist characteristic extraction step.

17. A content reproduction method, comprising the steps of:
selecting a predetermined one of playlists to which a plurality of contents belong in response to an input to an inputting section; and
reproducing a content which belongs to the selected playlist based on the predetermined playlist by applying a predetermined effect to the content.

18. The content reproduction method according to claim 17, further comprising the steps of:
extracting a characteristic of the playlist based on a plurality of contents which belong to the playlist; and
selecting an effect to be applied relating to reproduction of the contents which belong to the playlist based on the characteristic of the playlist extracted by the playlist characteristic extraction step.

19. A content reproduction apparatus for reproducing a content based on a playlist to which a plurality of contents belong, comprising:
reproduction means configured to reproduce a content; and
control means configured to select a predetermined one of contents in response to an input to inputting means and control said reproduction means so as to apply a predetermined effect based on the selected playlist to a content of the playlist to reproduce the content.
